(19) United States
(12) Patent Application Publication
(10) Pub. No.: US 2024/0427117 A1
(43) Pub. Date: Dec. 26, 2024

(54) OPTICAL SYSTEM AND OPTICAL APPARATUS

(71) Applicant: FUJIFILM Corporation, Tokyo (JP)

(72) Inventor: Hiroki SAITO, Saitama (JP)

(73) Assignee: FUJIFILM Corporation, Tokyo (JP)

(21) Appl. No.: 18/671,534

(22) Filed: May 22, 2024

(30) Foreign Application Priority Data
May 29, 2023 (JP) 2023-088198

(51) Int. Cl. G02B 13/00; G02B 9/64

(52) U.S. Cl. CPC G02B 13/0045; G02B 9/64

(57) ABSTRACT

An optical system includes a plurality of lens components in a case where one lens component is one single lens or one cemented lens, in which an aperture stop that has a variable opening diameter and that determines an F-number of the optical system and at least one focusing group that moves during focusing are disposed in the optical system. The optical system satisfies a predetermined conditional expression.

### CROSS-REFERENCE TO RELATED APPLICATIONS

This application claims priority from Japanese Patent Application No. 2023-088198, filed on May 29, 2023, the entire disclosure of which is incorporated herein by reference.

### BACKGROUND

### Technical Field

The disclosed technology relates to an optical system and an optical apparatus.

### Related Art

In the related art, the optical systems according to JP2022-117775A and JP2021-117436A have been known as an optical system usable in an optical apparatus such as a digital camera.

### SUMMARY

An optical system that is configured to have a small size and that has a wide angle of view and a small F-number while having high resolution is desired. A level of such demands is increased year by year.

An object of the present disclosure is to provide an optical system that is configured to have a small size and that has a wide angle of view and a small F-number while having high resolution, and an optical apparatus comprising the optical system.

An optical system of a first aspect of the present disclosure is an optical system comprising a plurality of lens components in a case where one lens component is one single lens or one cemented lens, in which an aperture stop that has a variable opening diameter and that determines an F-number of the optical system and at least one focusing group that moves during focusing are disposed in the optical system, and Conditional Expressions (1), (2), and (3) are satisfied, which are represented by

$$- 80 < α1 < - 30 \qquad ( 1 )$$

$$0.5 < FNo < 2.3 \qquad ( 2 )$$

$$0.5 < Bf / Y < 1.7 . \qquad ( 3 )$$

The optical system of the aspect is determined as follows. A lens component that is positioned closer to an object side than the aperture stop, that has a negative refractive power, and of which a surface closest to an image side has a concave shape is referred to as a negative concave lens component. The negative concave lens component having a maximum absolute value of an angle between an optical axis and a normal line to a surface of the negative concave lens component closest to the image side at a position of a maximum effective diameter of the surface in a cross section including the optical axis among the negative concave lens components of the optical system is referred to as a first negative concave lens component. The angle of the first negative concave lens component is denoted by α1, α1 is in degree units, and a sign of α1 is negative. An open F-number in a state where an infinite distance object is focused on is denoted by FNo. A back focus of the optical system as an air conversion distance in the state where the infinite distance object is focused on is denoted by Bf. A focal length of the optical system in the state where the infinite distance object is focused on is denoted by f. A maximum half angle of view in the state where the infinite distance object is focused on is denoted by ωm. Y=f×tan ωm is established.

In a case where a lens component closest to the object side among lens components that are positioned closer to the image side than the aperture stop and that have a positive refractive power is referred to as a P lens component, a distance on the optical axis from the aperture stop to a surface of the P lens component closest to the object side in the state where the infinite distance object is focused on is denoted by dStP, and a sum of Bf and a distance on the optical axis from the aperture stop to a lens surface of the optical system closest to the image side in the state where the infinite distance object is focused on is denoted by dStI, the optical system of the aspect preferably satisfies Conditional Expression (4), which is represented by

$$0 < dStP / dStI < 0.38 . \qquad ( 4 )$$

In a case where a larger one of a maximum effective diameter of a surface closest to the object side and a maximum effective diameter of a surface closest to the image side for each lens component of the optical system is referred to as a wide effective diameter, a lens component having the minimum wide effective diameter among lens components included from a surface of the P lens component closest to the object side to a surface, closest to the object side, of a lens component of the optical system closest to the image side is referred to as an Ed lens component, and a focal length of the Ed lens component is denoted by fEd, the optical system of the aspect preferably satisfies Conditional Expression (5), which is represented by

$$- 0.27 < Y / fEd < 0.1 . \qquad ( 5 )$$

In a case where an angle having a larger absolute value out of an angle between the optical axis and a normal line to a surface of the Ed lens component closest to the object side at the position of the maximum effective diameter of the surface and an angle between the optical axis and a normal line to a surface of the Ed lens component closest to the image side at the position of the maximum effective diameter of the surface in a cross section including the optical axis is denoted by α2, the optical system of the aspect preferably satisfies Conditional Expression (6), which is represented by

$$- 45 < α 2 < 0. \qquad ( 6 )$$

Here, α2 is in degree units, and a sign of α2 is negative in a case where the surface from which the normal line is obtained is a concave surface, and a sign of α2 is positive in a case where the surface from which the normal line is obtained is a convex surface.

In a case where a focal length of the P lens component is denoted by fP, the optical system of the aspect preferably satisfies Conditional Expression (7), which is represented by

$$0.1 < Y / fP < 0.9 . \qquad ( 7 )$$

In a case where ωm is in degree units, the optical system of the aspect preferably satisfies Conditional Expression (8), which is represented by

$$32 < ω m < 55. \qquad ( 8 )$$

In a case where a distance on the optical axis from a lens surface of the optical system closest to the object side to a paraxial entrance pupil position in the state where the infinite distance object is focused on is denoted by Denp, the optical system of the aspect preferably satisfies Conditional Expression (9), which is represented by

$$0.83 < f / Denp < 2.5 . \qquad ( 9 )$$

In a case where a distance on the optical axis from a paraxial exit pupil position to an image plane in the state where the infinite distance object is focused on is denoted by Dexp, the optical system of the aspect preferably satisfies Conditional Expression (10), which is represented by

$$0.25 < Dexp / Y < 0.5 . \qquad ( 10 )$$

In a case where an optical member not having a refractive power is disposed between the image plane and the paraxial exit pupil position, Dexp is calculated using an air conversion distance for the optical member.

In a case where a lateral magnification of the optical system in a state where a nearest object is focused on is denoted by B, the optical system of the aspect preferably satisfies Conditional Expression (11), which is represented by

$$0.07 < \vert B \vert < 0.3 . \qquad ( 11 )$$

In a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, and a focal length of the maximum focusing group is denoted by ffm, the optical system of the aspect preferably satisfies Conditional Expression (12), which is represented by

$$0.05 < f / \vert ffm \vert < 0.95 . \qquad ( 12 )$$

In a case where a combined focal length of all lenses closer to the object side than the maximum focusing group is denoted by ffmF, the optical system of the aspect preferably satisfies Conditional Expression (13), which is represented by

$$- 0.9 < f / ffmF < 2. \qquad ( 13 )$$

In a case where γ of the maximum focusing group is denoted by γfm, the optical system of the aspect preferably satisfies Conditional Expression (14), which is represented by

$$0.38 < \vert γ fm \vert < 2.5 . \qquad ( 14 )$$

In a case where Mf of the maximum focusing group is denoted by Mfm, and a sum of Bf and a distance on the optical axis from a lens surface of the optical system closest to the object side to a lens surface of the optical system closest to the image side in the state where the infinite distance object is focused on is denoted by TL, the optical system of the aspect preferably satisfies Conditional Expression (15), which is represented by

$$0.0 \; 06 < \vert Mfm \vert / TL < 0.15 . \qquad ( 15 )$$

In a case where a combined focal length of all lenses closer to the image side than the maximum focusing group is denoted by ffmR, the optical system of the aspect preferably satisfies Conditional Expression (16), which is represented by

$$- 0.5 < f / ffmR < 1.5 . \qquad ( 16 )$$

A first cemented lens that is obtained by bonding a negative lens and a positive lens to each other in this order from the object side and of which a surface closest to the object side has a concave shape is preferably disposed between a surface of the first negative concave lens component closest to the image side and the aperture stop. In a case where a paraxial curvature radius of a surface of the first cemented lens closest to the object side is denoted by Rc1, the optical system of the aspect preferably satisfies Conditional Expression (17), which is represented by

$$- 2 < f / Rc 1 < - 0.025 . \qquad ( 17 )$$

A second cemented lens obtained by bonding a positive lens and a negative lens to each other in this order from the object side is preferably disposed between a surface of the P lens component closest to the image side and a surface of the Ed lens component closest to the object side. In a case where a paraxial curvature radius of a surface of the second cemented lens closest to the object side is denoted by Rc2, the optical system of the aspect preferably satisfies Conditional Expression (18), which is represented by

$$0.02 < f / Rc 2 < 1.5 . \qquad ( 18 )$$

The optical system of the aspect preferably satisfies Conditional Expressions (4), (5), and (6) at the same time.

In the present specification, the expressions “consists of” and “consisting of” intend that a lens substantially not having a refractive power, an optical element other than a lens such as a stop, a filter, and a cover glass, a mechanism part such as a lens flange, a lens barrel, an imaging element, and a camera shake correction mechanism may be included in addition to the illustrated constituents.

The term “group” in the present specification is not limited to a configuration consisting of a plurality of lenses and may be a configuration consisting of only one lens. The term “group having a positive refractive power” in the present specification means that a positive refractive power is provided as a whole group. Similarly, the term “group having a negative refractive power” means that a negative refractive power is provided as a whole group. The term “lens component having a positive refractive power” in the present specification means that a positive refractive power is provided as a whole lens component. Similarly, the term “lens component having a negative refractive power” means that a negative refractive power is provided as a whole lens component.

A single lens is one lens that is not bonded. In the present specification, a compound aspherical lens (a lens (for example, a spherical lens) and a film of an aspherical shape formed on the lens are configured to be integrated with each other, and the lens functions as one aspherical lens as a whole) is not considered to be a cemented lens and is regarded as one lens. Unless otherwise specified, a curvature radius, a sign of a refractive power, and a surface shape related to a lens including an aspherical surface in a paraxial region are used. For a sign of the curvature radius, a sign of the curvature radius of a surface having a convex shape toward the object side is positive, and a sign of the curvature radius of a surface having a convex shape toward the image side is negative.

The term “focal length” used in the conditional expressions is a paraxial focal length. Unless otherwise specified, the term “distance on the optical axis” used in the conditional expressions is a geometrical distance. The term “back focus as the air conversion distance” means an air conversion distance on the optical axis from the lens surface of the optical system closest to the image side to the image plane. Unless otherwise specified, values used in the conditional expressions are values based on the d line in a state where an infinite distance object is focused on.

According to the present disclosure, an optical system that is configured to have a small size and that has a wide angle of view and a small F-number while having high resolution, and an optical apparatus comprising the optical system can be provided.

### BRIEF DESCRIPTION OF THE DRAWINGS

FIG. 1 is a cross-sectional view that corresponds to an optical system of Example 1 and that illustrates a configuration of an optical system according to one embodiment.

FIG. 2 is a cross-sectional view illustrating the configuration and luminous fluxes of the optical system in FIG. 1 in each focused state.

FIG. 3 is a diagram illustrating an example of an aperture stop having a variable opening diameter.

FIG. 4 is a diagram for describing a position of a maximum effective diameter.

FIG. 5 is a diagram for describing symbols of conditional expressions.

FIG. 6 is each aberration diagram of the optical system of Example 1.

FIG. 7 is a cross-sectional view illustrating a configuration of an optical system of Example 2.

FIG. 8 is each aberration diagram of the optical system of Example 2.

FIG. 9 is a cross-sectional view illustrating a configuration of an optical system of Example 3.

FIG. 10 is each aberration diagram of the optical system of Example 3.

FIG. 11 is a cross-sectional view illustrating a configuration of an optical system of Example 4.

FIG. 12 is each aberration diagram of the optical system of Example 4.

FIG. 13 is a cross-sectional view illustrating a configuration of an optical system of Example 5.

FIG. 14 is each aberration diagram of the optical system of Example 5.

FIG. 15 is a cross-sectional view illustrating a configuration of an optical system of Example 6.

FIG. 16 is each aberration diagram of the optical system of Example 6.

FIG. 17 is a cross-sectional view illustrating a configuration of an optical system of Example 7.

FIG. 18 is each aberration diagram of the optical system of Example 7.

FIG. 19 is a cross-sectional view illustrating a configuration of an optical system of Example 8.

FIG. 20 is each aberration diagram of the optical system of Example 8.

FIG. 21 is a cross-sectional view illustrating a configuration of an optical system of Example 9.

FIG. 22 is each aberration diagram of the optical system of Example 9.

FIG. 23 is a cross-sectional view illustrating a configuration of an optical system of Example 10.

FIG. 24 is each aberration diagram of the optical system of Example 10.

FIG. 25 is a perspective view of a front surface side of an imaging apparatus according to one embodiment.

FIG. 26 is a perspective view of a rear surface side of the imaging apparatus according to one embodiment.

### DESCRIPTION OF EMBODIMENTS

Hereinafter, an embodiment of the present disclosure will be described with reference to the drawings.

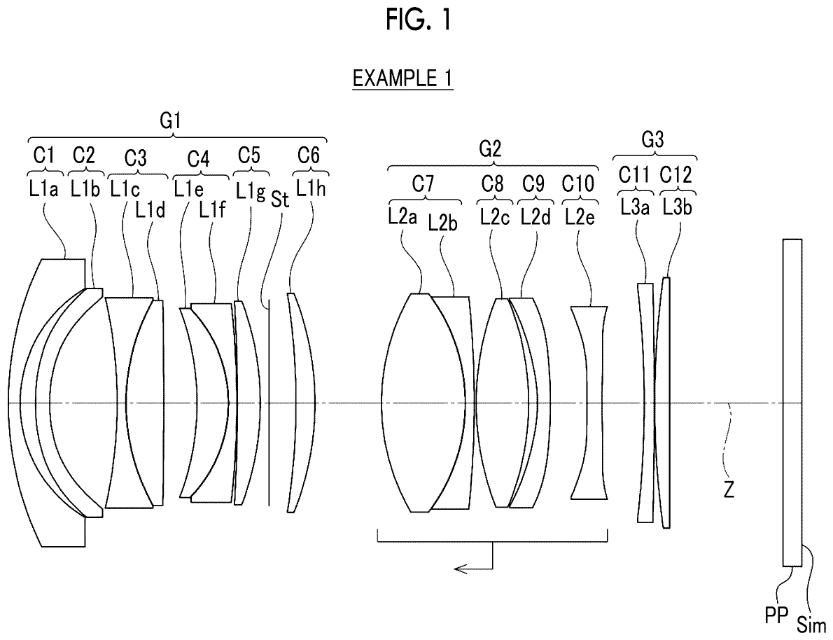

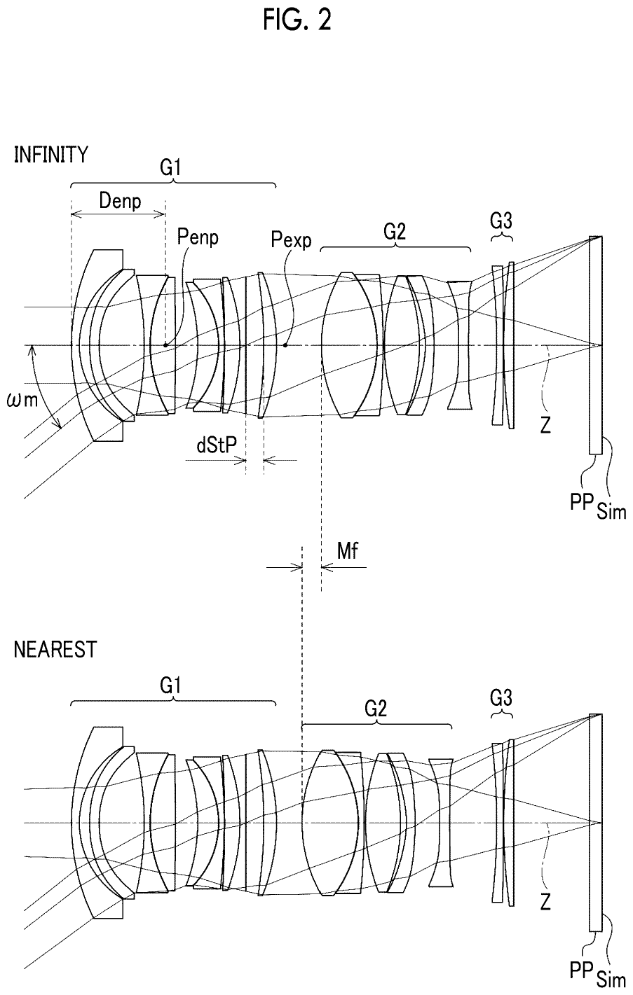

FIG. 1 illustrates a cross-sectional view of a configuration of an optical system according to one embodiment of the present disclosure in a state where an infinite distance object is focused on. FIG. 2 illustrates a cross-sectional view of the configuration and luminous fluxes of the optical system in FIG. 1 in each focused state. In FIG. 2, the state where the infinite distance object is focused on is illustrated in an upper part labeled “infinite distance”, and a state where a nearest object is focused on is illustrated in a lower part labeled “nearest”. In the present specification, an object at an infinite distance will be referred to as the “infinite distance object”, and an object at a nearest distance will be referred to as the “nearest object”. The upper part in FIG. 2 illustrates an on-axis luminous flux and a luminous flux of a maximum half angle of view ωm in the state where the infinite distance object is focused on as the luminous fluxes. The lower part in FIG. 2 illustrates the on-axis luminous flux and the luminous flux of the maximum half angle of view in the state where the nearest object is focused on as the luminous fluxes. In FIGS. 1 and 2, a left side is an object side, and a right side is an image side. Examples illustrated in FIGS. 1 and 2 correspond to an optical system of Example 1, described later. Hereinafter, description will be mainly provided with reference to FIG. 1.

The optical system according to the present disclosure includes a plurality of lens components. In the present specification, the term “lens component” refers to a single lens or a cemented lens obtained by bonding two or more lenses. One single lens or one cemented lens is one lens component. In a case where a lens component is a single lens, the term “surface of the lens component closest to the object side” means a surface of the single lens on the object side, and the term “surface of the lens component closest to the image side” means a surface of the single lens on the image side.

For example, the optical system in FIG. 1 includes 12 lens components of lens components C1 to C12 arranged in this order from the object side to the image side along an optical axis Z.

Each lens component in the example in FIG. 1 is configured as follows. The lens component C1 consists of a lens L1a that is a single lens. The lens component C2 consists of a lens L1b that is a single lens. The lens component C3 consists of a cemented lens obtained by bonding a lens L1c and a lens L1d to each other. The lens component C4 consists of a cemented lens obtained by bonding a lens L1e and a lens L1f to each other. The lens component C5 consists of a lens L1g that is a single lens. The lens component C6 consists of a lens L1h that is a single lens. The lens component C7 consists of a cemented lens obtained by bonding a lens L2a and a lens L2b to each other. The lens component C8 consists of a lens L2c that is a single lens. The lens component C9 consists of a lens L2d that is a single lens. The lens component C10 consists of a lens L2e that is a single lens. The lens component C11 consists of a lens L3a that is a single lens. The lens component C12 consists of a lens L3b that is a single lens.

In the example in FIG. 1, an example in which an optical member PP having a parallel flat plate shape is disposed closer to the image side than the optical system assuming that the optical system is applied to an optical apparatus is illustrated. The optical member PP is a member that is assumed to be, for example, various filters and/or a cover glass. The various filters include, for example, a low-pass filter, an infrared cut filter, and/or a filter that cuts a specific wavelength range. The optical member PP is a member that does not have a refractive power. The optical apparatus can also be configured without the optical member PP.

An aperture stop St that determines an F-number of the optical system is disposed in the optical system according to the present disclosure. The aperture stop St has an opening portion having a variable opening diameter. The F-number can be changed by changing the opening diameter. Thus, the F-number can be adjusted.

In the example in FIG. 1, the aperture stop St is disposed between the lens component C5 and the lens component C6. The aperture stop St illustrated in FIG. 1 does not indicate a size and a shape and indicates a position in an optical axis direction. An illustration method of the aperture stop St also applies to other cross-sectional views illustrating the configuration of the optical system.

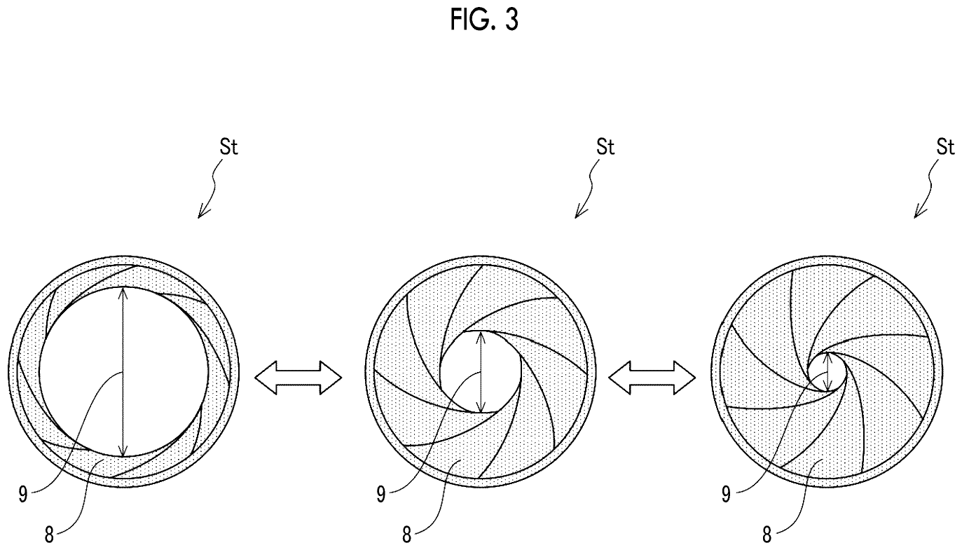

For example, as illustrated in FIG. 3, the aperture stop St can be configured to include a plurality of stop leaf blades 8 arranged at spacings on a circumference centered on the optical axis Z to form a light shielding unit having a ring shape as a whole. A part of the aperture stop St on an inner side of the light shielding unit in a diameter direction is the opening portion and is a part through which light passes. The opening portion has an approximately circular shape, and a diameter of the circular shape is an opening diameter 9. The opening diameter 9 is changed as illustrated in FIG. 3 by moving the plurality of stop leaf blades 8 in an opening and closing direction. While the aperture stop St in FIG. 3 includes eight stop leaf blades 8, only one stop leaf blade 8 is designated by the reference numeral in FIG. 3 in order to avoid complication of the drawing. In addition, FIG. 3 is merely an example, and any number of stop leaf blades 8 can be set to be included in one aperture stop St.

In addition, at least one focusing group that moves during focusing is disposed in the optical system according to the present disclosure. During focusing, the focusing group moves along the optical axis Z, and other groups are fixed with respect to an image plane Sim. Focusing is performed by moving the focusing group.

For example, the optical system in FIG. 1 is a single-focus optical system and consists of three lens groups of a first lens group G1, a second lens group G2, and a third lens group G3 in this order from the object side to the image side. In the example in FIG. 1, the second lens group G2 is the focusing group. Each lens group of the optical system in FIG. 1 is configured as follows. The first lens group G1 consists of six lens components of the lens components C1 to C6 and the aperture stop St. The second lens group G2 consists of four lens components of the lens components C7 to C10. The third lens group G3 consists of two lens components of the lens components C11 and C12. A leftward arrow below the second lens group G2 in FIG. 1 indicates a direction in which the focusing group moves during focusing from the infinite distance object to the nearest object.

In the example in FIG. 1, the optical system is configured to consist of the three lens groups using spacings that change during focusing as boundaries for each lens group. According to this configuration, focusing can be performed without changing a total length of the optical system, and weight reduction of the focusing group can be achieved.

The expression “using the spacings that change during focusing as boundaries for each lens group” in the present specification means that during focusing, a mutual spacing between adjacent lens groups changes, and a mutual spacing between lenses does not change inside each lens group. That is, during focusing, lenses are configured to move in units of each lens group or not move. For example, in the example in FIG. 1, in a case where the spacings that change during focusing among spacings between surfaces are referred to as variable surface spacings, a group consisting of all optical elements disposed closer to the object side than the variable surface spacing closest to the object side is the first lens group G1, and a group consisting of all optical elements disposed between the variable surface spacing closest to the object side and the second variable surface spacing from the object side is the second lens group G2. The term “optical element” in the present specification includes a lens and an aperture stop. That is, each lens group may include a stop such as an aperture stop in addition to a lens.

Hereinafter, preferable configurations related to the lens components of the optical system according to the present disclosure will be described. Hereinafter, the same symbol will be used for the same definition for symbols of conditional expressions in order to omit duplicate descriptions of the definitions of the symbols. In addition, hereinafter, the term “optical system according to the present disclosure” will be simply referred to as the “optical system” in order to avoid redundancy.

First, the terms “negative concave lens component” and “first negative concave lens component” will be described. In the present specification, a lens component that is positioned closer to the object side than the aperture stop St, that has a negative refractive power, and of which a surface closest to the image side has a concave shape will be referred to as the “negative concave lens component”. The optical system according to the present disclosure preferably includes the negative concave lens component. In this case, an advantage of implementing a wide angle while reducing a diameter of a part of the optical system on the object side is achieved. In the example in FIG. 1, the lens component C1 and the lens component C2 correspond to the negative concave lens component.

In the present specification, the negative concave lens component having the maximum absolute value of an angle between the optical axis Z and a normal line to the surface of the negative concave lens component closest to the image side at a position of a maximum effective diameter of the surface in a cross section including the optical axis Z among the negative concave lens components included in the optical system will be referred to as the “first negative concave lens component”. The angle of the first negative concave lens component will be denoted by α1. The angle α1 is not an obtuse angle and is an acute angle. The angle α1 is in degree units. In the present specification, in a case where the surface from which the normal line is obtained is a concave surface, a sign of the angle is negative. In a case where the surface from which the normal line is obtained is a convex surface, the sign of the angle is positive. Thus, a sign of the angle α1 is negative.

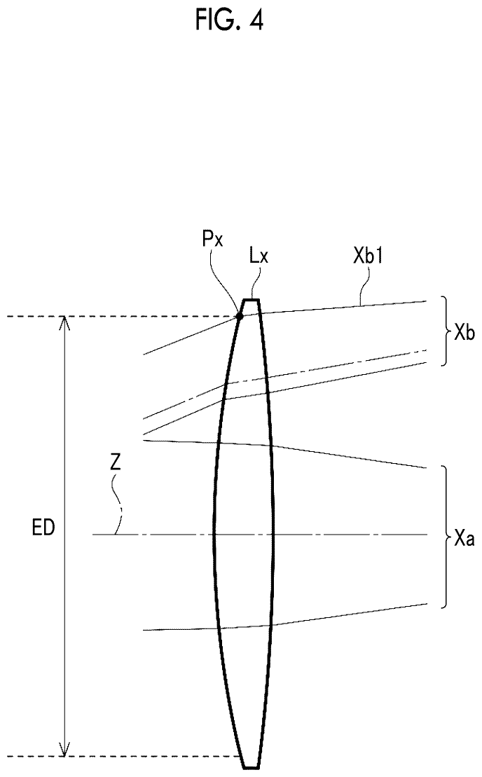

The term “position of the maximum effective diameter” used for defining the angle α1 will be described with reference to FIG. 4. FIG. 4 is a diagram for description. In FIG. 4, a left side is the object side, and a right side is the image side. FIG. 4 illustrates an on-axis luminous flux Xa and an off-axis luminous flux Xb passing through a lens Lx. In the example in FIG. 4, a ray Xb1 that is an upper ray of the off-axis luminous flux Xb is a ray passing through the outermost side. Here, the term “outer side” means an outer side in the diameter direction centered on the optical axis Z, that is, a side of separating from the optical axis Z. In the present specification, a position of an intersection between the ray passing through the outermost side and a lens surface is a position Px of the maximum effective diameter. In addition, double a distance from the position Px of the maximum effective diameter to the optical axis Z is an effective diameter ED of a surface of the lens Lx on the object side. While the upper ray of the off-axis luminous flux Xb is the ray passing through the outermost side in the example in FIG. 4, which ray is the ray passing through the outermost side varies depending on the optical system.

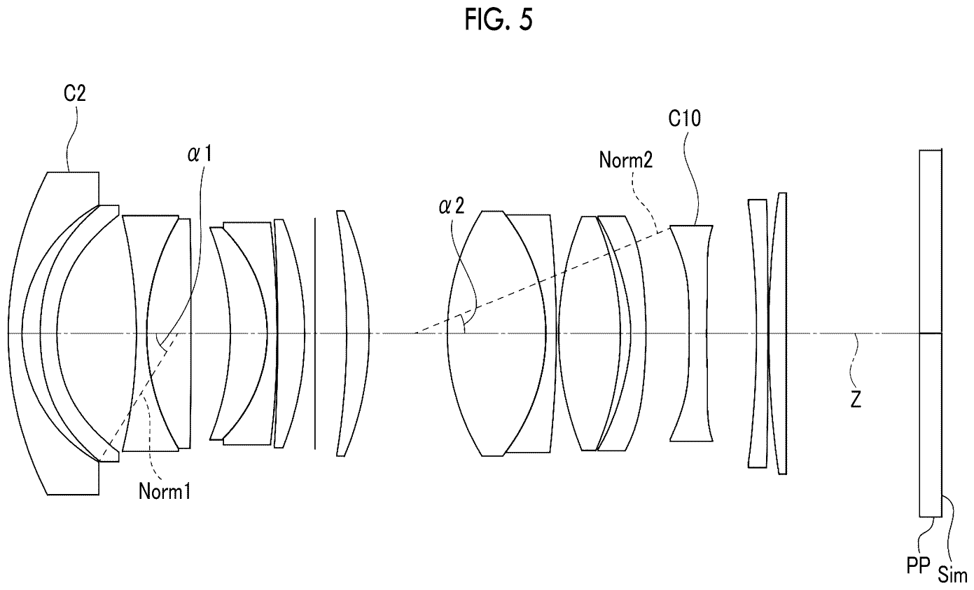

In the example in FIG. 1, the lens component C1 corresponds to the first negative concave lens component. For example, FIG. 5 illustrates a normal line Norm1 of a surface of the lens component C1 on the image side at the position of the maximum effective diameter of the surface and illustrates the angle α1 between the normal line Norm1 and the optical axis Z. As in the example in FIG. 1, in a case where the first negative concave lens component is configured to be a lens component of the optical system closest to the object side, an advantage of reducing a diameter of the lens component closest to the object side is achieved.

For the angle α1, the optical system preferably satisfies Conditional Expression (1) below. By not causing a corresponding value of Conditional Expression (1) to be less than or equal to its lower limit, refraction of off-axis rays in the first negative concave lens component can be suppressed. Thus, an advantage of suppressing an astigmatism is achieved. By not causing the corresponding value of Conditional Expression (1) to be greater than or equal to its upper limit, an advantage of reducing a diameter of a part of the optical system closer to the object side than the aperture stop St and implementing a wide angle while maintaining a small absolute value of a distortion is achieved. In order to obtain more favorable characteristics, the optical system more preferably satisfies at least one of Conditional Expression (1-1), (1-2), or (1-3) below.

$$- 80 < α1 < - 30 \qquad ( 1 )$$

$$- 70 < α1 < - 33 \qquad ( 1 - 1 )$$

$$- 65 < α1 < - 36 \qquad ( 1 - 2 )$$

$$- 60 < α1 < - 39 \qquad ( 1 - 3 )$$

In the optical system according to the present disclosure, the first negative concave lens component is preferably the lens component of the optical system closest to the object side or the second lens component of the optical system from the object side. In this case, an advantage of reducing the diameter of the lens component closest to the object side is achieved.

A first cemented lens that is obtained by bonding a negative lens and a positive lens to each other in this order from the object side and of which a surface closest to the object side has a concave shape is preferably disposed between a surface of the first negative concave lens component closest to the image side and the aperture stop St. In this case, the distortion and a lateral chromatic aberration can be corrected at the same time. In the example in FIG. 1, the lens component C3 corresponds to the first cemented lens.

The optical system preferably satisfies Conditional Expression (17) below. Here, a focal length of the optical system in the state where the infinite distance object is focused on will be denoted by f. A paraxial curvature radius of a surface of the first cemented lens closest to the object side will be denoted by Rc1. By not causing a corresponding value of Conditional Expression (17) to be less than or equal to its lower limit, an advantage of avoiding excessive correction of the astigmatism is achieved. By not causing the corresponding value of Conditional Expression (17) to be greater than or equal to its upper limit, an advantage of suppressing the astigmatism is achieved. In order to obtain more favorable characteristics, the optical system more preferably satisfies at least one of Conditional Expression (17-1), (17-2), or (17-3) below.

$$- 2 < f / Rc 1 < - 0.025 \qquad ( 17 )$$

$$- 1.5 < f / Rc 1 < - 0.1 \qquad ( 17 - 1 )$$

$$- 1.2 < f / Rc 1 < - 0.2 \qquad ( 17 - 2 )$$

$$- 1. 5 < f / Rc 1 < - 0.29 \qquad ( 17 - 3 )$$

Next, the term “P lens component” will be described. In the present specification, a lens component closest to the object side among lens components that are positioned closer to the image side than the aperture stop St and that have a positive refractive power will be referred to as the “P lens component”. The optical system according to the present disclosure preferably includes the P lens component. In this case, luminous fluxes closer to the image side than the P lens component can be caused to converge. Thus, a diameter of a part of the optical system closer to the image side than the P lens component can be reduced. In the example in FIG. 1, the lens component C6 corresponds to the P lens component.

The P lens component preferably includes a lens surface having a convex shape toward the image side. In this case, an advantage of correcting a spherical aberration is achieved.

For the P lens component, the optical system preferably satisfies Conditional Expression (4) below. Hereinafter, a distance on the optical axis from the aperture stop St to a surface of the P lens component closest to the object side in the state where the infinite distance object is focused on will be denoted by dStP. A back focus of the optical system as an air conversion distance in the state where the infinite distance object is focused on will be denoted by βf. In the present specification, the term “back focus of the optical system as the air conversion distance” refers to an air conversion distance on the optical axis from a lens surface of the optical system closest to the image side to the image plane Sim. A sum of Bf and a distance on the optical axis from the aperture stop St to the lens surface of the optical system closest to the image side in the state where the infinite distance object is focused on will be denoted by dStI. For example, FIG. 2 illustrates the distance dStP. By not causing a corresponding value of Conditional Expression (4) to be less than or equal to its lower limit, an advantage of securing a space for disposing an aperture stop mechanism is achieved. By not causing the corresponding value of Conditional Expression (4) to be greater than or equal to its upper limit, an advantage of reducing the total length of the optical system is achieved, and an advantage of reducing a diameter of the optical system closer to the image side than the aperture stop St is achieved. In order to obtain more favorable characteristics, the optical system more preferably satisfies at least one of Conditional Expression (4-1), (4-2), or (4-3) below.

$$0 < dStP / dStI < 0.38 \qquad ( 4 )$$

$$0.01 < d StP / dStI < 0.25 \qquad ( 4 - 1 )$$

$$0.01 4 < d StP / dStI < 0.15 \qquad ( 4 - 2 )$$

$$0.02 3 < d StP / dStI < 0.099 \qquad ( 4 - 3 )$$

The optical system preferably satisfies Conditional Expression (7) below. Hereinafter, a focal length of the P lens component will be denoted by fP. A maximum half angle of view of the optical system in the state where the infinite distance object is focused on will be denoted by ωm. A symbol Y will be defined as Y=f×tan ωm. Here, tan is a tangent. For example, FIG. 2 illustrates the maximum half angle of view ωm. By not causing a corresponding value of Conditional Expression (7) to be less than or equal to its lower limit, an advantage of decreasing an F-number while maintaining a small diameter of the part of the optical system closer to the image side than the aperture stop St is achieved. By not causing the corresponding value of Conditional Expression (7) to be greater than or equal to its upper limit, an advantage of suppressing the spherical aberration is achieved. In order to obtain more favorable characteristics, the optical system more preferably satisfies at least one of Conditional Expression (7-1), (7-2), or (7-3) below.

$$0.1 < Y / fP < 0.9 \qquad ( 7 )$$

$$0.145 < Y / fP < 0 \text{.82} \qquad ( 7 - 1 )$$

$$0.21 < Y / fP < 0 \text{.75} \qquad ( 7 - 2 )$$

$$0.26 < Y / fP < 0 \text{.69} \qquad ( 7 - 3 )$$

The optical system preferably satisfies Conditional Expression (20) below. Hereinafter, a refractive index of at least one positive lens included in the P lens component with respect to a d line will be denoted by Np. By not causing a corresponding value of Conditional Expression (20) to be less than or equal to its lower limit, an advantage of suppressing the spherical aberration is achieved. By not causing the corresponding value of Conditional Expression (20) to be greater than or equal to its upper limit, an advantage of suppressing sensitivity to error in surface shapes is achieved. In order to obtain more favorable characteristics, the optical system more preferably satisfies at least one of Conditional Expression (20-1), (20-2), (20-3), (20-4), (20-5), (20-6), or (20-7) below.

$$1.43 < N p < 2.2 \qquad ( 20 )$$

$$1.43 < N p < 2 \qquad ( 20 - 1 )$$

$$1.43 < N p < 1 \text{.75} \qquad ( 20 - 2 )$$

$$1.43 < N p < 1.6 \qquad ( 20 - 3 )$$

$$1.8 < N p < 2.2 \qquad ( 20 - 4 )$$

$$1.8 < N p < 2 \qquad ( 20 - 5 )$$

$$1.9 < N p < 2.2 \qquad ( 20 - 6 )$$

$$1.9 < N p < 2 \qquad ( 20 - 7 )$$

The optical system preferably satisfies Conditional Expression (21) below. Hereinafter, an Abbe number of at least one positive lens included in the P lens component based on the d line will be denoted by νp. By not causing a corresponding value of Conditional Expression (21) to be less than or equal to its lower limit, an advantage of suppressing an axial chromatic aberration is achieved. By not causing the corresponding value of Conditional Expression (21) to be greater than or equal to its upper limit, an advantage of avoiding excessive correction of the axial chromatic aberration is achieved. In order to obtain more favorable characteristics, the optical system more preferably satisfies at least one of Conditional Expression (21-1), (21-2), (21-3), (21-4), (21-5), (21-6), (21-7), (21-8), or (21-9) below.

$$14 < v p < 100 \qquad ( 21 )$$

$$14 < v p < 86 \qquad ( 21 - 1 )$$

$$14 < v p < 30 \qquad ( 21 - 1 )$$

$$14 < v p < 20 \qquad ( 21 - 3 )$$

$$30 < v p < 100 \qquad ( 21 - 4 )$$

$$30 < v p < 86 \qquad ( 21 - 5 )$$

$$50 < v p < 100 \qquad ( 21 - 6 )$$

$$50 < v p < 86 \qquad ( 21 - 7 )$$

$$70 < v p < 100 \qquad ( 21 - 8 )$$

$$70 < v p < 86 \qquad ( 21 - 9 )$$

Next, the term “Ed lens component” will be described. For each lens component of the optical system, a larger one of a maximum effective diameter of a surface closest to the object side and a maximum effective diameter of a surface closest to the image side will be referred to as a wide effective diameter. In the present specification, a lens component having the minimum wide effective diameter among lens components included from the surface of the P lens component closest to the object side to the surface, closest to the object side, of the lens component of the optical system closest to the image side will be referred to as the “Ed lens component”. By including the Ed lens component in the optical system, rays can be raised toward the image plane Sim using the Ed lens component. Thus, an advantage of correcting various aberrations of off-axis rays is achieved. In the example in FIG. 1, the lens component C10 corresponds to the Ed lens component.

For the Ed lens component, the optical system preferably satisfies Conditional Expression (5) below. Here, a focal length of the Ed lens component will be denoted by fEd. By not causing a corresponding value of Conditional Expression (5) to be less than or equal to its lower limit, an advantage of avoiding excessive correction of a field curvature caused by off-axis rays is achieved. By not causing the corresponding value of Conditional Expression (5) to be greater than or equal to its upper limit, an advantage of correcting the field curvature caused by off-axis rays is achieved. In order to obtain more favorable characteristics, the optical system more preferably satisfies at least one of Conditional Expression (5-1), (5-2), or (5-3) below.

$$- 0.2 \; 7 < Y / fEd , < 0.1 \qquad ( 5 )$$

$$- 0.24 < Y / fEd < 0 \qquad ( 5 - 1 )$$

$$- 0.2 \; 2 < Y / fEd < - 0.068 \qquad ( 5 - 2 )$$

$$- 0.1 \; 9 < Y / fEd < - 0.08 \qquad ( 5 - 3 )$$

An angle having a larger absolute value out of an angle between the optical axis Z and a normal line to a surface of the Ed lens component closest to the object side at the position of the maximum effective diameter of the surface and an angle between the optical axis Z and a normal line to a surface of the Ed lens component closest to the image side at the position of the maximum effective diameter of the surface in the cross section including the optical axis Z will be denoted by α2. The angle α2 is not an obtuse angle and is an acute angle. The angle α2 is in degree units. In a case where the surface from which the normal line is obtained is a concave surface, a sign of the angle α2 is negative. In a case where the surface from which the normal line is obtained is a convex surface, the sign of the angle α2 is positive. In the lens component C10 in the example in FIG. 1, an absolute value of an angle between the optical axis Z and a normal line to a surface on the object side at the position of the maximum effective diameter of the surface is larger than an absolute value of an angle between the optical axis Z and a normal line to a surface on the image side at the position of the maximum effective diameter. For example, FIG. 5 illustrates a normal line Norm2 of the surface of the lens component C10 on the object side at the position of the maximum effective diameter of the surface and illustrates the angle α2 between the normal line Norm2 and the optical axis Z.

For the angle α2, the optical system preferably satisfies Conditional Expression (6) below. By not causing a corresponding value of Conditional Expression (6) to be less than or equal to its lower limit, an advantage of avoiding excessive correction of the astigmatism caused by off-axis rays is achieved. By not causing the corresponding value of Conditional Expression (6) to be greater than or equal to its upper limit, an advantage of correcting the astigmatism caused by off-axis rays is achieved. In order to obtain more favorable characteristics, the optical system more preferably satisfies at least one of Conditional Expression (6-1), (6-2), or (6-3) below.

$$- 45 < α2 < 0 \qquad ( 6 )$$

$$- 42 < α2 < - 5 \qquad ( 6 - 1 )$$

$$- 40 < α2 < - 10 \qquad ( 6 - 2 )$$

$$- 36 < α2 < - 20 \qquad ( 6 - 3 )$$

The Ed lens component preferably includes an aspherical surface having a negative refractive power that is strengthened from the optical axis Z to a lens edge part. In this case, an advantage of correcting the astigmatism is achieved.

The optical system preferably satisfies Conditional Expression (22) below. Hereinafter, a refractive index of a lens having the maximum absolute value of a refractive power with respect to the d line among lenses included in the Ed lens component will be denoted by NEd. By not causing a corresponding value of Conditional Expression (22) to be less than or equal to its lower limit, an advantage of suppressing the field curvature is achieved. By not causing the corresponding value of Conditional Expression (22) to be greater than or equal to its upper limit, an advantage of suppressing the sensitivity to error in surface shapes is achieved. In order to obtain more favorable characteristics, the optical system more preferably satisfies at least one of Conditional Expression (22-1), (22-2), or (22-3) below.

$$1.65 < NEd < 2.2 \qquad ( 22 )$$

$$1.7 < NEd < 2 \qquad ( 22 - 1 )$$

$$1.75 < NEd < 1.9 \qquad ( 22 - 2 )$$

$$1.79 < NEd < 1.86 \qquad ( 22 - 3 )$$

The optical system preferably satisfies Conditional Expression (23) below. Hereinafter, an Abbe number of the lens having the maximum absolute value of the refractive power based on the d line among the lenses included in the Ed lens component will be denoted by νEd. By not causing a corresponding value of Conditional Expression (23) to be less than or equal to its lower limit, an advantage of avoiding excessive correction of the lateral chromatic aberration is achieved. By not causing the corresponding value of Conditional Expression (23) to be greater than or equal to its upper limit, an advantage of suppressing the lateral chromatic aberration is achieved. In order to obtain more favorable characteristics, the optical system more preferably satisfies at least one of Conditional Expression (23-1), (23-2), or (23-3) below.

$$30.5 < vEd < 55 \qquad ( 23 )$$

$$33 < vEd < 50 \qquad ( 23 - 1 )$$

$$35 < vEd < 45 \qquad ( 23 - 2 )$$

$$38 < vEd < 42.5 \qquad ( 23 - 3 )$$

A second cemented lens obtained by bonding a positive lens and a negative lens to each other in this order from the object side is preferably disposed between a surface of the P lens component closest to the image side and the surface of the Ed lens component closest to the object side. In this case, the spherical aberration and the axial chromatic aberration can be corrected at the same time. In the example in FIG. 1, the lens component C7 corresponds to the second cemented lens.

The optical system preferably satisfies Conditional Expression (18) below. Hereinafter, a paraxial curvature radius of a surface of the second cemented lens closest to the object side will be denoted by Rc2. By not causing a corresponding value of Conditional Expression (18) to be less than or equal to its lower limit, an advantage of suppressing the spherical aberration is achieved. By not causing the corresponding value of Conditional Expression (18) to be greater than or equal to its upper limit, an advantage of avoiding excessive correction of the spherical aberration is achieved. In order to obtain more favorable characteristics, the optical system more preferably satisfies at least one of Conditional Expression (18-1), (18-2), or (18-3) below.

$$0.02 < f / Rc 2 < 1.5 \qquad ( 18 )$$

$$0.25 < f / Rc 2 < 1.2 \qquad ( 18 - 1 )$$

$$0.4 < f / Rc 2 < 1.1 \qquad ( 18 - 2 )$$

$$0.5 < f / Rc 2 < 1.05 \qquad ( 18 - 3 )$$

Next, the terms “Asp1 lens component”, “Asp2 lens component”, and “Asp3 lens component” will be described as lens components related to aspherical surfaces. In the present specification, a lens component that is disposed closer to the image side than the aperture stop St and that includes at least one aspherical surface and a lens of which a refractive power at the position of the maximum effective diameter is shifted in a positive direction compared to the refractive power in a paraxial region will be referred to as the “Asp1 lens component”. The optical system may be configured to include the Asp1 lens component. In this case, an advantage of suppressing the field curvature is achieved. In a case where the Asp1 lens component is disposed between the P lens component and the Ed lens component, an advantage of further suppressing the field curvature is achieved.

In a case where the surface of the lens component closest to the object side and the surface of the lens component closest to the image side have different maximum effective diameters, the maximum effective diameter of the surface having a smaller maximum effective diameter will be used as the “maximum effective diameter” related to the Asp1 lens component. The term “refractive power” related to the Asp1 lens component in the expression “refractive power at the position of the maximum effective diameter compared to the refractive power in the paraxial region” does not mean a refractive power of a lens surface and means a refractive power of a lens.

The expression “refractive power at the position of the maximum effective diameter is shifted in the positive direction compared to the refractive power in the paraxial region” has the following meanings based on a sign of the refractive power. In a case where the lens has a positive refractive power in both of the paraxial region and the position of the maximum effective diameter, this means that the positive refractive power is strong at the position of the maximum effective diameter compared to that in the paraxial region. In a case where the lens has a negative refractive power in both of the paraxial region and the position of the maximum effective diameter, this means that the positive refractive power is weak at the position of the maximum effective diameter compared to that in the paraxial region. In a case where the lens has refractive powers of different signs between the paraxial region and the position of the maximum effective diameter, this means that the positive refractive power is negative in the paraxial region, and the refractive power is positive at the position of the maximum effective diameter.

In the present specification, a lens component that includes at least one lens surface having an aspherical shape of which a refractive power at the position of the maximum effective diameter is shifted in the positive direction compared to the refractive power in the paraxial region will be referred to as the “Asp2 lens component”. The optical system may be configured to include the Asp2 lens component. In this case, an advantage of suppressing the astigmatism is achieved. In a case where the Asp2 lens component is disposed closer to the image side than the Ed lens component, an advantage of further suppressing the astigmatism is achieved.

In the present specification, a lens component that includes at least one lens surface having an aspherical shape of which a refractive power at the position of the maximum effective diameter is shifted in a negative direction compared to the refractive power in the paraxial region will be referred to as the “Asp3 lens component”. The optical system may be configured to include the Asp3 lens component. In this case, an advantage of suppressing the distortion is achieved. In a case where the Asp3 lens component is disposed closer to the image side than the Ed lens component, an advantage of further suppressing the distortion is achieved. An advantage of further suppressing the distortion is also achieved in a case where the Asp3 lens component is disposed closer to the image side than the Asp2 lens component.

The term “refractive power” related to the Asp2 lens component and the Asp3 lens component in the expression “refractive power at the position of the maximum effective diameter compared to the refractive power in the paraxial region” means a refractive power of a lens surface. In the same manner as the Asp1 lens component, the expression “refractive power at the position of the maximum effective diameter is shifted in the positive direction compared to the refractive power in the paraxial region” related to the Asp2 lens component has the following meanings. In a case where the lens surface has a positive refractive power in both of the paraxial region and the position of the maximum effective diameter, this means that the positive refractive power is strong at the position of the maximum effective diameter compared to that in the paraxial region. In a case where the lens surface has a negative refractive power in both of the paraxial region and the position of the maximum effective diameter, this means that the positive refractive power is weak at the position of the maximum effective diameter compared to that in the paraxial region. In a case where the lens surface has refractive powers of different signs between the paraxial region and the position of the maximum effective diameter, this means that the positive refractive power is negative in the paraxial region, and the refractive power is positive at the position of the maximum effective diameter. The expression “refractive power at the position of the maximum effective diameter is shifted in the negative direction compared to the refractive power in the paraxial region” related to the Asp3 lens component can be considered by reversing the sign in the description related to the Asp2 lens component.

In a case where the optical system includes the Asp1 lens component, the optical system preferably satisfies Conditional Expression (29) below. Here, a focal length of the Asp1 lens component will be denoted by fAsp1. By not causing a corresponding value of Conditional Expression (29) to be less than or equal to its lower limit, an advantage of suppressing an effect of error in assembling the Asp1 lens component is achieved. By not causing the corresponding value of Conditional Expression (29) to be greater than or equal to its upper limit, an advantage of suppressing the field curvature is achieved. In order to obtain more favorable characteristics, the optical system more preferably satisfies at least one of Conditional Expression (29-1), (29-2), or (29-3) below.

$$- 0.9 < f / fAsp1 < - 0.2 \qquad ( 29 )$$

$$- 0.8 < f / fAsp1 < - 0.28 \qquad ( 29 - 1 )$$

$$- 0.7 < f / fAsp1 < - 0.35 \qquad ( 29 - 2 )$$

$$- 0.6 < f / fAsp1 < - 0.41 \qquad ( 29 - 3 )$$

In a case where the optical system includes the Asp1 lens component, the optical system preferably satisfies Conditional Expression (32) below. Here, an Abbe number of a lens having the maximum absolute value of a refractive power based on the d line among lenses included in the Asp1 lens component will be denoted by νAsp1. By not causing a corresponding value of Conditional Expression (32) to be less than or equal to its lower limit, a lens of a material having a lower refractive index can be selected. Thus, an effect of error in surface shapes can be suppressed. By not causing the corresponding value of Conditional Expression (32) to be greater than or equal to its upper limit, an advantage of suppressing the lateral chromatic aberration is achieved. In order to obtain more favorable characteristics, the optical system more preferably satisfies at least one of Conditional Expression (32-1), (32-2), or (32-3) below.

$$15 < vAsp 1 < 45 \qquad ( 32 )$$

$$20 < vAsp 1 < 40 \qquad ( 32 - 1 )$$

$$25 < vAsp 1 < 35 \qquad ( 32 - 2 )$$

$$29.5 < vAsp 1 < 32.5 \qquad ( 32 - 3 )$$

In a case where the optical system includes the Asp2 lens component, the optical system preferably satisfies Conditional Expression (30) below. Here, a paraxial curvature radius of a surface of the Asp2 lens component closest to the object side will be denoted by RAsp2. By not causing a corresponding value of Conditional Expression (30) to be less than or equal to its lower limit, an advantage of suppressing the spherical aberration is achieved. By not causing the corresponding value of Conditional Expression (30) to be greater than or equal to its upper limit, an advantage of suppressing the astigmatism is achieved. In order to obtain more favorable characteristics, the optical system more preferably satisfies at least one of Conditional Expression (30-1), (30-2), or (30-3) below.

$$- 2.5 < f / RAsp 2 < 0.78 \qquad ( 30 )$$

$$- 2 < f / RAsp 2 < 0 \qquad ( 30 - 1 )$$

$$- 1.5 < f / RAsp 2 < - 0.35 \qquad ( 30 - 2 )$$

$$- 1.21 < f / RAsp 2 < 0.65 \qquad ( 30 - 3 )$$

In a case where the optical system includes the Asp3 lens component, the optical system preferably satisfies Conditional Expression (31) below. Here, a paraxial curvature radius of a surface of the Asp3 lens component closest to the object side will be denoted by RAsp3. By not causing a corresponding value of Conditional Expression (31) to be less than or equal to its lower limit, an advantage of suppressing the spherical aberration is achieved. By not causing the corresponding value of Conditional Expression (31) to be greater than or equal to its upper limit, an advantage of suppressing the distortion is achieved. In order to obtain more favorable characteristics, the optical system more preferably satisfies at least one of Conditional Expression (31-1), (31-2), or (31-3) below.

$$0.3 < f / RAsp 3 < 1.6 \qquad ( 31 )$$

$$0.4 < f / RAsp 3 < 1.4 \qquad ( 31 - 1 )$$

$$0.5 < f / RAsp 3 < 1.2 \qquad ( 31 - 2 )$$

$$0.64 < f / RAsp 3 < 1.06 \qquad ( 31 - 3 )$$

Next, preferable configurations related to the focusing group will be described. In the present specification, symbols will be defined for each focusing group as follows. A moving amount of the focusing group during focusing on the nearest object from the infinite distance object is denoted by Mf. For example, FIG. 2 illustrates the moving amount Mf. A lateral magnification of the focusing group in the state where the infinite distance object is focused on is denoted by βf. A combined lateral magnification of all lenses closer to the image side than the focusing group in the state where the infinite distance object is focused on is denoted by βfR. A symbol γ is defined as γ=(1−βf²)×βfR². In a case where there is no lens closer to the image side than the focusing group, βfR=1 is established. In the present specification, a focusing group having the maximum |Mf×γ| among focusing groups of the optical systems will be referred to as the “maximum focusing group”. The maximum focusing group is a focusing group having a main focus adjustment effect (that is, a focused position adjustment effect).

In a case where the optical system includes only one focusing group, the one focusing group is the maximum focusing group. In the example in FIG. 1, the second lens group G2 corresponds to the maximum focusing group. As in the example in FIG. 1, the maximum focusing group may be configured to be disposed closer to the image side than the aperture stop St. In this case, an advantage of suppressing fluctuations of aberrations during focusing is achieved. However, in the optical system according to the present disclosure, the maximum focusing group may be configured to be disposed closer to the object side than the aperture stop St. In this case, an advantage of suppressing fluctuations of an angle of view during focusing is achieved.

The optical system preferably satisfies Conditional Expression (12) below. Here, a focal length of the maximum focusing group will be denoted by ffm. By not causing a corresponding value of Conditional Expression (12) to be less than or equal to its lower limit, a refractive power of the maximum focusing group can be strengthened. Thus, a moving amount of the maximum focusing group during focusing on the nearest object from the infinite distance object can be suppressed. Accordingly, an advantage of size reduction is achieved. By not causing the corresponding value of Conditional Expression (12) to be greater than or equal to its upper limit, the refractive power of the maximum focusing group is not excessively strengthened. Thus, an advantage of suppressing fluctuations of aberrations during focusing is achieved. In order to obtain more favorable characteristics, the optical system more preferably satisfies at least one of Conditional Expression (12-1), (12-2), or (12-3) below.

$$0.05 < f / \vert ffm \vert < 0.95 \qquad ( 12 )$$

$$0.2 < f / \vert ffm \vert < 0.8 \qquad ( 12 - 1 )$$

$$0.36 < f / \vert ffm \vert < 0.7 \qquad ( 12 - 2 )$$

$$0.41 < f / \vert ffm \vert < 0.6 \qquad ( 12 - 3 )$$

The optical system preferably satisfies Conditional Expression (13) below. Here, a combined focal length of all lenses closer to the object side than the maximum focusing group will be denoted by ffmF. By not causing a corresponding value of Conditional Expression (13) to be less than or equal to its lower limit, luminous fluxes incident on the maximum focusing group do not tend to excessively diverse. Thus, an advantage of reducing a diameter of the maximum focusing group is achieved. By not causing the corresponding value of Conditional Expression (13) to be greater than or equal to its upper limit, luminous fluxes incident on the maximum focusing group do not tend to excessively converge. Thus, an advantage of suppressing fluctuations of the spherical aberration during focusing is achieved. In order to obtain more favorable characteristics, the optical system more preferably satisfies at least one of Conditional Expression (13-1), (13-2), (13-3), (13-4), (13-5), (13-6), (13-7), (13-8), (13-9), or (13-10) below.

$$- 0.9 < f / ffmF < 2 \qquad ( 13 )$$

$$- 0.47 < f / ffmF < 2 \qquad ( 13 - 1 )$$

$$0.01 < f / ffmF < 2 \qquad ( 13 - 2 )$$

$$- 0.9 < f / ffmF < 1.5 \qquad ( 13 - 3 )$$

$$- 0.47 < f / ffmF < 1.5 \qquad ( 13 - 4 )$$

$$0.01 < f / ffmF < 1.5 \qquad ( 13 - 5 )$$

$$- 0.9 < f / ffmF < 0.2 \qquad ( 13 - 6 )$$

$$- 0.47 < f / ffmF < 0.2 \qquad ( 13 - 7 )$$

$$0.01 < f / ffmF < 0.2 \qquad ( 13 - 8 )$$

$$- 0.9 < f / ffmF < - 0.2 \qquad ( 13 - 9 )$$

$$- 0.47 < f / ffmF < - 0.2 \qquad ( 13 - 10 )$$

The optical system preferably satisfies Conditional Expression (14) below. Here, γ of the maximum focusing group will be denoted by γfm. By not causing a corresponding value of Conditional Expression (14) to be less than or equal to its lower limit, the moving amount of the maximum focusing group during focusing on the nearest object from the infinite distance object can be suppressed. Thus, an advantage of size reduction is achieved. By not causing the corresponding value of Conditional Expression (14) to be greater than or equal to its upper limit, sensitivity to error in the maximum focusing group can be suppressed. In order to obtain more favorable characteristics, the optical system more preferably satisfies at least one of Conditional Expression (14-1), (14-2), or (14-3) below.

$$0.38 < \vert γ fm \vert < 2.5 \qquad ( 14 )$$

$$0.6 < \vert γ fm \vert < 2.3 \qquad ( 14 - 1 )$$

$$0.7 < \vert γ fm \vert < 2 \qquad ( 14 - 2 )$$

$$0.83 < \vert γ fm \vert < 1.83 \qquad ( 14 - 3 )$$

The optical system preferably satisfies Conditional Expression (15) below. Here, Mf of the maximum focusing group will be denoted by Mfm. A sum of Bf and a distance on the optical axis from the lens surface of the optical system closest to the object side to the lens surface of the optical system closest to the image side in the state where the infinite distance object is focused on will be denoted by TL. By not causing a corresponding value of Conditional Expression (15) to be less than or equal to its lower limit, the sensitivity to error in the maximum focusing group can be suppressed. By not causing the corresponding value of Conditional Expression (15) to be greater than or equal to its upper limit, the moving amount of the maximum focusing group during focusing on the nearest object from the infinite distance object can be suppressed. Thus, an advantage of size reduction is achieved. In order to obtain more favorable characteristics, the optical system more preferably satisfies at least one of Conditional Expression (15-1), (15-2), or (15-3) below.

$$0.006 < \vert Mfm \vert / TL < 0.15 \qquad ( 15 )$$

$$0.008 < \vert Mfm \vert / TL < 0.1 \qquad ( 15 - 1 )$$

$$0.1 < \vert Mfm \vert / TL < 0.065 \qquad ( 15 - 2 )$$

$$0. \text{.13} < \vert Mfm \vert / TL < 0.045 \qquad ( 15 - 3 )$$

The optical system preferably satisfies Conditional Expression (16) below. Here, a combined focal length of all lenses closer to the image side than the maximum focusing group will be denoted by ffmR. By not causing a corresponding value of Conditional Expression (16) to be less than or equal to its lower limit, an advantage of reducing the diameter of the maximum focusing group while decreasing the F-number is achieved. By not causing the corresponding value of Conditional Expression (16) to be greater than or equal to its upper limit, refraction of off-axis rays can be weakened on a side closer to the image side than the maximum focusing group. Thus, an advantage of suppressing fluctuations of the spherical aberration astigmatism during focusing is achieved. In order to obtain more favorable characteristics, the optical system more preferably satisfies at least one of Conditional Expression (16-1), (16-2), (16-3), (16-4), (16-5), (16-6), (16-7), (16-8), or (16-9) below.

$$- 0.5 < f / ffmR < 1.5 \qquad ( 16 )$$

$$- 0.11 < f / ffmR < 1.5 \qquad ( 16 - 1 )$$

$$0.35 < f / ffmR < 1.5 \qquad ( 16 - 2 )$$

$$0.6 < f / ffmR < 1.5 \qquad ( 16 - 3 )$$

$$- 0.5 < f / ffmR < 1.1 \qquad ( 16 - 4 )$$

$$- 0.11 < f / ffmR < 1.1 \qquad ( 16 - 5 )$$

$$0.35 < f / ffmR < 1.1 \qquad ( 16 - 6 )$$

$$0.6 < f / ffmR < 1.1 \qquad ( 16 - 7 )$$

$$- 0.5 < f / ffmR < 0.2 \qquad ( 16 - 8 )$$

$$- 0.11 < f / ffmR < 0.2 \qquad ( 16 - 9 )$$

Next, preferable configurations other than the above will be described. In a case where an open F-number of the optical system in the state where the infinite distance object is focused on is denoted by FNo, the optical system preferably satisfies Conditional Expression (2) below. By not causing a corresponding value of Conditional Expression (2) to be less than or equal to its lower limit, an advantage of weight reduction, reduction of the total length of the optical system, and suppression of various aberrations in on-axis rays is achieved. By not causing the corresponding value of Conditional Expression (2) to be greater than or equal to its upper limit, a bright optical system that takes in a larger light quantity can be implemented. In order to obtain more favorable characteristics, the optical system more preferably satisfies at least one of Conditional Expression (2-1), (2-2), or (2-3) below.

$$0.5 < FNo < 2.3 \qquad ( 2 )$$

$$1.1 < FNo < 1.95 \qquad ( 2 - 1 )$$

$$1.3 < FNo < 1.9 \qquad ( 2 - 2 )$$

$$1.5 < FNo < 1.84 \qquad ( 2 - 3 )$$

The optical system preferably satisfies Conditional Expression (3) below. By not causing a corresponding value of Conditional Expression (3) to be less than or equal to its lower limit, an advantage of suppressing ghosts caused by reflection on a lens surface disposed closer to the image side than the aperture stop St and on an imaging surface of an imaging element or the like is achieved. By not causing the corresponding value of Conditional Expression (3) to be greater than or equal to its upper limit, an advantage of reducing the total length of the optical system is achieved. In order to obtain more favorable characteristics, the optical system more preferably satisfies at least one of Conditional Expression (3-1), (3-2), or (3-3) below.

$$0.5 < Bf / Y < 1.7 \qquad ( 3 )$$

$$0.62 < Bf / Y < 1.5 \qquad ( 3 - 1 )$$

$$0.68 < Bf / Y < 1.3 \qquad ( 3 - 2 )$$

$$0.72 < Bf / Y < 1.18 \qquad ( 3 - 3 )$$

The optical system preferably satisfies Conditional Expression (8) below. Here, om is in degree units. By not causing a corresponding value of Conditional Expression (8) to be less than or equal to its lower limit, an optical system having a wider imaging range can be implemented. By not causing the corresponding value of Conditional Expression (8) to be greater than or equal to its upper limit, an advantage of suppressing various aberrations caused by off-axis rays is achieved. In order to obtain more favorable characteristics, the optical system more preferably satisfies at least one of Conditional Expression (8-1), (8-2), or (8-3) below.

$$32 < ω m < 55 \qquad ( 8 )$$

$$33 < ω m < 52 \qquad ( 8 - 1 )$$

$$35 < ω m < 50 \qquad ( 8 - 2 )$$

$$37 < ω m < 48 \qquad ( 8 - 3 )$$

The optical system preferably satisfies Conditional Expression (9) below. Here, a distance on the optical axis from the lens surface of the optical system closest to the object side to a paraxial entrance pupil position in the state where the infinite distance object is focused on will be denoted by Denp. For example, FIG. 2 illustrates a paraxial entrance pupil position Penp and the distance Denp. By not causing a corresponding value of Conditional Expression (9) to be less than or equal to its lower limit, an advantage of reducing the diameter of the part of the optical system on the object side is achieved. By not causing the corresponding value of Conditional Expression (9) to be greater than or equal to its upper limit, on-axis rays and off-axis rays can be separated from each other in a lens on the object side. Thus, an advantage of correcting various aberrations caused by off-axis rays is achieved. In order to obtain more favorable characteristics, the optical system more preferably satisfies at least one of Conditional Expression (9-1), (9-2), or (9-3) below.

$$0.83 < f / Denp < 2.5 \qquad ( 9 )$$

$$0.92 < f / Denp < 2 \qquad ( 9 - 1 )$$

$$0.97 < f / Denp < 1.8 \qquad ( 9 - 2 )$$

$$1.02 < f / Denp < 1 \text{.55} \qquad ( 9 - 3 )$$

The optical system preferably satisfies Conditional Expression (10) below. Here, a distance on the optical axis from a paraxial exit pupil position to the image plane Sim in the state where the infinite distance object is focused on will be denoted by Dexp. In a case where an optical member not having a refractive power is disposed between the image plane Sim and the paraxial exit pupil position, Dexp is calculated using an air conversion distance for the optical member. For example, the optical member PP in the example in FIG. 1 is an optical member that is disposed between the image plane Sim and the paraxial exit pupil position and that does not have a refractive power. For example, FIG. 2 illustrates a paraxial exit pupil position Pexp. By not causing a corresponding value of Conditional Expression (10) to be less than or equal to its lower limit, an advantage of securing an edge part light quantity is achieved. By not causing the corresponding value of Conditional Expression (10) to be greater than or equal to its upper limit, an advantage of reducing the total length of the optical system is achieved. In order to obtain more favorable characteristics, the optical system more preferably satisfies at least one of Conditional Expression (10-1), (10-2), or (10-3) below.

$$0.25 < D exp / Y < 0.5 \qquad ( 10 )$$

$$0.27 < D exp / Y < 0 \text{.48} \qquad ( 10 - 1 )$$

$$0.29 < D exp / Y < 0 \text{.46} \qquad ( 10 - 2 )$$

$$0.31 < D exp / Y < 0 \text{.42} \qquad ( 10 - 3 )$$

The optical system preferably satisfies Conditional Expression (11) below. Here, a lateral magnification of the optical system in the state where the nearest object is focused on will be denoted by B. By not causing a corresponding value of Conditional Expression (11) to be less than or equal to its lower limit, a more enlarged image of a subject can be captured. By not causing the corresponding value of Conditional Expression (11) to be greater than or equal to its upper limit, a space for moving the focusing group during focusing can be reduced. Thus, an advantage of size reduction is achieved. In order to obtain more favorable characteristics, the optical system more preferably satisfies at least one of Conditional Expression (11-1), (11-2), or (11-3) below.

$$0.07 < \vert B \vert < 0.3 \qquad ( 11 )$$

$$0.095 < \vert B \vert < 0 \text{.24} \qquad ( 11 - 1 )$$

$$0.105 < \vert B \vert < 0.2 \qquad ( 11 - 2 )$$

$$0.115 < \vert B \vert < 0 \text{.16} \qquad ( 11 - 3 )$$

The optical system preferably satisfies Conditional Expression (19) below. Here, a maximum value of refractive indexes of all lenses of the optical system with respect to the d line will be denoted by Nmax. By not causing a corresponding value of Conditional Expression (19) to be less than or equal to its lower limit, an advantage of suppressing the field curvature is achieved. By not causing the corresponding value of Conditional Expression (19) to be greater than or equal to its upper limit, an advantage of suppressing the sensitivity to error in surface shapes is achieved. In order to obtain more favorable characteristics, the optical system more preferably satisfies at least one of Conditional Expression (19-1), (19-2), or (19-3) below.

$$1.85 < N max < 2.5 \qquad ( 19 )$$

$$1.9 < N max < 2.4 \qquad ( 19 - 1 )$$

$$1.95 < N max < 2.3 \qquad ( 19 - 2 )$$

$$2 < N max < 2.2 \qquad ( 19 - 3 )$$

The example illustrated in FIG. 1 is merely an example, and various modifications can be made without departing from the gist of the disclosed technology. For example, the number of lens groups included in the optical system, the number of lenses included in each lens group, the number of focusing groups included in the optical system, and the number of lenses included in the focusing group may be different from the numbers in the example in FIG. 1. In addition, configurations of lenses included in each lens group can be different from the configurations in the example in FIG. 1.

For example, the optical system in FIG. 1 consists of three lens groups of the first lens group G1, the second lens group G2, and the third lens group G3 in this order from the object side to the image side using the spacings that change during focusing as the boundaries for each lens group. However, the optical system according to the present disclosure is not limited to this configuration.

As in an example described later, the optical system according to the present disclosure may be configured to consist of four lens groups of the first lens group G1, the second lens group G2, the third lens group G3, and a fourth lens group G4 in this order from the object side to the image side using the spacings that change during focusing as the boundaries for each lens group. In this case, focusing can be performed without changing the total length of the optical system, weight reduction of the focusing group can be achieved, and fluctuations of aberrations during focusing can be suppressed.

Alternatively, as in another example described later, the optical system according to the present disclosure may be configured to consist of five lens groups of the first lens group G1, the second lens group G2, the third lens group G3, the fourth lens group G4, and a fifth lens group G5 in this order from the object side to the image side using the spacings that change during focusing as the boundaries for each lens group. In this case, focusing can be performed without changing the total length of the optical system, weight reduction of the focusing group can be achieved, and fluctuations of aberrations during focusing can be suppressed.

In each of a case where the optical system consists of three lens groups, a case where the optical system consists of four lens groups, and a case where the optical system consists of five lens groups as described above, the optical system preferably satisfies Conditional Expression (24) below. Here, a focal length of the first lens group G1 will be denoted by f1. By not causing a corresponding value of Conditional Expression (24) to be less than or equal to its lower limit, divergence of luminous fluxes to a side closer to the image side than the first lens group G1 can be suppressed. Thus, an advantage of reducing a diameter of a lens group closer to the image side than the first lens group G1 is achieved. By not causing the corresponding value of Conditional Expression (24) to be greater than or equal to its upper limit, convergence of luminous fluxes to a side closer to the image side than the first lens group G1 can be suppressed. Thus, an advantage of decreasing the F-number is achieved. In order to obtain more favorable characteristics, the optical system more preferably satisfies at least one of Conditional Expression (24-1), (24-2), (24-3), (24-4), (24-5), (24-6), or (24-7) below.

$$- 0.7 < f / f 1 < 1.5 \qquad ( 24 )$$

$$- 0.7 < f / f 1 < 1 \qquad ( 24 - 1 )$$

$$- 0.7 < f / f 1 < 0.25 \qquad ( 24 - 2 )$$

$$- 0.7 < f / f 1 < 0 \qquad ( 24 - 3 )$$

$$- 0.7 < f / f 1 < - 0.3 \qquad ( 24 - 4 )$$

$$0 < f / f 1 < 1.5 \qquad ( 24 - 5 )$$

$$0 < f / f 1 < 1 \qquad ( 24 - 6 )$$

$$0 < f / f 1 < 0.25 \qquad ( 24 - 7 )$$

In each of a case where the optical system consists of three lens groups, a case where the optical system consists of four lens groups, and a case where the optical system consists of five lens groups as described above, the optical system preferably satisfies Conditional Expression (25) below. Here, a focal length of the second lens group G2 will be denoted by f2. By not causing a corresponding value of Conditional Expression (25) to be less than or equal to its lower limit, divergence of luminous fluxes to a side closer to the image side than the second lens group G2 can be suppressed. Thus, an advantage of reducing a diameter of a lens group closer to the image side than the second lens group G2 is achieved. By not causing the corresponding value of Conditional Expression (25) to be greater than or equal to its upper limit, convergence of luminous fluxes to a side closer to the image side than the second lens group G2 can be suppressed. Thus, an advantage of suppressing the spherical aberration is achieved. In order to obtain more favorable characteristics, the optical system more preferably satisfies at least one of Conditional Expression (25-1), (25-2), (25-3), (25-4), or (25-5) below.

$$- 0.65 < f / f 2 < 0 \text{.65} \qquad ( 25 )$$

$$- 0.6 \; 5 < f / f 2 < - 0.1 \qquad ( 25 - 1 )$$

$$- 0.6 \; 5 < f / f 2 < - 0.4 \qquad ( 25 - 2 )$$

$$- 0.1 < f / f 2 < 0 \text{.65} \qquad ( 25 - 3 )$$

$$0.2 < f / f 2 < 0 \text{.65} \qquad ( 25 - 4 )$$

$$0.4 < f / f 2 < 0 \text{.65} \qquad ( 25 - 5 )$$

In each of a case where the optical system consists of three lens groups, a case where the optical system consists of four lens groups, and a case where the optical system consists of five lens groups as described above, the optical system preferably satisfies Conditional Expression (26) below. Here, a focal length of the third lens group G3 will be denoted by f3. By not causing a corresponding value of Conditional Expression (26) to be less than or equal to its lower limit, divergence of luminous fluxes to a side closer to the image side than the third lens group G3 can be suppressed. Thus, an advantage of securing the back focus is achieved. By not causing the corresponding value of Conditional Expression (26) to be greater than or equal to its upper limit, convergence of luminous fluxes to a side closer to the image side than the third lens group G3 can be suppressed. Thus, an advantage of reducing the total length of the optical system is achieved. In order to obtain more favorable characteristics, the optical system more preferably satisfies at least one of Conditional Expression (26-1), (26-2), (26-3), (26-4), (26-5), (26-6), (26-7), (26-8), (26-9), (26-10), or (26-11) below.

$$- 0.5 < f / f 3 < 1.1 \qquad ( 26 )$$

$$- 0.5 < f / f 3 < 0.5 \qquad ( 26 - 1 )$$

$$- 0.5 < f / f 3 < 0.2 \qquad ( 26 - 2 )$$

$$- 0.5 < f / f 3 < 0 \qquad ( 26 - 3 )$$

$$- 0.2 < f / f 3 < 1.1 \qquad ( 26 - 4 )$$

$$- 0.2 < f / f 3 < 0.5 \qquad ( 26 - 5 )$$

$$- 0.2 < f / f 3 < 0.2 \qquad ( 26 - 6 )$$

$$- 0.2 < f / f 3 < 0 \qquad ( 26 - 7 )$$

$$0 < f / f 3 < 1.1 \qquad ( 26 - 8 )$$

$$0 < f / f 3 < 0.5 \qquad ( 26 - 9 )$$

$$0 < f / f 3 < 0.2 \qquad ( 26 - 10 )$$

$$0.6 < f / f 3 < 1.1 \qquad ( 26 - 11 )$$

In each of a case where the optical system consists of four lens groups and a case where the optical system consists of five lens groups as described above, the optical system preferably satisfies Conditional Expression (27) below. Here, a focal length of the fourth lens group G4 will be denoted by f4. By not causing a corresponding value of Conditional Expression (27) to be less than or equal to its lower limit, divergence of luminous fluxes to a side closer to the image side than the fourth lens group G4 can be suppressed. Thus, an advantage of securing the back focus is achieved. By not causing the corresponding value of Conditional Expression (27) to be greater than or equal to its upper limit, convergence of luminous fluxes to a side closer to the image side than the fourth lens group G4 can be suppressed. Thus, an advantage of reducing the total length of the optical system is achieved. In order to obtain more favorable characteristics, the optical system more preferably satisfies at least one of Conditional Expression (27-1), (27-2), (27-3), (27-4), or (27-5) below.

$$0.01 < f / f 4 < 0.9 \qquad ( 27 )$$

$$0.01 < f / f 4 < 0.5 \qquad ( 27 - 1 )$$

$$0.01 < f / f 4 < 0.13 \qquad ( 27 - 2 )$$

$$0.2 < f / f 4 < 0.9 \qquad ( 27 - 3 )$$

$$0.5 < f / f 4 < 0.9 \qquad ( 27 - 4 )$$

$$0.7 < f / f 4 < 0.9 \qquad ( 27 - 5 )$$

In a case where the optical system consists of five lens groups as described above, the optical system preferably satisfies Conditional Expression (28) below. Here, a focal length of the fifth lens group G5 will be denoted by f5. By not causing a corresponding value of Conditional Expression (28) to be less than or equal to its lower limit, divergence of luminous fluxes to a side closer to the image side than the fifth lens group G5 can be suppressed. Thus, an advantage of securing the back focus is achieved. By not causing the corresponding value of Conditional Expression (28) to be greater than or equal to its upper limit, convergence of luminous fluxes to a side closer to the image side than the fifth lens group G5 can be suppressed. Thus, an advantage of reducing the total length of the optical system is achieved. In order to obtain more favorable characteristics, the optical system more preferably satisfies at least one of Conditional Expression (28-1), (28-2), or (28-3) below.

$$- 0.8 < f / f 5 < - 0.2 \qquad ( 28 )$$

$$- 0.7 < f / f 5 < - 0.3 \qquad ( 28 - 1 )$$

$$- 0.6 < f / f 5 < - 0.4 \qquad ( 28 - 2 )$$

$$- 0.5 \; 7 < f / f 5 < - 0 \text{.52} \qquad ( 28 - 3 )$$

The above preferable configurations and available configurations including the configurations related to the conditional expressions can be combined with each other in any manner and are preferably employed appropriately selectively in accordance with required specifications. The conditional expressions preferably satisfied by the optical system according to the present disclosure are not limited to the conditional expressions described in expression forms and include all conditional expressions obtained by combining lower limits and upper limits from preferable and more preferable conditional expressions with each other.

For example, one preferable aspect of the present disclosure is an optical system including a plurality of lens components in a case where one lens component is one single lens or one cemented lens, in which the aperture stop St that has a variable opening diameter and that determines an F-number of the optical system and at least one focusing group that moves during focusing are disposed in the optical system, and Conditional Expressions (1), (2), and (3) are satisfied.

In addition, for example, another preferable aspect of the present disclosure is an optical system having the configuration of the one aspect, in which Conditional Expressions (4), (5), and (6) are satisfied.

Next, examples of the optical system according to the present disclosure will be described with reference to the drawings. Reference numerals provided to lenses and lens groups in a cross-sectional view of each example are independently used for each example in order to avoid complication of description and the drawings caused by an increase in the number of digits of the reference numerals. Accordingly, even in a case where a common reference numeral is provided in the drawings of different examples, the common reference numeral does not necessarily indicate a common configuration.

### Example 1

A cross-sectional view of a configuration of the optical system of Example 1 is illustrated in FIG. 1, and its illustration method and its configuration are described above. Thus, duplicate descriptions will be partially omitted. The optical system of Example 1 consists of the first lens group G1 having a positive refractive power, the second lens group G2 having a positive refractive power, and the third lens group G3 having a positive refractive power in this order from the object side to the image side. The optical system of Example 1 includes only one focusing group. During focusing on the nearest object from the infinite distance object, the first lens group G1 and the third lens group G3 are fixed with respect to the image plane Sim, and the second lens group G2 moves to the object side.

For the optical system of Example 1, basic lens data is shown in Table 1, specifications and variable surface spacings are shown in Table 2, and aspherical coefficients are shown in Table 3.

The table of the basic lens data is described as follows. A column of “Sn” shows surface numbers in a case where the number is increased by one at a time toward the image side from the surface closest to the object side as a first surface. A column of “R” shows a curvature radius of each surface. A column of “D” shows a surface spacing on the optical axis between each surface and its adjacent surface on the image side. A column of “Nd” shows a refractive index of each constituent with respect to the d line. A column of “νd” shows an Abbe number of each constituent based on the d line. A column of “θgF” shows a partial dispersion ratio of each constituent between a g line and an F line. A column of “ED” shows an effective diameter of each surface.

In a case where refractive indexes of a lens with respect to the g line, the F line, and a C line are denoted by Ng, NF, and NC, respectively, and a partial dispersion ratio of the lens between the g line and the F line is denoted by θgF, θgF is defined as the following expression.

$$θ g F = ( N g - NF ) / ( NF - N C )$$

The terms “d line”, “C line”, “F line”, and “g line” described in the present specification mean bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

In the table of the basic lens data, a sign of the curvature radius of the surface having a convex shape toward the object side is positive, and a sign of the curvature radius of the surface having a convex shape toward the image side is negative. A field of the surface number of the surface corresponding to the aperture stop St has the surface number and a text (St). The optical member PP is also shown in the table of the basic lens data. A value in the lowermost field of the column of D in the table is a spacing between a surface closest to the image side in the table and the image plane Sim. A symbol DD[ ] is used for the variable surface spacings during focusing. A surface number on the object side of the spacing is provided inside [ ] and is described in the column of the surface spacings.

Table 2 shows the focal length, the open F-number, the maximum full angle of view, the lateral magnification, and the variable surface spacings based on the d line. In a field of the maximum full angle of view, [°] indicates a degree unit. In Table 2, each value in the state where the infinite distance object is focused on is shown in a column of “infinite distance”, and each value in the state where the nearest object is focused on is shown in a column of “nearest”.

In the basic lens data, surface numbers of aspherical surfaces are marked with *, and numerical values of paraxial curvature radiuses are described in fields of the curvature radiuses of the aspherical surfaces. In Table 3, the column of Sn shows the surface numbers of the aspherical surfaces, and columns of KA and Am show numerical values of the aspherical coefficients for each aspherical surface. In the present example, m of Am is an even number greater than or equal to 3 and less than or equal to 16 (m=3, 4, 5, . . . , 16). In the numerical values of the aspherical coefficients in Table 3, “E±n” (n: integer) means “×10⁺ⁿ”. KA and Am are aspherical coefficients in an aspheric equation represented by the following expression.

$$Zd = C \times {h}^{2} / \{ 1 + {( 1 - K A \times {C}^{2} \times {h}^{2} )}^{1 / 2} \} + Σ A m \times {h}^{m}$$

where
Zd: a depth of an aspherical surface (a length of a perpendicular line drawn from a point on the aspherical surface having a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
Σ in the aspheric equation means a total sum with respect to m.

In the data of each table, a degree unit is used for angles, and a millimeter (mm) unit is used for lengths. However, since the optical system can also be proportionally enlarged or proportionally reduced to be used, other appropriate units can also be used. In addition, numerical values rounded to predetermined digits are described in each table shown below.

TABLE 1
Example 1

| Sn | R | D | Nd | νd | θgF | ED |
|---|---|---|---|---|---|---|
| 1 | 55.1299 | 1.9982 | 1.56384 | 60.83 | 0.54082 | 48.7214 |
| 2 | 22.5106 | 2.6309 | | | | 38.8036 |
| *3 | 35.4986 | 2.4055 | 1.58313 | 59.46 | 0.54056 | 38.6980 |
| *4 | 27.2216 | 11.4977 | | | | 35.8365 |
| 5 | −78.9374 | 1.5127 | 1.58144 | 40.89 | 0.57680 | 35.5934 |
| 6 | 35.0055 | 6.4101 | 2.00330 | 28.27 | 0.59802 | 34.6040 |
| 7 | −1023.7751 | 5.6783 | | | | 34.0509 |
| 8 | −44.4874 | 5.3423 | 1.45860 | 90.19 | 0.53516 | 32.0108 |
| 9 | −22.8461 | 1.4212 | 1.89286 | 20.36 | 0.63944 | 31.6395 |
| 10 | −146.9457 | 0.1000 | | | | 33.5988 |
| 11 | −297.6264 | 3.9032 | 1.95375 | 32.32 | 0.59015 | 33.8447 |
| 12 | −48.6683 | 1.5000 | | | | 34.3540 |
| 13 | ∞ | 4.5663 | | | | 34.7985 |
| (St) | | | | | | |
| 14 | −117.8515 | 3.2503 | 1.98613 | 16.48 | 0.66558 | 36.2220 |
| 15 | −49.6281 | DD[15] | | | | 36.6597 |
| 16 | 36.6415 | 14.1737 | 1.49700 | 81.61 | 0.53887 | 36.9582 |
| 17 | −30.3990 | 1.5150 | 1.66446 | 35.87 | 0.58904 | 35.8435 |
| 18 | −174.8168 | 0.3438 | | | | 35.1425 |
| 19 | 48.1997 | 8.9159 | 1.49700 | 81.61 | 0.53887 | 35.2953 |
| 20 | −45.7521 | 1.4984 | | | | 35.0466 |
| *21 | −25.0970 | 2.2129 | 1.68948 | 31.02 | 0.59874 | 34.8729 |
| *22 | −68.7108 | 6.2195 | | | | 35.3930 |
| *23 | 715.7532 | 2.5634 | 1.80610 | 40.73 | 0.56940 | 31.8139 |
| *24 | 117.0199 | DD[24] | | | | 32.5271 |
| 25 | −166.4389 | 1.6779 | 1.47047 | 66.88 | 0.53235 | 38.8544 |
| 26 | −985.5424 | 0.1000 | | | | 40.4547 |
| 27 | 155.5487 | 2.5454 | 1.91082 | 35.25 | 0.58224 | 42.0837 |
| 28 | −180857.7324 | 19.3048 | | | | 42.4262 |
| 29 | ∞ | 3.2000 | 1.51680 | 64.20 | 0.53430 | 54.1326 |
| 30 | ∞ | 0.0000 | | | | 55.4165 |

TABLE 2
Example 1

| | Infinite Distance | Nearest |
|---|---|---|
| Focal Length | 34.05 | 34.36 |
| Open F-Number | 1.75 | 1.86 |
| Maximum Full Angle of View [°] | 79.0 | 75.2 |
| Lateral Magnification | 0 | −0.12 |
| DD[15] | 11.3211 | 6.5072 |
| DD[24] | 7.2044 | 12.0183 |

TABLE 3
Example 1

| Sn | 3 | 4 | 21 |
|---|---|---|---|
| KA | 2.254783014E+00 | 1.113221501E+00 | 9.713596077E−01 |
| A3 | 0.000000000E+00 | 0.000000000E+00 | 0.000000000E+00 |
| A4 | 2.422343570E−05 | 2.976826075E−05 | 7.347149495E−05 |
| A5 | 7.239143178E−07 | 9.658706248E−07 | 1.164813201E−06 |
| A6 | −1.562789388E−07 | −2.164035823E−07 | −1.072274479E−06 |
| A7 | 9.487082233E−09 | 1.439597558E−08 | 1.119102901E−07 |
| A8 | −2.078424875E−10 | 2.739133366E−10 | −7.726844007E−09 |
| A9 | −1.235212229E−11 | −1.182039845E−10 | 4.842753756E−10 |
| A10 | 3.161609559E−14 | 5.221189085E−12 | −1.842229269E−11 |
| A11 | 8.441016901E−14 | 1.515240433E−13 | −1.679533568E−13 |
| A12 | −1.339840426E−15 | −9.558058531E−15 | −5.259617735E−17 |
| A13 | −2.609222713E−16 | −5.635280228E−16 | 6.579379062E−15 |
| A14 | 1.105866877E−17 | 3.826154406E−17 | −5.457064499E−16 |
| A15 | −8.140185952E−20 | −5.578289027E−19 | 1.776176781E−17 |
| A16 | −1.212637050E−21 | −1.038753579E−22 | −2.143759874E−19 |
| Sn | 22 | 23 | 24 |
| KA | 2.894018525E+00 | 4.999992677E+00 | 5.000006568E+00 |
| A3 | 0.000000000E+00 | 0.000000000E+00 | 0.000000000E+00 |
| A4 | 3.588142326E−05 | −7.676342851E−05 | −3.915089547E−05 |
| A5 | −8.207295700E−08 | −3.145330103E−06 | −3.689106317E−06 |
| A6 | −5.297821294E−07 | 6.701347703E−07 | 8.479525330E−07 |
| A7 | 1.824102330E−08 | −5.526949288E−08 | −7.730138324E−08 |
| A8 | 2.257821329E−09 | 9.787493674E−10 | 3.537288100E−09 |
| A9 | −1.339259217E−10 | 2.791575899E−10 | 1.485880799E−10 |
| A10 | −6.330458982E−12 | −4.471108869E−12 | −8.220049943E−12 |
| A11 | 5.557030834E−13 | −8.188708282E−13 | −8.377376186E−13 |
| A12 | 1.763656826E−14 | −2.553424842E−14 | 1.205981958E−14 |
| A13 | −2.585663454E−15 | 7.022132285E−16 | 4.281177789E−15 |
| A14 | 7.088291718E−17 | 4.058440629E−16 | −2.017312401E−16 |
| A15 | 2.376182560E−20 | −2.358123968E−17 | 2.350997204E−18 |
| A16 | −1.797156184E−20 | 3.744022982E−19 | 9.475678965E−21 |

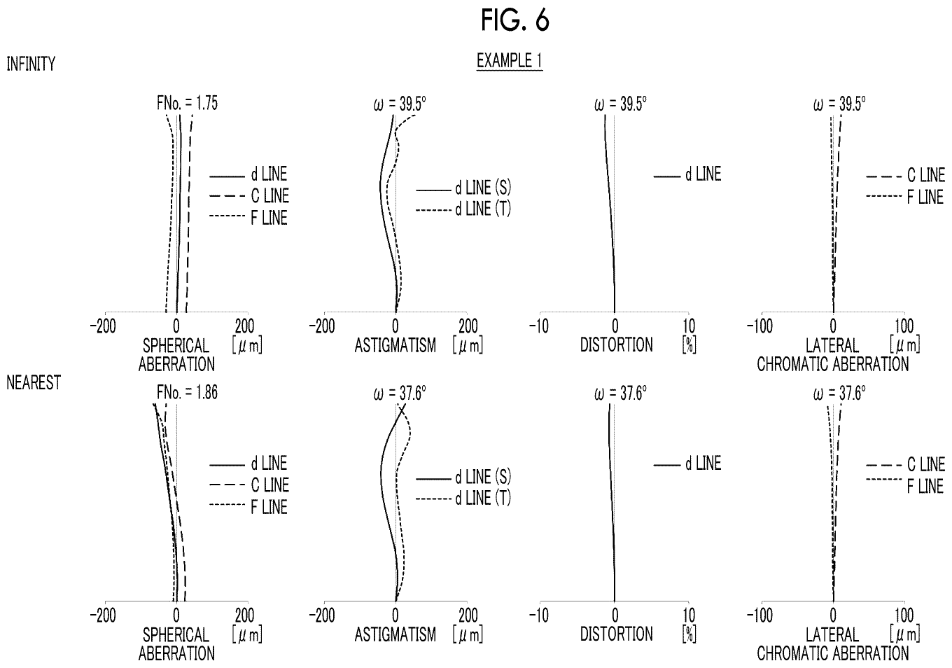

FIG. 6 illustrates each aberration diagram of the optical system of Example 1. In FIG. 6, each aberration diagram in the state where the infinite distance object is focused on is illustrated in an upper part labeled “infinite distance”, and each aberration diagram in the state where the nearest object is focused on is illustrated in a lower part labeled “nearest”. In FIG. 6, a spherical aberration, an astigmatism, a distortion, and a lateral chromatic aberration are illustrated in this order from the left. In the spherical aberration diagram, aberrations on the d line, the C line, and the F line are illustrated by a solid line, a long broken line, and a short broken line, respectively. In the astigmatism diagram, an aberration on the d line in a sagittal direction is illustrated by a solid line, and an aberration on the d line in a tangential direction is illustrated by a short broken line. In the distortion diagram, an aberration on the d line is illustrated by a solid line. In the lateral chromatic aberration diagram, aberrations on the C line and the F line are illustrated by a long broken line and a short broken line, respectively. In the spherical aberration diagram, a value of the open F-number in each state is shown after “FNo.=”. In other aberration diagrams, a value of the maximum half angle of view in each state is shown after “ω=”. In Example 1, a distance on the optical axis from the nearest object to the lens surface closest to the object side is 0.278 meters (m).

Symbols, meanings, description methods, and illustration methods of each data related to Example 1 are basically the same for the following examples unless otherwise specified. Thus, duplicate descriptions will be omitted below. In the cross-sectional views from Example 2, signs of the lens components will not be illustrated.

### Example 2

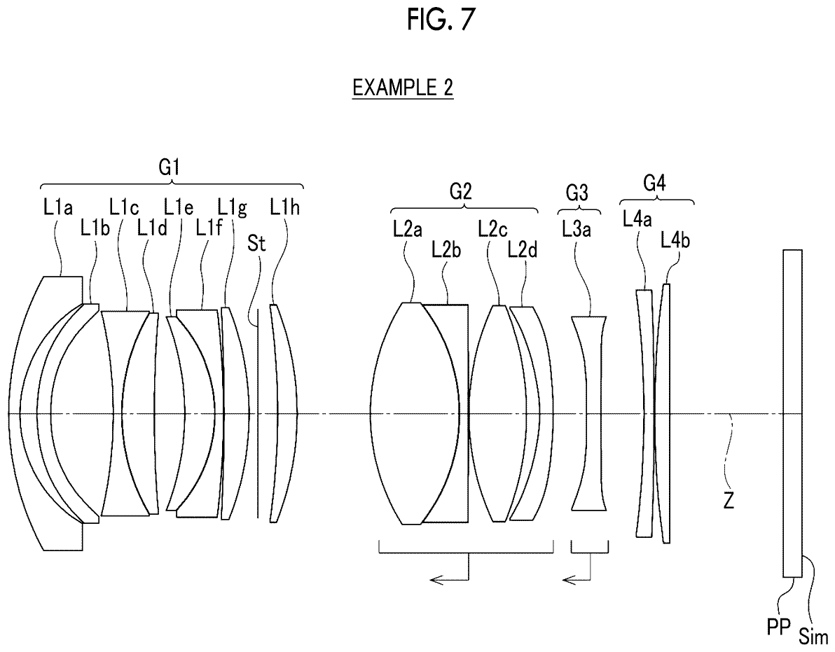

A cross-sectional view of a configuration of an optical system of Example 2 is illustrated in FIG. 7. The optical system of Example 2 consists of the first lens group G1 having a positive refractive power, the second lens group G2 having a positive refractive power, the third lens group G3 having a negative refractive power, and the fourth lens group G4 having a positive refractive power in this order from the object side to the image side. The optical system of Example 2 includes two focusing groups. During focusing on the nearest object from the infinite distance object, the first lens group G1 and the fourth lens group G4 are fixed with respect to the image plane Sim, and the second lens group G2 and the third lens group G3 move to the object side by changing spacings with their adjacent lens groups.

The first lens group G1 consists of the lenses L1a to L1g, the aperture stop St, and the lens L1h in this order from the object side to the image side. The second lens group G2 consists of four lenses of the lenses L2a to L2d in this order from the object side to the image side. The third lens group G3 consists of one lens of the lens L3a. The fourth lens group G4 consists of two lenses of lenses L4a and L4b in this order from the object side to the image side.

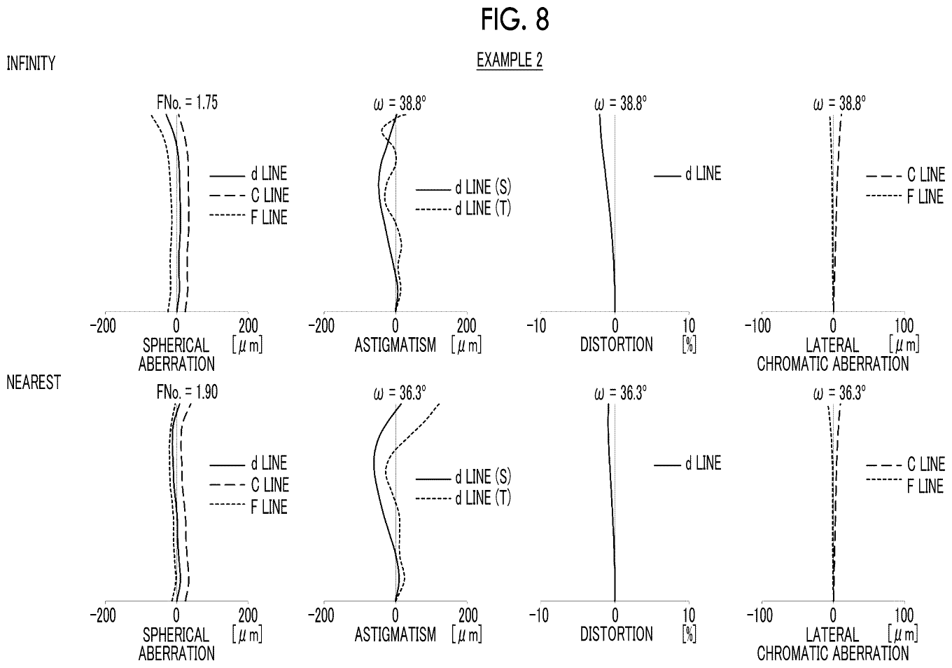

For the optical system of Example 2, basic lens data is shown in Table 4, specifications and variable surface spacings are shown in Table 5, aspherical coefficients are shown in Table 6, and each aberration diagram is illustrated in FIG. 8. The distance on the optical axis from the nearest object to the lens surface closest to the object side is 0.230 meters (m).

TABLE 4
Example 2

| Sn | R | D | Nd | νd | θgF | ED |
|---|---|---|---|---|---|---|
| 1 | 48.1515 | 1.9130 | 1.58313 | 59.37 | 0.54345 | 46.3647 |
| 2 | 21.6372 | 2.9182 | | | | 37.3041 |
| *3 | 31.3933 | 2.3127 | 1.58313 | 59.46 | 0.54056 | 37.1920 |
| *4 | 25.7782 | 10.6604 | | | | 34.8275 |
| 5 | −74.8895 | 1.4691 | 1.47047 | 66.88 | 0.53235 | 34.6573 |
| 6 | 33.2421 | 5.5186 | 1.95375 | 32.32 | 0.59056 | 33.9578 |
| 7 | 204.8936 | 5.1902 | | | | 33.4335 |
| 8 | −44.2178 | 5.1215 | 1.43700 | 95.10 | 0.53364 | 32.7277 |
| 9 | −23.6701 | 1.4780 | 1.89286 | 20.36 | 0.63944 | 32.5726 |
| 10 | −143.1875 | 0.1000 | | | | 35.1216 |
| 11 | −345.0625 | 4.2639 | 1.88300 | 40.80 | 0.56557 | 35.4711 |
| 12 | −48.4468 | 1.5000 | | | | 35.8565 |
| 13 | ∞ | 3.3572 | | | | 35.2599 |
| (St) | | | | | | |
| 14 | −127.0545 | 3.3236 | 1.98613 | 16.48 | 0.66558 | 36.2893 |
| 15 | −49.8585 | DD[15] | | | | 36.7325 |
| 16 | 35.3197 | 15.0615 | 1.49700 | 81.61 | 0.53887 | 37.5411 |
| 17 | −29.8912 | 1.5217 | 1.62604 | 39.07 | 0.58113 | 36.8254 |
| 18 | −2668.7497 | 0.1000 | | | | 36.6096 |
| 19 | 43.2375 | 9.8023 | 1.49700 | 81.61 | 0.53887 | 36.5634 |
| 20 | −47.8610 | 2.2488 | | | | 36.1211 |
| *21 | −25.5412 | 2.2715 | 1.68948 | 31.02 | 0.59874 | 35.5962 |
| *22 | −64.7625 | DD[22] | | | | 36.1721 |
| *23 | 3591.8472 | 2.4284 | 1.80610 | 40.73 | 0.56940 | 32.2285 |
| *24 | 174.9088 | DD[24] | | | | 32.7627 |
| 25 | −160.9911 | 1.7285 | 1.72047 | 34.71 | 0.58350 | 40.4454 |
| 26 | −536.3648 | 0.1000 | | | | 41.7875 |
| 27 | 160.4084 | 2.5959 | 1.95375 | 32.32 | 0.59056 | 43.5316 |
| 28 | −162372.5260 | 19.2995 | | | | 43.8317 |
| 29 | ∞ | 3.2000 | 1.51680 | 64.20 | 0.53430 | 54.2857 |
| 30 | ∞ | 0.0000 | | | | 55.4199 |

TABLE 5
Example 2

| | Infinite Distance | Nearest |
|---|---|---|
| Focal Length | 35.17 | 35.62 |
| Open F-Number | 1.75 | 1.90 |
| Maximum Full Angle of View [°] | 77.6 | 72.6 |
| Lateral Magnification | 0 | −0.15 |
| DD[15] | 12.4794 | 6.5026 |
| DD[22] | 5.6968 | 5.6495 |
| DD[24] | 7.3518 | 13.3758 |

TABLE 6
Example 2

| Sn | 3 | 4 | 21 |
|---|---|---|---|
| KA | 1.422751630E+00 | 9.338450398E−01 | 9.698582962E−01 |
| A3 | 0.000000000E+00 | 0.000000000E+00 | 0.000000000E+00 |
| A4 | 1.972141194E−05 | 2.210489590E−05 | 5.740938536E−05 |
| A5 | 1.100886723E−07 | 9.565941637E−07 | 5.364330482E−06 |
| A6 | −5.204158043E−08 | −2.355405605E−07 | −2.375466317E−06 |
| A7 | 4.189328945E−09 | 2.290010703E−08 | 3.713607745E−07 |
| A8 | −1.175286121E−11 | −5.324353852E−10 | −3.192769352E−08 |
| A9 | −4.231024768E−11 | −8.203835472E−11 | 2.469811971E−10 |
| A10 | 3.598933429E−12 | 3.472839384E−12 | 2.823013255E−10 |
| A11 | −9.558916047E−14 | 2.816482854E−13 | −3.227317430E−11 |
| A12 | −9.425296584E−17 | −1.238329915E−14 | 1.553925155E−12 |
| A13 | 2.901388960E−17 | −8.422705390E−16 | −1.750369222E−14 |
| A14 | −3.939382308E−18 | 5.406158681E−17 | −1.539512297E−15 |
| A15 | 2.420554684E−19 | −7.935446929E−19 | 6.792589915E−17 |
| A16 | −3.922914440E−21 | 2.326584562E−22 | −8.720750181E−19 |
| Sn | 22 | 23 | 24 |
| KA | −4.850723833E+00 | 4.999992677E+00 | −4.999999997E+00 |
| A3 | 0.000000000E+00 | 0.000000000E+00 | 0.000000000E+00 |
| A4 | 2.438214491E−05 | −6.339405401E−05 | −2.566126067E−05 |
| A5 | 8.510258020E−07 | −2.229983891E−06 | −3.690667884E−06 |
| A6 | −6.393957703E−07 | 3.996631646E−07 | 8.484622246E−07 |
| A7 | 5.456396759E−08 | −4.499535237E−09 | −8.195931276E−08 |
| A8 | −4.579036511E−09 | −5.760567869E−09 | 3.473859099E−09 |
| A9 | 5.489832066E−10 | 6.736408997E−10 | 1.403993616E−10 |
| A10 | −4.700005725E−11 | 3.047594223E−12 | −4.678820147E−12 |
| A11 | 2.319010220E−12 | −3.479448651E−12 | −7.023606362E−13 |
| A12 | −6.991113876E−14 | 1.121788039E−13 | −3.219302906E−14 |
| A13 | 2.543920531E−15 | 3.029045985E−15 | 6.531251187E−15 |
| A14 | −1.483693121E−16 | −1.365838080E−16 | −2.207376392E−16 |
| A15 | 5.256923949E−18 | −1.678693758E−18 | 1.021990480E−18 |
| A16 | −7.045480012E−20 | 7.312889169E−20 | 3.673493449E−20 |

### Example 3

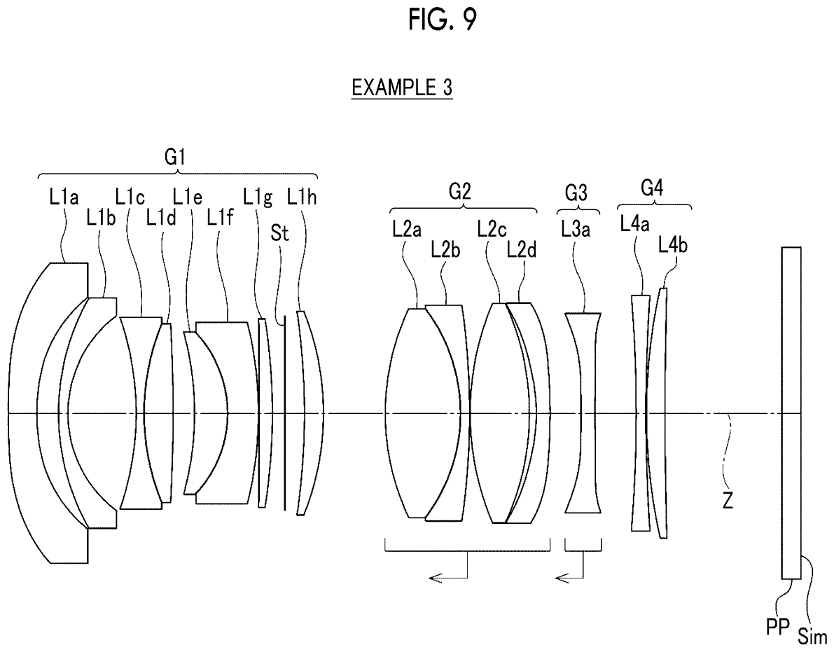

A cross-sectional view of a configuration of an optical system of Example 3 is illustrated in FIG. 9. The optical system of Example 3 consists of the first lens group G1 having a positive refractive power, the second lens group G2 having a positive refractive power, the third lens group G3 having a negative refractive power, and the fourth lens group G4 having a positive refractive power in this order from the object side to the image side. The optical system of Example 3 includes two focusing groups. During focusing on the nearest object from the infinite distance object, the first lens group G1 and the fourth lens group G4 are fixed with respect to the image plane Sim, and the second lens group G2 and the third lens group G3 move to the object side by changing spacings with their adjacent lens groups.

The first lens group G1 consists of the lenses L1a to L1g, the aperture stop St, and the lens L1h in this order from the object side to the image side. The second lens group G2 consists of four lenses of the lenses L2a to L2d in this order from the object side to the image side. The third lens group G3 consists of one lens of the lens L3a. The fourth lens group G4 consists of two lenses of the lenses L4a and L4b in this order from the object side to the image side.

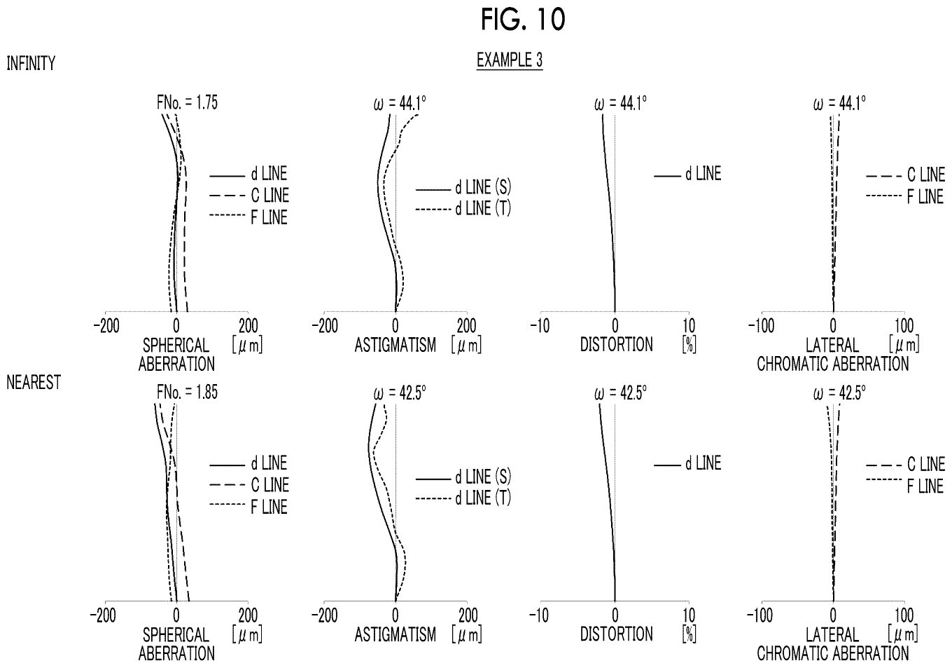

For the optical system of Example 3, basic lens data is shown in Table 7, specifications and variable surface spacings are shown in Table 8, aspherical coefficients are shown in Table 9, and each aberration diagram is illustrated in FIG. 10. The distance on the optical axis from the nearest object to the lens surface closest to the object side is 0.231 meters (m).

TABLE 7
Example 3

| Sn | R | D | Nd | νd | θgF | ED |
|---|---|---|---|---|---|---|
| *1 | 199.6042 | 4.7955 | 1.51680 | 64.20 | 0.53430 | 50.1420 |
| *2 | 37.4126 | 3.6216 | | | | 38.7259 |
| 3 | 38.7445 | 1.5843 | 1.43700 | 95.10 | 0.53364 | 38.4436 |
| 4 | 20.3062 | 11.4584 | | | | 32.5021 |
| 5 | −48.1477 | 1.3364 | 1.43700 | 95.10 | 0.53364 | 31.9954 |
| 6 | 38.9244 | 4.8458 | 1.91082 | 35.25 | 0.58224 | 29.8454 |
| 7 | −290.2700 | 3.6301 | | | | 29.1973 |
| 8 | −50.4223 | 5.5527 | 1.48749 | 70.44 | 0.53062 | 27.0584 |
| 9 | −19.4689 | 5.1588 | 2.00171 | 20.66 | 0.63472 | 26.7554 |
| 10 | −62.5235 | 0.1000 | | | | 30.2572 |
| 11 | −2176.9573 | 2.2532 | 1.84850 | 43.79 | 0.56197 | 31.1778 |
| 12 | −99.6191 | 2.1041 | | | | 31.4824 |
| 13 | ∞ | 3.2787 | | | | 32.4261 |
| (St) | | | | | | |
| 14 | −1.151484 | 3.1911 | 1.98613 | 16.48 | 0.66558 | 33.4910 |
| 15 | −45.4102 | DD[15] | | | | 33.9488 |
| 16 | 40.4491 | 12.5382 | 1.52841 | 76.45 | 0.53954 | 34.7448 |
| 17 | −28.6298 | 1.5155 | 1.67270 | 32.17 | 0.59633 | 34.8099 |
| 18 | −124.8539 | 0.1000 | | | | 35.9699 |
| 19 | 46.4747 | 9.9552 | 1.49700 | 81.61 | 0.53887 | 36.6158 |
| 20 | −43.2925 | 1.1764 | | | | 36.1703 |
| *21 | −25.9369 | 2.2956 | 1.68948 | 31.02 | 0.59874 | 36.1149 |
| *22 | −80.9396 | DD[22] | | | | 36.7213 |
| *23 | 847.1167 | 2.3404 | 1.80610 | 40.73 | 0.56940 | 32.9083 |
| *24 | 191.6970 | DD[24] | | | | 33.2708 |
| 25 | −232.1901 | 1.6245 | 1.78880 | 28.43 | 0.60092 | 37.7524 |
| 26 | 283.8343 | 0.1000 | | | | 39.3467 |
| 27 | 95.7171 | 3.0983 | 1.95375 | 32.32 | 0.59056 | 41.3401 |
| 28 | 634.0480 | 19.6470 | | | | 41.6743 |
| 29 | ∞ | 3.2000 | 1.51680 | 64.20 | 0.53430 | 54.0707 |
| 30 | ∞ | 0.0000 | | | | 55.4220 |

TABLE 8
Example 3

| | Infinite Distance | Nearest |
|---|---|---|
| Focal Length | 29.04 | 29.27 |
| Open F-Number | 1.75 | 1.85 |
| Maximum Full Angle of View [°] | 88.2 | 85.0 |
| Lateral Magnification | 0 | −0.12 |
| DD[15] | 10.3889 | 6.4999 |
| DD[22] | 5.1766 | 5.1423 |
| DD[24] | 6.9486 | 10.8719 |

TABLE 9
Example 3

| Sn | 1 | 2 | 21 | 22 |
|---|---|---|---|---|
| KA | −5.000000663E+00 | 5.758693444E−01 | 9.587946437E−01 | 4.667593368E+00 |
| A3 | 0.000000000E+00 | 0.000000000E+00 | 0.000000000E+00 | 0.000000000E+00 |
| A4 | 2.420904414E−05 | 2.788093454E−05 | 7.651856498E−05 | 4.128142545E−05 |
| A5 | 1.300452567E−06 | 2.415806893E−06 | 4.359688570E−08 | 5.256424902E−07 |
| A6 | −8.281636113E−08 | −2.155201590E−07 | −8.267586865E−07 | −8.664920479E−07 |
| A7 | −2.141297346E−08 | −1.197221749E−08 | 5.719533316E−08 | 6.485695736E−08 |
| A8 | 2.552177672E−09 | 1.167474936E−09 | −1.506725355E−10 | −1.266337496E−09 |
| A9 | −9.396861628E−11 | 6.816021787E−11 | −6.170769798E−11 | 7.274878894E−12 |
| A10 | −7.481386341E−13 | −7.901308410E−12 | −7.212275652E−12 | −6.349141979E−12 |
| A11 | 1.496579266E−13 | 1.307944619E−13 | 7.438705843E−13 | 9.143500510E−14 |
| A12 | −2.190751889E−15 | 3.723101770E−15 | −2.830188421E−14 | 4.512298054E−14 |
| A13 | −1.704809644E−16 | −8.946042036E−17 | 1.780382770E−15 | −2.104069285E−15 |
| A14 | 9.562657363E−18 | 1.202640653E−17 | −1.328953022E−16 | −4.828731637E−17 |
| A15 | −2.126949718E−19 | −8.150247620E−19 | 4.727315547E−18 | 4.807245023E−18 |
| A16 | 1.899113510E−21 | 1.379362811E−20 | −6.098176611E−20 | −8.147992891E−20 |

| Sn | 23 | 24 |
|---|---|---|
| KA | 4.999992677E+00 | −5.000000004E+00 |
| A3 | 0.000000000E+00 | 0.000000000E+00 |
| A4 | −4.821441741E−05 | −1.214428375E−05 |
| A5 | −4.212708345E−06 | −3.056333847E−06 |
| A6 | 4.723206464E−07 | −3.620424861E−07 |
| A7 | −9.231338832E−09 | 2.202844702E−07 |
| A8 | −4.899182457E−09 | −3.118639761E−08 |
| A9 | 6.629596870E−10 | 1.078162900E−09 |
| A10 | −1.751929725E−11 | 2.252527365E−10 |
| A11 | −4.204478574E−13 | −2.909287450E−11 |
| A12 | −6.644018656E−14 | 1.091017270E−12 |
| A13 | 5.970998325E−15 | 2.748169832E−14 |
| A14 | 1.762904028E−17 | −3.811220298E−15 |
| A15 | −9.673884595E−18 | 1.276120591E−16 |
| A16 | 1.839882816E−19 | −1.533795700E−18 |

### Example 4

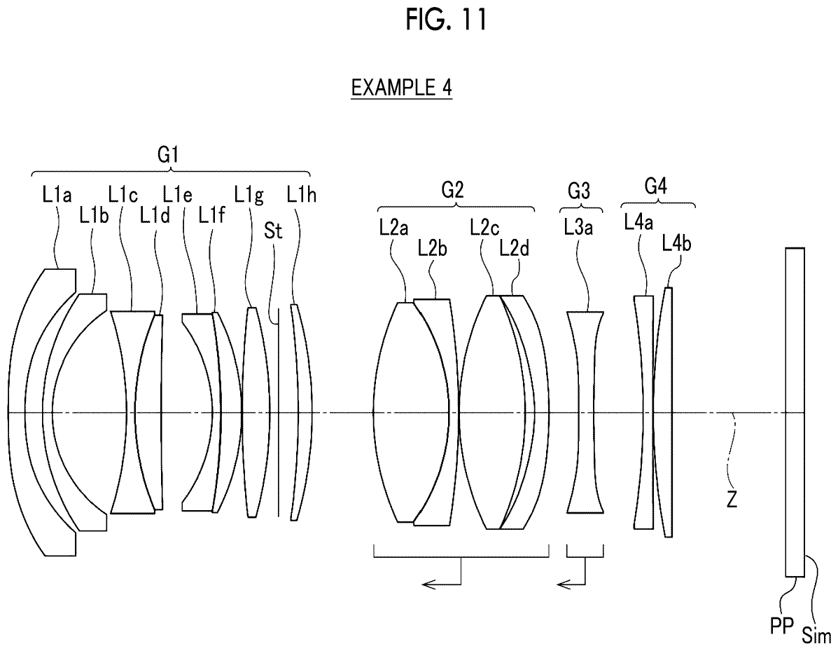

A cross-sectional view of a configuration of an optical system of Example 4 is illustrated in FIG. 11. The optical system of Example 4 consists of the first lens group G1 having a positive refractive power, the second lens group G2 having a positive refractive power, the third lens group G3 having a negative refractive power, and the fourth lens group G4 having a positive refractive power in this order from the object side to the image side. The optical system of Example 4 includes two focusing groups. During focusing on the nearest object from the infinite distance object, the first lens group G1 and the fourth lens group G4 are fixed with respect to the image plane Sim, and the second lens group G2 and the third lens group G3 move to the object side by changing spacings with their adjacent lens groups.

The first lens group G1 consists of the lenses L1a to L1g, the aperture stop St, and the lens L1h in this order from the object side to the image side. The second lens group G2 consists of four lenses of the lenses L2a to L2d in this order from the object side to the image side. The third lens group G3 consists of one lens of the lens L3a. The fourth lens group G4 consists of two lenses of the lenses L4a and L4b in this order from the object side to the image side.

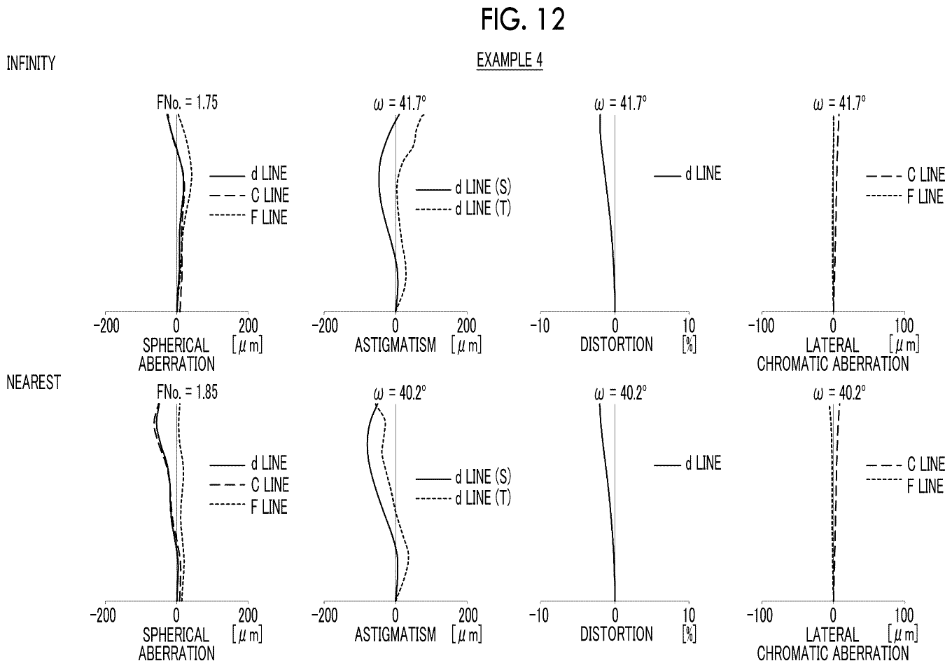

For the optical system of Example 4, basic lens data is shown in Table 10, specifications and variable surface spacings are shown in Table 11, aspherical coefficients are shown in Table 12, and each aberration diagram is illustrated in FIG. 12. The distance on the optical axis from the nearest object to the lens surface closest to the object side is 0.254 meters

TABLE 10
Example 4

| Sn | R | D | Nd | νd | θgF | ED |
|---|---|---|---|---|---|---|
| *1 | 200.2796 | 2.8310 | 1.58313 | 59.38 | 0.54237 | 48.3134 |
| *2 | 43.7426 | 2.9751 | | | | 40.6154 |
| 3 | 34.9395 | 1.6439 | 1.43700 | 95.10 | 0.53364 | 39.9286 |
| 4 | 20.6414 | 12.6119 | | | | 34.4342 |
| 5 | −54.8228 | 1.4473 | 1.48749 | 70.44 | 0.53062 | 34.0184 |
| 6 | 42.1143 | 4.4354 | 1.95375 | 32.32 | 0.59015 | 32.7162 |
| 7 | 554.9950 | 8.6809 | | | | 32.2839 |
| 8 | −25.0861 | 1.3972 | 1.85478 | 24.80 | 0.61232 | 30.3860 |
| 9 | −98.8889 | 0.1000 | | | | 33.1598 |
| 10 | −92.6642 | 3.4711 | 1.77535 | 50.31 | 0.55042 | 33.1631 |
| 11 | −36.5044 | 0.1000 | | | | 33.6692 |
| 12 | 161.9095 | 4.6852 | 1.55032 | 75.50 | 0.54001 | 35.1653 |
| 13 | −66.9348 | 1.5000 | | | | 35.3140 |
| 14 | ∞ | 3.3178 | | | | 34.9007 |
| (St) | | | | | | |
| 15 | −128.9278 | 2.3588 | 1.98613 | 16.48 | 0.66558 | 35.6169 |
| 16 | −65.0987 | DD[16] | | | | 35.9485 |
| 17 | 43.4019 | 12.7605 | 1.49700 | 81.61 | 0.53887 | 36.9248 |
| 18 | −31.4349 | 1.6009 | 1.73800 | 32.33 | 0.59005 | 36.6678 |
| 19 | −118.4135 | 0.1000 | | | | 38.1464 |
| 20 | 44.1757 | 11.2062 | 1.49700 | 81.61 | 0.53887 | 39.3507 |
| 21 | −46.6932 | 1.5915 | | | | 38.8781 |
| *22 | −27.7546 | 2.4465 | 1.68948 | 31.02 | 0.59874 | 38.8127 |
| *23 | −62.4292 | DD[23] | | | | 39.3406 |
| *24 | 7911.7542 | 2.5590 | 1.80610 | 40.73 | 0.56940 | 33.8456 |
| *25 | 201.7648 | DD[25] | | | | 33.4873 |
| 26 | −116.5012 | 1.6328 | 1.89286 | 20.36 | 0.63944 | 37.5813 |
| 27 | 2360.9360 | 0.1000 | | | | 39.3037 |
| 28 | 111.0742 | 3.1518 | 1.95906 | 17.47 | 0.65993 | 41.6223 |
| 29 | −156312.3257 | 19.2897 | | | | 41.9887 |
| 30 | ∞ | 3.2000 | 1.51680 | 64.20 | 0.53430 | 54.1031 |
| 31 | ∞ | 0.0000 | | | | 55.4412 |

TABLE 11
Example 4

| | Infinite Distance | Nearest |
|---|---|---|
| Focal Length | 31.75 | 31.75 |
| Open F-Number | 1.75 | 1.85 |
| Maximum Full Angle of View [°] | 83.4 | 80.4 |
| Lateral Magnification | 0 | −0.12 |
| DD[16] | 10.3847 | 6.5029 |
| DD[23] | 5.0400 | 4.9872 |
| DD[25] | 8.3823 | 12.3169 |

TABLE 12
Example 4

| Sn | 1 | 2 | 22 | 23 |
|---|---|---|---|---|
| KA | −1.839114589E+00 | 1.003713703E+00 | 9.942172052E−01 | 3.800459767E+00 |
| A3 | 0.000000000E+00 | 0.000000000E+00 | 0.000000000E+00 | 0.000000000E+00 |
| A4 | 2.901818148E−05 | 3.212824397E−05 | 5.494138531E−05 | 2.576049499E−05 |
| A5 | 3.519085365E−06 | 3.713382132E−06 | 1.238164332E−07 | −7.169917343E−07 |
| A6 | −5.259348851E−07 | −4.347439803E−07 | −4.536286895E−07 | −2.557800177E−07 |
| A7 | 1.201144272E−08 | −9.082434705E−09 | 1.766828652E−08 | 6.195121246E−09 |
| A8 | 1.173907080E−09 | 2.392713522E−09 | 1.706870066E−09 | 1.162084909E−09 |
| A9 | −4.373865021E−11 | −4.989429937E−12 | −1.517142519E−10 | −5.642095250E−11 |
| A10 | −3.016991993E−12 | −8.658716037E−12 | −1.268989272E−13 | −1.582656397E−12 |
| A11 | 1.829448070E−13 | 2.872655959E−13 | 4.313399896E−13 | 1.682706830E−13 |
| A12 | 2.581275300E−16 | −4.021209552E−15 | −1.819505832E−14 | −2.318434808E−15 |
| A13 | −1.757116515E−16 | 7.233821199E−16 | 5.223343705E−16 | −2.476340934E−17 |
| A14 | 1.275578965E−18 | −3.760725522E−17 | −3.276995603E−17 | −8.655046829E−18 |
| A15 | 9.343776465E−20 | 3.301495327E−19 | 1.380347245E−18 | 5.540328740E−19 |
| A16 | −1.463351541E−21 | 7.631148863E−21 | −2.030435485E−20 | −9.129794978E−21 |

| Sn | 24 | 25 |
|---|---|---|
| KA | 4.999996307E+00 | −5.000000000E+00 |
| A3 | 0.000000000E+00 | 0.000000000E+00 |
| A4 | −4.631375509E−05 | −1.311251014E−05 |
| A5 | −1.049325058E−06 | 8.673844536E−07 |
| A6 | 3.785555931E−07 | −5.600482268E−07 |
| A7 | −7.110380339E−08 | 1.739643376E−07 |
| A8 | 5.735136243E−09 | −2.854580891E−08 |
| A9 | 6.900215170E−11 | 2.503410090E−09 |
| A10 | −2.280487747E−11 | −3.937711122E−11 |
| A11 | 6.303811097E−13 | −1.209539607E−11 |
| A12 | −2.780961299E−16 | 1.128014970E−12 |
| A13 | −1.984089381E−15 | −4.437803988E−14 |
| A14 | 2.819815671E−16 | 7.673082894E−16 |
| A15 | −1.327791581E−17 | −8.871977665E−19 |
| A16 | 2.036467489E−19 | −1.049473712E−19 |

### Example 5

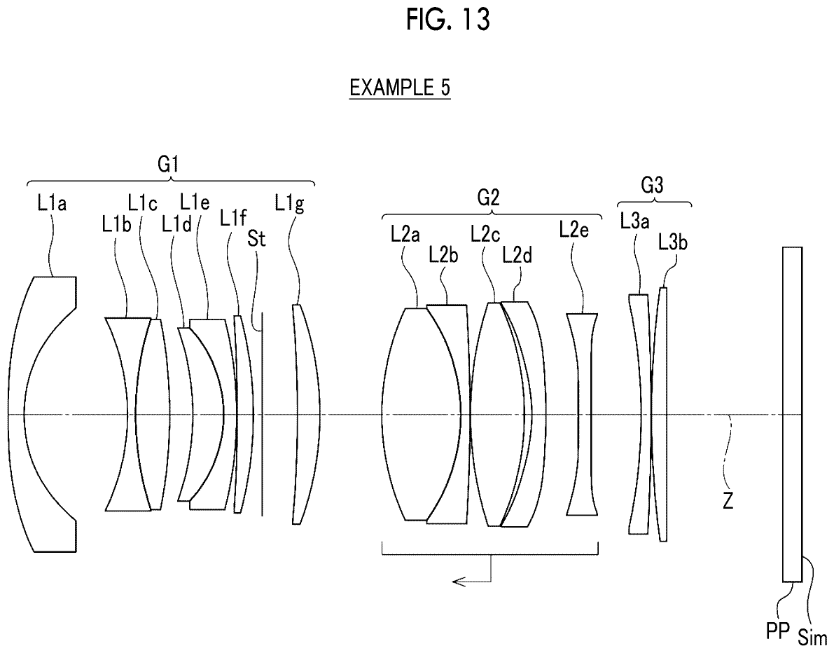

A cross-sectional view of a configuration of an optical system of Example 5 is illustrated in FIG. 13. The optical system of Example 5 consists of the first lens group G1 having a positive refractive power, the second lens group G2 having a positive refractive object side to the image side. The optical system of Example 5 includes only one focusing group. During focusing on the nearest object from the infinite distance object, the first lens group G1 and the third lens group G3 are fixed with respect to the image plane Sim, and the second lens group G2 moves to the object side.

The first lens group G1 consists of the lenses L1a to L1f, the aperture stop St, and the lens L1g in this order from the object side to the image side. The second lens group G2 consists of five lenses of the lenses L2a to L2e in this order from the object side to the image side. The third lens group G3 consists of two lenses of the lenses L3a and L3b in this order from the object side to the image side.

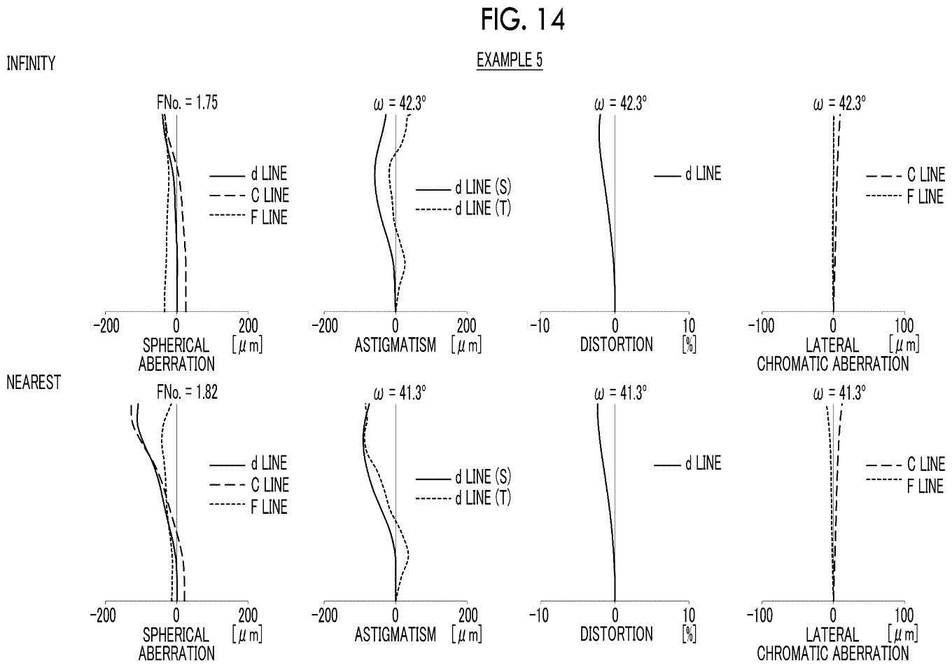

For the optical system of Example 5, basic lens data is shown in Table 13, specifications and variable surface spacings are shown in Table 14, aspherical coefficients are shown in Table 15, and each aberration diagram is illustrated in FIG. 14. The distance on the optical axis from the nearest object to the lens surface closest to the object side is 0.248 meters

TABLE 13
Example 5

| Sn | R | D | Nd | νd | θgF | ED |
|---|---|---|---|---|---|---|
| *1 | 199.7440 | 2.6715 | 1.58313 | 59.38 | 0.54237 | 45.5215 |
| *2 | 25.6920 | 17.1893 | | | | 35.1808 |
| 3 | −35.9562 | 1.3496 | 1.48749 | 70.44 | 0.53062 | 31.8996 |
| 4 | 50.0953 | 5.6730 | 1.95375 | 32.32 | 0.59015 | 31.4029 |
| 5 | −81.1328 | 3.8526 | | | | 31.0648 |
| 6 | −41.8009 | 5.1285 | 1.43700 | 95.10 | 0.53364 | 28.6000 |
| 7 | −20.9487 | 2.1661 | 2.00272 | 19.32 | 0.64514 | 28.5927 |
| 8 | −63.5894 | 0.1000 | | | | 31.4617 |
| 9 | −239.3637 | 2.6830 | 1.91082 | 35.25 | 0.58325 | 32.2068 |
| 10 | −62.7629 | 1.5000 | | | | 32.6076 |
| 11 | ∞ | 5.8301 | | | | 33.5692 |
| (St) | | | | | | |
| 12 | −199.9740 | 3.7477 | 1.98613 | 16.48 | 0.66558 | 35.8546 |
| 13 | −51.3443 | DD[13] | | | | 36.2517 |
| 14 | 41.2353 | 13.0355 | 1.55032 | 75.50 | 0.54001 | 35.0000 |
| 15 | −29.8733 | 1.5261 | 1.77047 | 29.74 | 0.59514 | 34.9775 |
| 16 | −286.8105 | 0.1000 | | | | 36.1238 |
| 17 | 59.5060 | 8.9652 | 1.59282 | 68.62 | 0.54414 | 36.8815 |
| 18 | −44.0276 | 1.2417 | | | | 36.7466 |
| *19 | −26.1286 | 2.3326 | 1.68948 | 31.02 | 0.59874 | 36.6182 |
| *20 | −86.3317 | 5.4345 | | | | 37.1502 |
| *21 | 1103.2548 | 2.0976 | 1.80610 | 40.73 | 0.56940 | 33.2650 |
| *22 | 474.1987 | DD[22] | | | | 33.2012 |
| 23 | −87.7427 | 1.6431 | 1.72825 | 28.32 | 0.60755 | 37.7359 |
| 24 | −356.3053 | 0.1000 | | | | 39.5892 |
| 25 | 156.3065 | 2.5097 | 2.00069 | 25.46 | 0.61364 | 41.6238 |
| 26 | −41917.7070 | 19.3002 | | | | 41.9619 |
| 27 | ∞ | 3.2000 | 1.51680 | 64.20 | 0.53430 | 54.1012 |
| 28 | ∞ | 0.0000 | | | | 55.4208 |

TABLE 14
Example 5

| | Infinite Distance | Nearest |
|---|---|---|
| Focal Length | 31.05 | 30.76 |
| Open F-Number | 1.75 | 1.82 |
| Maximum Full Angle of View [°] | 84.6 | 82.6 |
| Lateral Magnification | 0 | −0.12 |
| DD[13] | 10.3064 | 6.5064 |
| DD[22] | 8.3298 | 12.1298 |

TABLE 15
Example 5

| Sn | 1 | 2 | 19 | 20 |
|---|---|---|---|---|
| KA | −4.573956530E+00 | 8.434152639E−01 | 9.573482671E−01 | 1.542006909E+00 |
| A3 | 0.000000000E+00 | 0.000000000E+00 | 0.000000000E+00 | 0.000000000E+00 |
| A4 | 5.795632257E−05 | 6.173134340E−05 | 6.998829808E−05 | 3.726715960E−05 |
| A5 | −2.445701567E−06 | −1.707841169E−06 | −8.879011103E−08 | 9.688091645E−08 |
| A6 | −2.349876215E−07 | −3.498689208E−07 | −5.827962526E−07 | −6.773143377E−07 |
| A7 | 2.223364462E−08 | 2.113978169E−08 | 3.208902900E−09 | 3.889386886E−08 |
| A8 | −2.002116822E−10 | 9.640710731E−10 | 6.992305289E−09 | 1.075466495E−09 |
| A9 | −2.375527268E−11 | −1.938059780E−11 | −5.929764111E−10 | −1.303465362E−10 |
| A10 | −1.320669892E−12 | −1.918590260E−11 | 7.852695397E−12 | −2.226533950E−12 |
| A11 | 1.533007063E−13 | 2.227360454E−12 | 1.367290491E−12 | 3.176919244E−13 |
| A12 | −1.316324634E−15 | −1.400537662E−13 | −7.790552691E−14 | 7.147012394E−15 |
| A13 | −2.241634112E−16 | 6.375939860E−15 | 1.198533952E−15 | −3.185647117E−16 |
| A14 | 7.792064028E−18 | −1.993693941E−16 | 1.572891988E−17 | −6.275711149E−17 |
| A15 | −6.813080447E−20 | 3.309787778E−18 | −4.641257274E−19 | 3.640389628E−18 |
| A16 | −2.470312716E−22 | −1.763975120E−20 | −2.919103376E−22 | −5.632899782E−20 |

| Sn | 21 | 22 |
|---|---|---|
| KA | 4.999992677E+00 | −4.999999552E+00 |
| A3 | 0.000000000E+00 | 0.000000000E+00 |
| A4 | −3.052315538E−05 | 2.951645574E−06 |
| A5 | −4.632578094E−06 | −5.146942914E−06 |
| A6 | 9.892833215E−07 | 9.647281015E−07 |
| A7 | −1.639534965E−07 | −1.150934505E−07 |
| A8 | 1.692769539E−08 | 7.929480391E−09 |
| A9 | −1.099908602E−09 | −3.734267541E−10 |
| A10 | 4.655411279E−11 | 4.415171645E−11 |
| A11 | 1.934264161E−12 | −3.015933934E−12 |
| A12 | −4.576790034E−13 | −4.721116991E−14 |
| A13 | 2.283181383E−14 | 1.312241994E−14 |
| A14 | −1.379505355E−16 | −5.011520469E−16 |
| A15 | −1.813244731E−17 | 5.899623827E−18 |
| A16 | 3.726524497E−19 | 6.274584681E−21 |

### Example 6

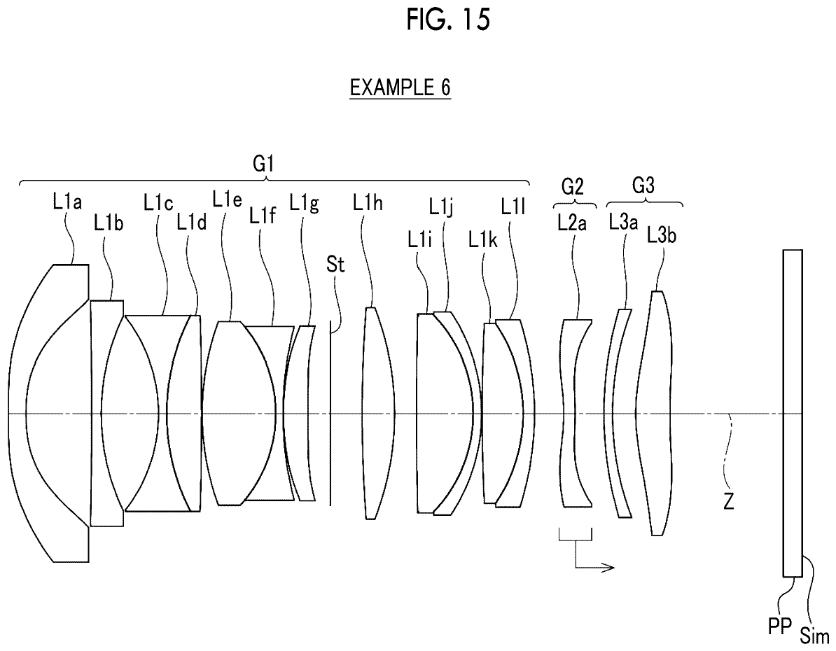

A cross-sectional view of a configuration of an optical system of Example 6 is illustrated in FIG. 15. The optical system of Example 6 consists of the first lens group G1 having a positive refractive power, the second lens group G2 having a negative refractive object side to the image side. The optical system of Example 6 includes only one focusing group. During focusing on the nearest object from the infinite distance object, the first lens group G1 and the third lens group G3 are fixed with respect to the image plane Sim, and the second lens group G2 moves to the image side.

The first lens group G1 consists of the lenses L1a to L1g, the aperture stop St, and lenses L1h to L1l in this order from the object side to the image side. The second lens group G2 consists of one lens of the lens L2a. The third lens group G3 consists of two lenses of the lenses L3a and L3b in this order from the object side to the image side.

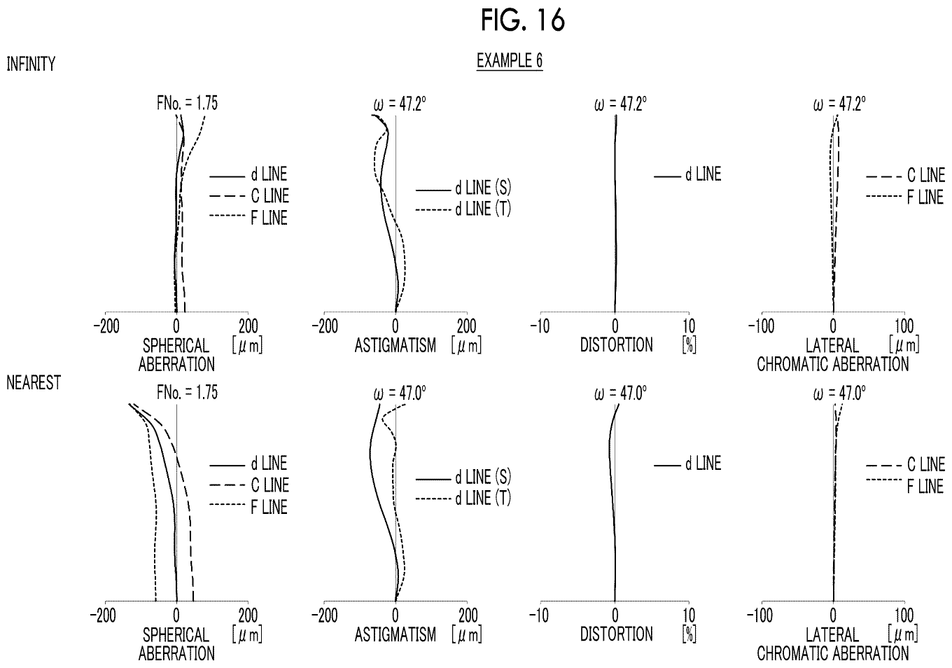

For the optical system of Example 6, basic lens data is shown in Table 16, specifications and variable surface spacings are shown in Table 17, aspherical coefficients are shown in Table 18, and each aberration diagram is illustrated in FIG. 16. The distance on the optical axis from the nearest object to the lens surface closest to the object side is 0.189 meters

TABLE 16
Example 6

| Sn | R | D | Nd | νd | θgF | ED |
|---|---|---|---|---|---|---|
| *1 | 4342896.7477 | 2.9553 | 1.58313 | 59.38 | 0.54237 | 50.3584 |
| *2 | 32.2432 | 11.1881 | | | | 38.6573 |
| 3 | −895.2831 | 1.6357 | 1.43700 | 95.10 | 0.53364 | 38.1765 |
| 4 | 38.0816 | 9.7469 | | | | 32.9552 |
| 5 | −26.4663 | 1.4063 | 1.48749 | 70.44 | 0.53062 | 32.6102 |
| 6 | 35.8820 | 5.9344 | 2.01960 | 21.45 | 0.63675 | 33.1545 |
| 7 | −537.2266 | 0.1000 | | | | 32.7755 |
| 8 | 45.3737 | 12.5260 | 1.68500 | 49.22 | 0.55927 | 31.0719 |
| 9 | −23.0030 | 1.2293 | 1.94595 | 17.98 | 0.65460 | 29.4151 |
| 10 | 56.8799 | 0.1000 | | | | 28.9608 |
| *11 | 47.6209 | 4.1702 | 1.85135 | 40.10 | 0.56954 | 29.4605 |
| *12 | −2067.1084 | 3.7865 | | | | 29.5414 |
| 13 | ∞ | 5.4244 | | | | 31.2125 |
| (St) | | | | | | |
| 14 | 233.8815 | 5.5263 | 1.98613 | 16.48 | 0.66558 | 35.3331 |
| 15 | −49.1177 | 3.7355 | | | | 35.7038 |
| 16 | 762.9813 | 9.5389 | 1.49700 | 81.61 | 0.53887 | 33.6804 |
| 17 | −23.9302 | 1.4255 | 2.00272 | 19.32 | 0.64514 | 33.2991 |
| 18 | −30.7976 | 0.1000 | | | | 34.3959 |
| 19 | 307.3682 | 6.9755 | 1.55032 | 75.50 | 0.54001 | 30.3871 |
| 20 | −27.0636 | 1.9325 | 2.00330 | 28.27 | 0.59802 | 30.4275 |
| 21 | −51.8599 | DD[21] | | | | 31.7163 |
| *22 | −24.8681 | 1.9112 | 1.85135 | 40.10 | 0.56954 | 31.6254 |
| *23 | −52.9641 | DD[23] | | | | 30.6624 |
| 24 | 61.8955 | 1.4629 | 1.98613 | 16.48 | 0.66558 | 34.8981 |
| 25 | 49.2025 | 3.9518 | | | | 35.1907 |
| *26 | 34.5698 | 5.8242 | 1.53409 | 55.87 | 0.55876 | 40.0997 |
| *27 | 97.5267 | 19.2958 | | | | 41.3137 |
| 28 | ∞ | 3.2000 | 1.51680 | 64.20 | 0.53430 | 54.1174 |
| 29 | ∞ | 0.0000 | | | | 55.4247 |

TABLE 17
Example 6

| | Infinite Distance | Nearest |
|---|---|---|
| Focal Length | 25.57 | 24.63 |
| Open F-Number | 1.75 | 1.75 |
| Maximum Full Angle of View [°] | 94.4 | 94.0 |
| Lateral Magnification | 0 | −0.12 |
| DD[21] | 4.9997 | 6.8783 |
| DD[23] | 4.9234 | 3.0448 |

TABLE 18
Example 6

| Sn | 1 | 2 | 11 | 12 |
|---|---|---|---|---|
| KA | −5.000000000E+00 | −4.600247912E+00 | 2.758955074E−01 | 5.000000000E+00 |
| A3 | 0.000000000E+00 | 0.000000000E+00 | 0.000000000E+00 | 0.000000000E+00 |
| A4 | 1.072975160E−04 | 1.393356492E−04 | 1.220627993E−05 | 2.586489505E−05 |
| A5 | −3.051636716E−06 | −4.124468388E−06 | −5.570091552E−08 | 1.605643883E−08 |
| A6 | −4.287650785E−07 | −1.231977914E−07 | 9.192152119E−09 | 3.081294057E−08 |
| A7 | 1.745521293E−08 | −1.757596788E−09 | 2.737918909E−09 | −4.947129414E−10 |
| A8 | 1.769541763E−09 | −1.726922926E−09 | −3.909887244E−10 | −4.908081306E−11 |
| A9 | −1.352509004E−10 | 3.438062609E−10 | 1.879504423E−11 | −1.959067896E−11 |
| A10 | 7.037744400E−13 | −9.696866609E−12 | −1.879742360E−12 | 2.730350164E−12 |
| A11 | 2.000878098E−13 | −8.983346093E−13 | 1.821361431E−13 | 2.122491750E−14 |
| A12 | −6.700469056E−15 | 4.189264413E−14 | 9.801220643E−16 | −2.766578799E−14 |
| A13 | 7.264902127E−17 | 1.043981862E−15 | −1.219905654E−15 | 1.705293399E−15 |
| A14 | −1.634787870E−18 | −7.364960736E−17 | 5.148388605E−17 | −1.151865686E−17 |
| A15 | 7.584140958E−20 | 3.805749286E−19 | 4.138491604E−19 | −2.131559172E−18 |
| A16 | −1.002291986E−21 | 1.541160882E−20 | −4.107883692E−20 | 5.841863843E−20 |
| Sn | 22 | 23 | 26 | 27 |
| KA | 4.028066633E−01 | −2.553771066E+00 | 1.309040795E+00 | 4.999917421E+00 |
| A3 | 0.000000000E+00 | 0.000000000E+00 | 0.000000000E+00 | 0.000000000E+00 |
| A4 | 2.518240947E−04 | 2.276903021E−04 | −3.038553350E−05 | −1.037720678E−05 |
| A5 | −1.239892376E−06 | −2.352782943E−06 | −9.079793816E−08 | −4.236544151E−06 |
| A6 | −2.268489672E−06 | −1.230304225E−06 | −1.005543261E−08 | 4.698190391E−07 |
| A7 | 1.110306922E−07 | −2.809857077E−09 | −1.894158597E−08 | −1.686390572E−08 |
| A8 | 5.391937512E−09 | 8.477639943E−09 | 5.186625546E−09 | −1.015866847E−09 |
| A9 | −3.407920081E−10 | −1.260957759E−10 | −5.384561721E−10 | 1.047435766E−10 |
| A10 | −8.271975592E−12 | −2.478140916E−11 | 2.754551265E−11 | 2.823767031E−13 |
| A11 | −1.575255030E−12 | 4.050790477E−13 | −5.646957439E−13 | −2.888979125E−13 |
| A12 | 2.719775659E−13 | −5.186539080E−14 | −9.908995438E−15 | 1.051311609E−15 |
| A13 | −9.635961087E−15 | 1.623886212E−14 | 9.812399928E−16 | 9.519917455E−16 |
| A14 | −1.433212670E−16 | −1.184898800E−15 | −3.435894409E−17 | −4.178577837E−17 |
| A15 | 1.483554910E−17 | 3.580812220E−17 | 7.164540918E−19 | 5.701377527E−19 |
| A16 | −2.375855999E−19 | −4.087522626E−19 | −6.645778245E−21 | −6.030132339E−22 |

### Example 7

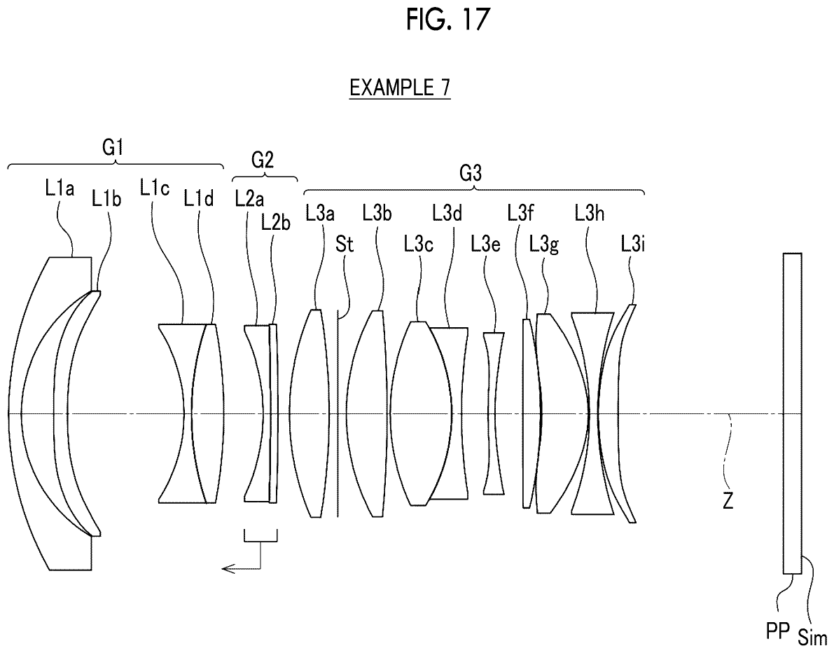

A cross-sectional view of a configuration of an optical system of Example 7 is illustrated in FIG. 17. The optical system of Example 7 consists of the first lens group G1 having a negative refractive power, the second lens group G2 having a negative refractive object side to the image side. The optical system of Example 7 includes only one focusing group. During focusing on the nearest object from the infinite distance object, the first lens group G1 and the third lens group G3 are fixed with respect to the image plane Sim, and the second lens group G2 moves to the object side.

The first lens group G1 consists of four lenses of the lenses L1a to L1d in this order from the object side to the image side. The second lens group G2 consists of two lenses of the lenses L2a and L2b in this order from the object side to the image side. The third lens group G3 consists of the lens L3a, the aperture stop St, and lenses L3b to L3i in this order from the object side to the image side.

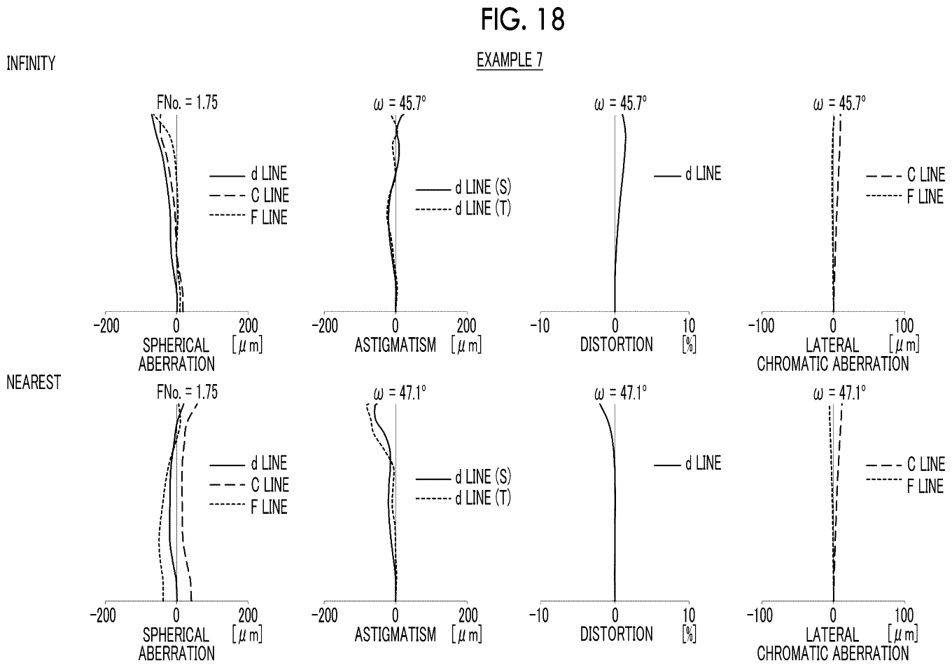

For the optical system of Example 7, basic lens data is shown in Table 19, specifications and variable surface spacings are shown in Table 20, aspherical coefficients are shown in Table 21, and each aberration diagram is illustrated in FIG. 18. The distance on the optical axis from the nearest object to the lens surface closest to the object side is 0.192 meters (m).

TABLE 19
Example 7

| Sn | R | D | Nd | νd | θgF | ED |
|---|---|---|---|---|---|---|
| 1 | 55.1068 | 2.2224 | 1.84850 | 43.79 | 0.56197 | 54.1283 |
| 2 | 24.6415 | 5.6175 | | | | 42.5302 |
| *3 | 258.0045 | 2.4158 | 1.49710 | 81.56 | 0.53848 | 42.4256 |
| *4 | 75.7751 | 20.2985 | | | | 40.8745 |
| 5 | −27.1053 | 1.3086 | 1.49700 | 81.61 | 0.53887 | 29.6316 |
| 6 | 47.8902 | 5.6144 | 2.00330 | 28.27 | 0.59802 | 30.9161 |
| 7 | −82.5131 | DD[7] | | | | 30.8482 |
| 8 | −33.0756 | 1.2858 | 1.73800 | 32.26 | 0.58963 | 28.5489 |
| 9 | −574.3671 | 1.2981 | 1.98613 | 16.48 | 0.66558 | 30.4203 |
| 10 | −409.5254 | DD[10] | | | | 30.8857 |
| 11 | 45.0159 | 6.9120 | 1.59282 | 68.62 | 0.54414 | 35.8202 |
| 12 | −110.2958 | 1.5000 | | | | 35.9455 |
| 13 | ∞ | 1.5000 | | | | 35.7087 |
| (St) | | | | | | |
| 14 | 37.1503 | 7.0904 | 1.55032 | 75.50 | 0.54001 | 35.6493 |
| 15 | −203.9741 | 0.5512 | | | | 34.9688 |
| 16 | 37.3529 | 10.5961 | 1.61997 | 63.88 | 0.54252 | 31.7912 |
| 17 | −30.0891 | 1.7165 | 1.85451 | 25.15 | 0.61031 | 29.6092 |
| 18 | 87.6288 | 4.6276 | | | | 27.0638 |
| *19 | 71.2534 | 1.1790 | 1.85135 | 40.10 | 0.56954 | 26.8368 |
| *20 | 45.5475 | 4.8459 | | | | 27.9274 |
| 21 | 1715.1316 | 3.0765 | 1.98613 | 16.48 | 0.66558 | 31.9350 |
| 22 | −71.9222 | 0.2707 | | | | 32.5759 |
| *23 | −33.1314 | 8.0708 | 1.62263 | 58.16 | 0.53913 | 33.5628 |
| *24 | −20.0416 | 0.2063 | | | | 34.4632 |
| 25 | −46.6831 | 1.4582 | 1.77047 | 29.74 | 0.59514 | 33.4723 |
| 26 | 55.7731 | 0.1000 | | | | 34.8877 |
| *27 | 39.4802 | 3.4393 | 1.80625 | 40.91 | 0.56920 | 37.6656 |
| *28 | 288.9301 | 28.7465 | | | | 37.5827 |
| 29 | ∞ | 3.2000 | 1.51680 | 64.20 | 0.53430 | 54.0833 |
| 30 | ∞ | 0.0000 | | | | 55.4669 |

TABLE 20
Example 7

| | Infinite Distance | Nearest |
|---|---|---|
| Focal Length | 26.76 | 25.07 |
| Open F-Number | 1.75 | 1.75 |
| Maximum Full Angle of View [°] | 91.4 | 94.2 |
| Lateral Magnification | 0 | −0.12 |
| DD[7] | 6.8575 | 5.0017 |
| DD[10] | 1.9991 | 3.8549 |

TABLE 21
Example 7

| Sn | 3 | 4 | 19 | 20 |
|---|---|---|---|---|
| KA | −2.999995131E+00 | −1.321105915E+00 | −4.999999439E+00 | −4.157560306E+00 |
| A3 | 0.000000000E+00 | 0.000000000E+00 | 0.000000000E+00 | 0.000000000E+00 |
| A4 | 4.876726368E−05 | 4.709773821E−05 | −6.749285679E−05 | −1.817183948E−05 |
| A5 | 2.388556131E−06 | 8.774364216E−07 | 2.117743228E−06 | 8.968978548E−07 |
| A6 | −5.437203718E−07 | −2.437772174E−07 | −6.615601145E−07 | −3.228131916E−07 |
| A7 | 2.249975344E−08 | −7.250293682E−09 | 3.494438115E−08 | 2.298861907E−08 |
| A8 | 5.838201804E−10 | 1.404637692E−09 | 4.587362492E−09 | −6.201218257E−11 |
| A9 | −5.841896444E−11 | 5.297455656E−12 | −5.455782816E−10 | 1.062997195E−10 |
| A10 | −6.094204792E−13 | −2.821681137E−12 | −1.771397947E−11 | −6.655329723E−12 |
| A11 | 1.836144026E−13 | −1.908232935E−13 | 8.019267183E−12 | −6.725209612E−13 |
| A12 | −7.675079199E−15 | 1.625657909E−14 | −6.366276387E−13 | 3.885266736E−14 |
| A13 | 1.403695506E−16 | 2.465952605E−16 | 2.001304213E−14 | 3.930796263E−15 |
| A14 | 5.173600149E−19 | −4.607502391E−17 | −2.211699156E−16 | −4.708371305E−16 |
| A15 | −1.416425559E−20 | 1.329592792E−18 | 3.409368648E−18 | 1.868755611E−17 |
| A16 | 5.916898931E−23 | −1.245482046E−20 | −1.289827482E−19 | −2.736971755E−19 |
| Sn | 23 | 24 | 27 | 28 |
| KA | 1.618976692E+00 | 2.810951168E−01 | −9.110673198E−01 | −5.000000000E+00 |
| A3 | 0.000000000E+00 | 0.000000000E+00 | 0.000000000E+00 | 0.000000000E+00 |
| A4 | 7.457802173E−05 | 8.340006984E−08 | −3.653805299E−05 | −8.788394646E−06 |
| A5 | −6.718187780E−07 | 5.370827096E−06 | 4.997812308E−06 | 1.106629116E−06 |
| A6 | −8.898481508E−08 | −1.301316095E−07 | 9.382831642E−09 | 7.103125305E−08 |
| A7 | 1.888708258E−08 | −4.602202643E−08 | −1.165499249E−08 | 1.765215524E−08 |
| A8 | −1.686027375E−09 | 2.622481231E−09 | −8.648048181E−10 | −1.826566240E−09 |
| A9 | 1.283903691E−11 | 3.402430517E−11 | 3.038678121E−11 | 1.314561149E−11 |
| A10 | 2.807933081E−12 | 1.508869246E−12 | 1.876869423E−11 | 4.320611092E−12 |
| A11 | 2.060020405E−14 | −8.559317981E−13 | −2.177560527E−12 | −3.741169143E−13 |
| A12 | −1.623230533E−14 | 5.454486813E−14 | 9.595612080E−14 | 2.711037107E−14 |
| A13 | 1.613181395E−15 | −1.984976356E−15 | −9.764953702E−16 | −1.294163577E−15 |
| A14 | −9.368110591E−17 | 7.012214294E−17 | −7.283465922E−17 | 2.571546840E−17 |
| A15 | 2.816165347E−18 | −1.930179391E−18 | 2.833367605E−18 | 1.184390307E−19 |
| A16 | −3.346209477E−20 | 2.272737984E−20 | −3.174469649E−20 | −7.679957601E−21 |

### Example 8

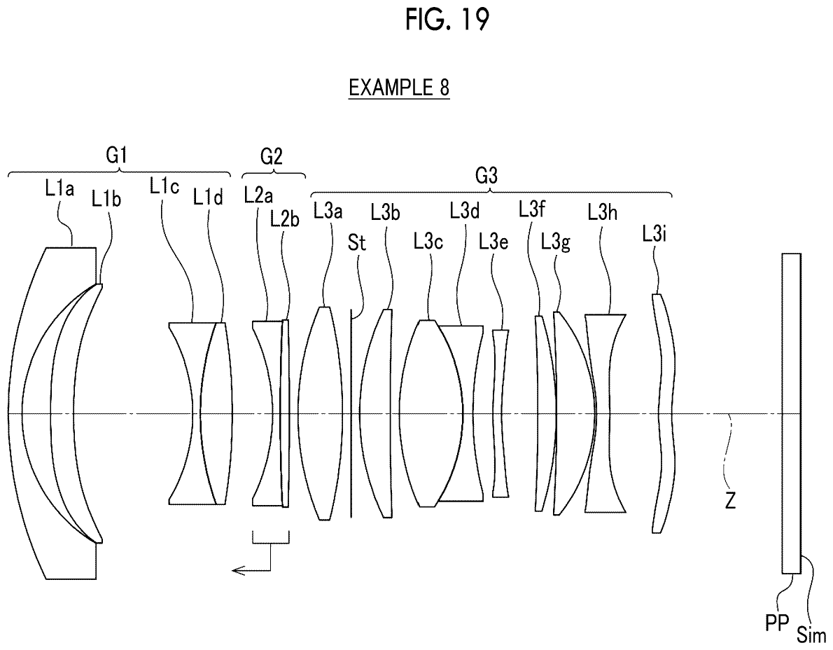

A cross-sectional view of a configuration of an optical system of Example 8 is illustrated in FIG. 19. The optical system of Example 8 consists of the first lens group G1 having a negative refractive power, the second lens group G2 having a negative refractive object side to the image side. The optical system of Example 8 includes only one focusing group. During focusing on the nearest object from the infinite distance object, the first lens group G1 and the third lens group G3 are fixed with respect to the image plane Sim, and the second lens group G2 moves to the object side.

The first lens group G1 consists of four lenses of the lenses L1a to L1d in this order from the object side to the image side. The second lens group G2 consists of two lenses of the lenses L2a and L2b in this order from the object side to the image side. The third lens group G3 consists of the lens L3a, the aperture stop St, and the lenses L3b to L3i in this order from the object side to the image side.

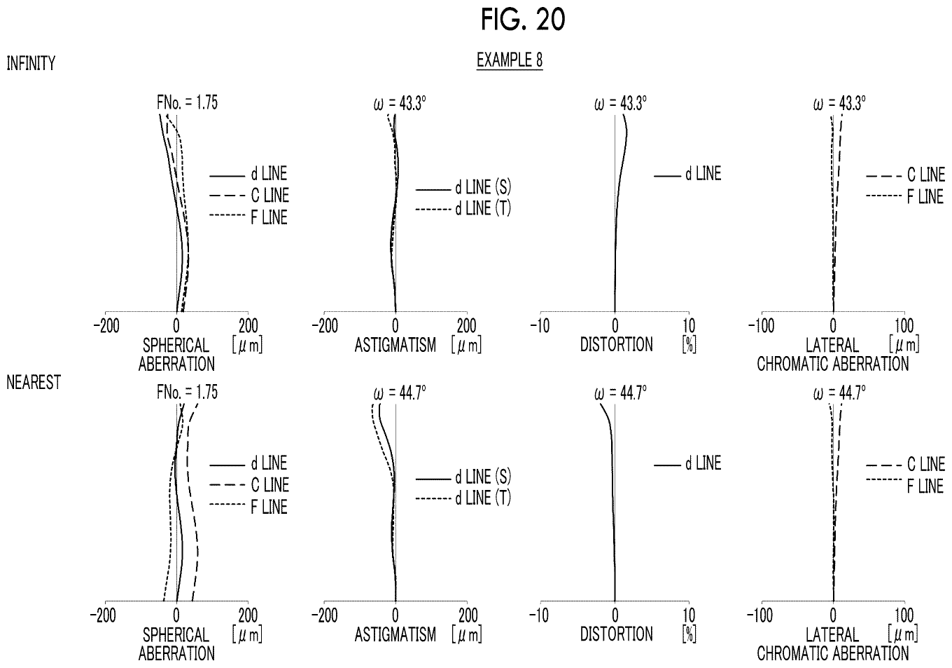

For the optical system of Example 8, basic lens data is shown in Table 22, specifications and variable surface spacings are shown in Table 23, aspherical coefficients are shown in Table 24, and each aberration diagram is illustrated in FIG. 20. The distance on the optical axis from the nearest object to the lens surface closest to the object side is 0.209 meters (m).

TABLE 22
Example 8

| Sn | R | D | Nd | νd | θgF | ED |
|---|---|---|---|---|---|---|
| 1 | 65.8330 | 2.3607 | 1.77535 | 50.31 | 0.55042 | 57.4020 |
| 2 | 25.9927 | 4.9898 | | | | 44.8858 |
| *3 | 105.0664 | 4.0275 | 1.49710 | 81.56 | 0.53848 | 44.8481 |
| *4 | 82.1551 | 20.7541 | | | | 43.6494 |
| 5 | −28.9611 | 1.3219 | 1.49700 | 81.61 | 0.53887 | 29.7205 |
| 6 | 45.8287 | 5.5754 | 1.95375 | 32.32 | 0.59056 | 31.3447 |
| 7 | −96.6938 | DD[7] | | | | 31.3116 |
| 8 | −32.9215 | 1.3417 | 1.73800 | 32.26 | 0.58963 | 29.5734 |
| 9 | 340.5825 | 1.5807 | 1.98613 | 16.48 | 0.66558 | 31.9493 |
| 10 | −651.0791 | DD[10] | | | | 32.3346 |
| 11 | 47.2397 | 7.7662 | 1.59282 | 68.62 | 0.54414 | 36.6831 |
| 12 | −77.1919 | 1.5000 | | | | 36.7810 |
| 13 | ∞ | 1.5000 | | | | 36.0009 |
| (St) | | | | | | |
| 14 | 41.0118 | 5.3137 | 1.72916 | 54.68 | 0.54484 | 35.9530 |
| 15 | 542.5422 | 1.5775 | | | | 35.3808 |
| 16 | 39.3136 | 10.9746 | 1.61997 | 63.88 | 0.54252 | 32.2817 |
| 17 | −28.8024 | 1.7546 | 1.85478 | 24.80 | 0.61232 | 30.2686 |
| 18 | 55.6836 | 3.4772 | | | | 27.9046 |
| *19 | 50.7928 | 1.5055 | 1.85135 | 40.10 | 0.56954 | 28.2046 |
| *20 | 48.1456 | 6.3272 | | | | 28.8813 |
| 21 | −331.0324 | 3.1897 | 1.98613 | 16.48 | 0.66558 | 33.1611 |
| 22 | −58.7100 | 0.1000 | | | | 33.7535 |
| 23 | −286.5236 | 6.6237 | 1.62299 | 58.16 | 0.54589 | 34.6995 |
| 24 | −27.9935 | 0.3403 | | | | 35.0712 |
| *25 | −24.4894 | 2.2830 | 1.77047 | 29.74 | 0.59514 | 33.9970 |
| *26 | −88.7636 | 8.5011 | | | | 34.2227 |
| *27 | 28.7832 | 2.3007 | 1.80625 | 40.91 | 0.56920 | 40.2136 |
| *28 | 29.1979 | 19.2938 | | | | 41.2903 |
| 29 | ∞ | 3.2000 | 1.51680 | 64.20 | 0.53430 | 54.1794 |
| 30 | ∞ | 0.0000 | | | | 55.4285 |

TABLE 23
Example 8

| | Infinite Distance | Nearest |
|---|---|---|
| Focal Length | 29.09 | 26.96 |
| Open F-Number | 1.75 | 1.75 |
| Maximum Full Angle of View [°] | 86.6 | 89.4 |
| Lateral Magnification | 0 | −0.12 |
| DD[7] | 7.0189 | 5.0664 |
| DD[10] | 1.4998 | 3.4523 |

TABLE 24
Example 8

| Sn | 3 | 4 | 19 | 20 |
|---|---|---|---|---|
| KA | 1.083613589E+00 | −2.049740757E+00 | 4.999998963E+00 | 2.759786294E+00 |
| A3 | 0.000000000E+00 | 0.000000000E+00 | 0.000000000E+00 | 0.000000000E+00 |
| A4 | 2.770342527E−05 | 1.931253345E−05 | −6.313426589E−05 | −3.680162610E−05 |
| A5 | −8.825608284E−07 | 9.463945352E−07 | −1.372736504E−06 | −2.455308893E−06 |
| A6 | 1.968672778E−07 | −2.143014291E−07 | 1.873806330E−07 | 6.013685504E−07 |
| A7 | −3.831254063E−08 | 1.272494806E−08 | −2.282556251E−08 | −9.869457253E−08 |
| A8 | 3.727492378E−09 | −1.246271081E−10 | −1.342841892E−09 | 7.832184806E−09 |
| A9 | −1.848372974E−10 | −2.419366535E−11 | 3.725409521E−10 | −2.976090587E−10 |
| A10 | 3.188199017E−12 | 1.058156784E−12 | 8.483962928E−12 | 4.200034594E−11 |
| A11 | 1.296627693E−13 | 1.085752394E−14 | −3.144347849E−12 | −4.203621172E−12 |
| A12 | −9.364805967E−15 | −2.280241544E−15 | 1.550369794E−13 | 6.496877684E−14 |
| A13 | 3.414419459E−16 | 6.869128700E−17 | −4.314376916E−15 | 1.141685091E−14 |
| A14 | −1.140835314E−17 | 8.263755658E−19 | 1.253571119E−16 | −7.337417647E−16 |
| A15 | 2.744103802E−19 | −9.033326058E−20 | −5.916848601E−19 | 1.843044207E−17 |
| A16 | −2.743051511E−21 | 1.364484896E−21 | −6.470034417E−20 | −1.842449634E−19 |
| Sn | 25 | 26 | 27 | 28 |
| KA | 1.422601292E+00 | 4.999999996E+00 | −1.922449220E+00 | 1.051016822E+00 |
| A3 | 0.000000000E+00 | 0.000000000E+00 | 0.000000000E+00 | 0.000000000E+00 |
| A4 | 1.313343393E−04 | 9.343601635E−05 | −1.691441905E−04 | −1.841834588E−04 |
| A5 | 2.643911467E−07 | −1.674223057E−06 | 3.551303937E−06 | 3.360614327E−06 |
| A6 | −4.000531826E−07 | 3.578489514E−07 | −2.451662338E−07 | 1.354742085E−07 |
| A7 | 1.577671295E−08 | −3.811439398E−08 | 7.878306267E−08 | 2.507322861E−08 |
| A8 | −7.800652807E−09 | −3.907097726E−09 | −5.086870431E−09 | −4.959275951E−10 |
| A9 | 1.138167276E−09 | 5.361305774E−10 | 2.108628661E−10 | −1.262108891E−10 |
| A10 | −3.366176284E−11 | 9.523362985E−12 | −1.468434604E−11 | −1.621508731E−12 |
| A11 | −4.185054826E−12 | −3.659887877E−12 | 8.342516575E−13 | 8.292630548E−13 |
| A12 | 3.636059964E−13 | 1.933469838E−13 | −7.357865052E−15 | −1.619806750E−14 |
| A13 | −6.818138196E−15 | −7.185246238E−15 | −1.638729272E−15 | −1.864171791E−15 |
| A14 | −2.988041673E−16 | 4.095826715E−16 | 6.504927492E−17 | 8.585538329E−17 |
| A15 | 1.518933118E−17 | −1.580737694E−17 | −1.385412548E−19 | −6.420955497E−19 |
| A16 | −1.931168657E−19 | 2.201482369E−19 | −1.864428462E−20 | −1.253001963E−20 |

### Example 9

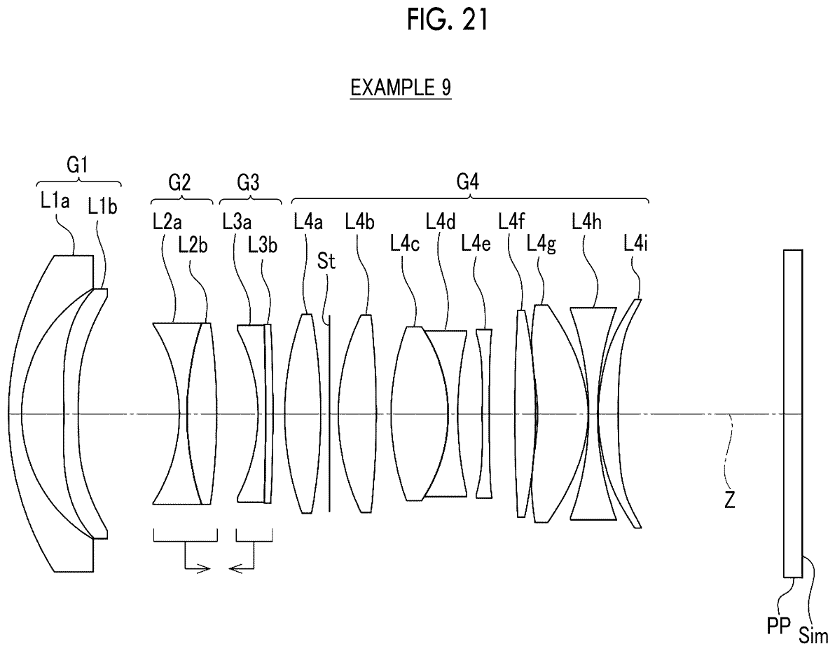

A cross-sectional view of a configuration of an optical system of Example 9 is illustrated in FIG. 21. The optical system of Example 9 consists of the first lens group G1 having a negative refractive power, the second lens group G2 having a positive refractive power, the third lens group G3 having a negative refractive power, and the fourth lens group G4 having a positive refractive power in this order from the object side to the image side. The optical system of Example 9 includes two focusing groups. During focusing on the nearest object from the infinite distance object, the first lens group G1 and the fourth lens group G4 are fixed with respect to the image plane Sim. The second lens group G2 moves to the image side, and the third lens group G3 moves to the object side.

The first lens group G1 consists of two lenses of the lenses L1a and L1b in this order from the object side to the image side. The second lens group G2 consists of two lenses of the lenses L2a and L2b in this order from the object side to the image side. The third lens group G3 consists of two lenses of the lenses L3a and L3b in this order from the object side to the image side. The fourth lens group G4 consists of the lens L4a, the aperture stop St, and lenses L4b to L4i in this order from the object side to the image side.

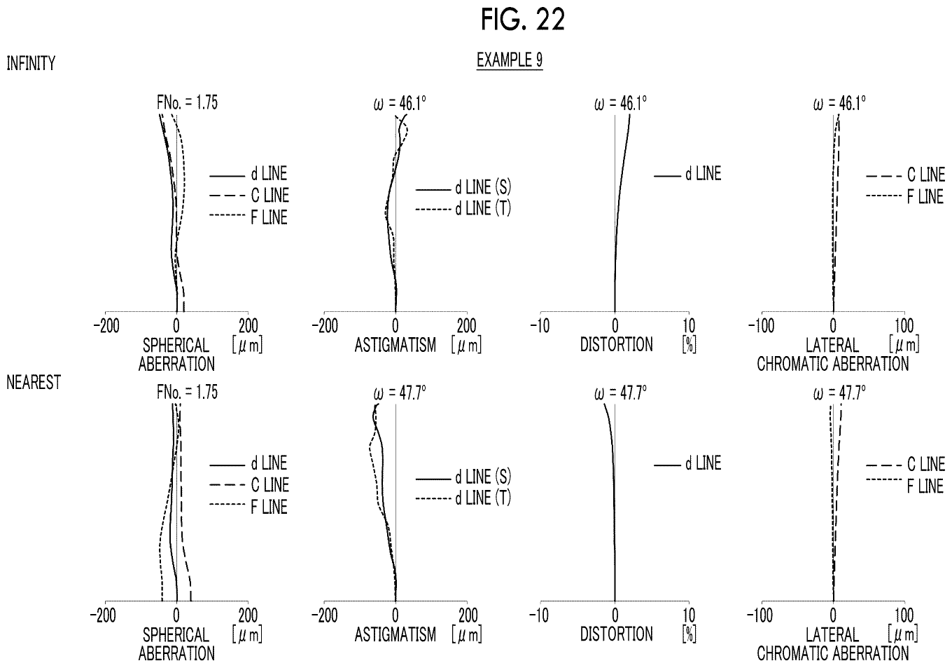

For the optical system of Example 9, basic lens data is shown in Table 25, specifications and variable surface spacings are shown in Table 26, aspherical coefficients are shown in Table 27, and each aberration diagram is illustrated in FIG. 22. The distance on the optical axis from the nearest object to the lens surface closest to the object side is 0.187 meters (m).

TABLE 25
Example 9

| Sn | R | D | Nd | νd | θgF | ED |
|---|---|---|---|---|---|---|
| 1 | 50.0218 | 2.2018 | 1.84850 | 43.79 | 0.56197 | 53.5594 |
| 2 | 24.5874 | 7.2102 | | | | 42.4413 |
| *3 | −150.2604 | 2.4420 | 1.49710 | 81.56 | 0.53848 | 42.2571 |
| *4 | 155.8190 | DD[4] | | | | 39.7176 |
| 5 | −27.6516 | 1.3068 | 1.45860 | 90.19 | 0.53516 | 30.1885 |
| 6 | 48.4851 | 5.0340 | 2.00100 | 29.13 | 0.59952 | 30.6494 |
| 7 | −112.2117 | DD[7] | | | | 30.4395 |
| 8 | −30.2049 | 1.2866 | 1.59270 | 35.45 | 0.59271 | 28.1645 |
| 9 | −488.4531 | 1.2678 | 1.98613 | 16.48 | 0.66558 | 29.8858 |
| 10 | −293.8746 | DD[10] | | | | 30.2351 |
| 11 | 49.9185 | 6.1107 | 1.59282 | 68.62 | 0.54414 | 33.5679 |
| 12 | −91.5373 | 1.5000 | | | | 33.6432 |
| 13 | ∞ | 1.5000 | | | | 33.1840 |
| (St) | | | | | | |
| 14 | 37.8173 | 6.4618 | 1.55032 | 75.50 | 0.54001 | 33.4071 |
| 15 | −156.1067 | 2.5435 | | | | 32.8841 |
| 16 | 42.3431 | 9.5963 | 1.61997 | 63.88 | 0.54252 | 29.3639 |
| 17 | −26.0986 | 1.6220 | 1.85451 | 25.15 | 0.61031 | 28.0331 |
| 18 | 60.6449 | 4.1478 | | | | 26.6070 |
| *19 | 364.9560 | 1.2057 | 1.85135 | 40.10 | 0.56954 | 27.2600 |
| *20 | 574.2476 | 4.3552 | | | | 28.4719 |
| 21 | 303.7181 | 3.5282 | 1.98613 | 16.48 | 0.66558 | 34.3236 |
| 22 | −83.5578 | 0.3645 | | | | 34.9630 |
| *23 | −29.5450 | 8.5849 | 1.62263 | 58.16 | 0.53913 | 36.1644 |
| *24 | −21.3468 | 0.1000 | | | | 36.7632 |
| 25 | −51.2692 | 1.5184 | 1.77047 | 29.74 | 0.59514 | 35.1360 |
| 26 | 51.8095 | 0.1000 | | | | 35.8968 |
| *27 | 27.6536 | 3.3867 | 1.80625 | 40.91 | 0.56920 | 38.5948 |
| *28 | 96.3174 | 28.1809 | | | | 38.4735 |
| 29 | ∞ | 3.2000 | 1.51680 | 64.20 | 0.53430 | 54.0943 |
| 30 | ∞ | 0.0000 | | | | 55.4469 |

TABLE 26
Example 9

| | Infinite Distance | Nearest |
|---|---|---|
| Focal Length | 26.13 | 24.52 |
| Open F-Number | 1.75 | 1.75 |
| Maximum Full Angle of View [°] | 92.2 | 95.4 |
| Lateral Magnification | 0 | −0.12 |
| DD[4] | 17.2088 | 17.3086 |
| DD[7] | 7.0388 | 4.5737 |
| DD[10] | 1.9998 | 4.3650 |

TABLE 27
Example 9

| Sn | 3 | 4 | 19 | 20 |
|---|---|---|---|---|
| KA | 3.000000004E+00 | −2.575906969E+00 | −4.287676071E+00 | 4.999995957E+00 |
| A3 | 0.000000000E+00 | 0.000000000E+00 | 0.000000000E+00 | 0.000000000E+00 |
| A4 | 7.277698836E−05 | 7.437456300E−05 | −2.868129767E−05 | 1.504421825E−05 |
| A5 | 2.918735824E−06 | −3.376626985E−06 | −6.271351861E−08 | −1.248429889E−06 |
| A6 | −7.993493828E−07 | 1.474882231E−06 | −3.814110092E−07 | 1.082672274E−07 |
| A7 | 1.873093502E−08 | −4.141514940E−07 | 8.054361108E−08 | −9.566659255E−09 |
| A8 | 3.832287883E−09 | 4.937656916E−08 | −1.065715043E−08 | −2.766865361E−10 |
| A9 | −2.887554894E−10 | −2.472780339E−09 | 8.241257450E−10 | 1.354531673E−11 |
| A10 | 1.324094010E−12 | −5.002766046E−11 | −4.398306577E−11 | 6.220849100E−12 |
| A11 | 6.477886475E−13 | 1.433905341E−11 | 2.426933214E−12 | −1.292646415E−13 |
| A12 | −2.722643184E−14 | −8.310228794E−13 | −6.825855295E−14 | −7.549269329E−15 |
| A13 | 6.923876337E−17 | 1.952159654E−14 | 4.560219723E−16 | −1.630172993E−15 |
| A14 | 2.422331959E−17 | 6.524325800E−17 | −3.398042932E−16 | 1.518341354E−16 |
| A15 | −7.028122825E−19 | −1.219432604E−17 | 2.782270986E−17 | −4.422521772E−18 |
| A16 | 6.702240705E−21 | 1.730488860E−19 | −5.953362617E−19 | 4.714665776E−20 |
| Sn | 23 | 24 | 27 | 28 |
| KA | 1.482329246E+00 | 5.025078711E−01 | −2.656561445E+00 | −4.290287333E+00 |
| A3 | 0.000000000E+00 | 0.000000000E+00 | 0.000000000E+00 | 0.000000000E+00 |
| A4 | 1.124822537E−04 | −1.058188179E−05 | −6.081130238E−05 | −2.019902011E−05 |
| A5 | 4.233971472E−07 | 7.963257433E−06 | 5.636820104E−06 | −5.579212667E−07 |
| A6 | −7.530863887E−07 | −5.218025395E−07 | −9.569961168E−09 | 3.347848783E−07 |
| A7 | 6.363691267E−08 | −5.841367496E−09 | −7.929351730E−09 | 2.142794914E−09 |
| A8 | −2.559042272E−09 | 9.467524348E−11 | 1.759709913E−10 | −1.399036142E−09 |
| A9 | 1.238016651E−10 | 2.220301348E−10 | −1.633708087E−11 | 3.231157932E−11 |
| A10 | −1.656142320E−11 | −1.591259866E−11 | 1.797545252E−12 | −2.347967549E−12 |
| A11 | 1.269856979E−12 | 1.626819057E−13 | −4.231159453E−14 | 6.934539769E−13 |
| A12 | −4.744111790E−14 | 2.090450601E−14 | −1.562684367E−15 | −5.587196053E−14 |
| A13 | 1.238206702E−15 | −8.572298582E−16 | 2.012130910E−16 | 1.831863386E−15 |
| A14 | −4.677384068E−17 | 1.197791417E−17 | −2.183271227E−17 | −2.979921701E−17 |
| A15 | 1.535864988E−18 | −4.337560216E−20 | 9.889666169E−19 | 5.842672241E−19 |
| A16 | −2.005473708E−20 | −3.617913884E−22 | −1.414660674E−20 | −1.088112645E−20 |

### Example 10

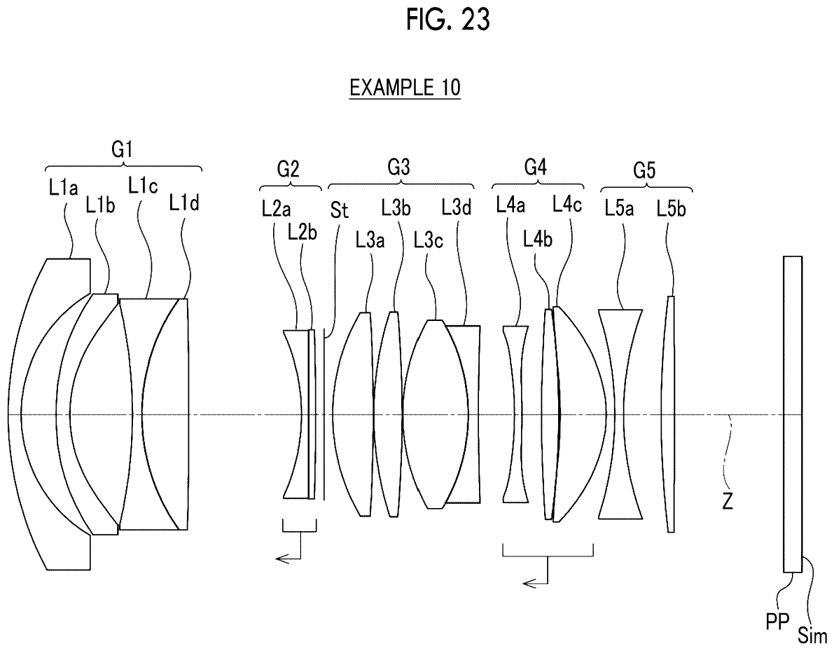

A cross-sectional view of a configuration of an optical system of Example 10 is illustrated in FIG. 23. The optical system of Example 10 consists of the first lens group G1 having a negative refractive power, the second lens group G2 having a negative refractive power, the third lens group G3 having a positive refractive power, the fourth lens group G4 having a positive refractive power, and the fifth lens group G5 having a negative refractive power in this order from the object side to the image side. The optical system of Example 10 includes two focusing groups. During focusing on the nearest object from the infinite distance object, the first lens group G1, the third lens group G3, and the fifth lens group G5 are fixed with respect to the image plane Sim, and the second lens group G2 and the fourth lens group G4 move to the object side.

The first lens group G1 consists of four lenses of the lenses L1a to L1d in this order from the object side to the image side. The second lens group G2 consists of two lenses of the lenses L2a and L2b in this order from the object side to the image side. The third lens group G3 consists of the aperture stop St and the lenses L3a to L3d in this order from the object side to the image side. The fourth lens group G4 consists of three lenses of the lenses L4a to L4c in this order from the object side to the image side. The fifth lens group G5 consists of two lenses of the lenses L5a and L5b in this order from the object side to the image side.

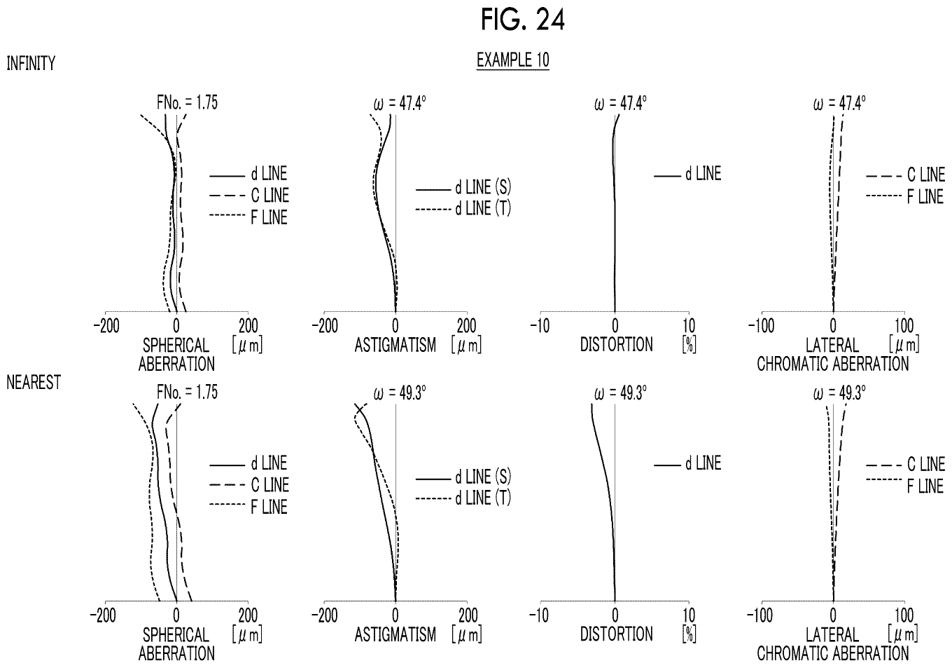

For the optical system of Example 10, basic lens data is shown in Table 28, specifications and variable surface spacings are shown in Table 29, aspherical coefficients are shown in Table 30, and each aberration diagram is illustrated in FIG. 24. The distance on the optical axis from the nearest object to the lens surface closest to the object side is 0.179 meters (m).

TABLE 28
Example 10

| Sn | R | D | Nd | νd | θgF | ED |
|---|---|---|---|---|---|---|
| 1 | 57.7680 | 2.2834 | 1.95001 | 29.37 | 0.59972 | 54.5350 |
| 2 | 24.5991 | 6.1765 | | | | 42.4563 |
| *3 | 50.4215 | 2.4384 | 1.49710 | 81.56 | 0.53848 | 42.1975 |
| *4 | 25.4410 | 11.0403 | | | | 38.7603 |
| 5 | −84.5367 | 1.6671 | 1.45860 | 90.19 | 0.53516 | 38.6032 |
| 6 | 34.5528 | 8.2862 | 2.05090 | 26.94 | 0.60519 | 40.4234 |
| 7 | −834.8494 | DD[7] | | | | 39.9905 |
| 8 | −34.1501 | 1.2227 | 1.72047 | 34.71 | 0.58350 | 28.8487 |
| 9 | 1737.3168 | 1.2721 | 1.59833 | 20.31 | 0.83392 | 29.4322 |
| *10 | −546.2978 | DD[10] | | | | 29.5977 |
| 11 | ∞ | 1.5000 | | | | 29.9986 |
| (St) | | | | | | |
| 12 | 34.9830 | 7.1736 | 1.49700 | 81.61 | 0.53887 | 35.5524 |
| 13 | −295.4360 | 0.1000 | | | | 35.6721 |
| 14 | 58.1872 | 5.0010 | 1.69680 | 56.17 | 0.54296 | 35.8976 |
| 15 | −204.4580 | 0.1000 | | | | 35.5852 |
| 16 | 34.0389 | 11.4635 | 1.55032 | 75.50 | 0.54001 | 33.0202 |
| 17 | −32.0067 | 1.8009 | 1.84666 | 23.78 | 0.61923 | 31.0275 |
| 18 | 438.8922 | DD[18] | | | | 29.2732 |
| *19 | −60.9172 | 1.3250 | 1.85400 | 40.38 | 0.56890 | 29.2311 |
| *20 | −106.8968 | 3.4627 | | | | 30.9144 |
| 21 | 256.2349 | 3.0175 | 1.98613 | 16.48 | 0.66558 | 36.0402 |
| 22 | −135.4376 | 0.2701 | | | | 36.7516 |
| *23 | −69.1114 | 8.1252 | 1.74320 | 49.29 | 0.55303 | 37.0463 |
| *24 | −21.8680 | DD[24] | | | | 37.6875 |
| 25 | −57.5157 | 1.5553 | 1.77047 | 29.74 | 0.59514 | 35.6545 |
| 26 | 52.1305 | 6.6347 | | | | 36.6344 |
| 27 | 171.1911 | 2.3309 | 1.95906 | 17.47 | 0.65862 | 41.0776 |
| 28 | −6155.7516 | 19.2953 | | | | 41.4215 |
| 29 | ∞ | 3.2000 | 1.51680 | 64.20 | 0.53430 | 54.0522 |
| 30 | ∞ | 0.0000 | | | | 55.4997 |

TABLE 29
Example 10

| | Infinite Distance | Nearest |
|---|---|---|
| Focal Length | 25.36 | 23.62 |
| Open F-Number | 1.75 | 1.75 |
| Maximum Full Angle of View [°] | 94.8 | 98.6 |
| Lateral Magnification | 0 | −0.12 |
| DD[7] | 19.8963 | 17.8327 |
| DD[10] | 1.4996 | 3.5632 |
| DD[18] | 6.3587 | 6.3240 |
| DD[24] | 1.5125 | 1.5472 |

TABLE 30
Example 10

| Sn | 3 | 4 | 10 | 19 |
|---|---|---|---|---|
| KA | −2.902338841E+00 | −1.855439088E+00 | −4.999990068E+00 | 4.354594836E−01 |
| A3 | 0.000000000E+00 | 0.000000000E+00 | 0.000000000E+00 | 0.000000000E+00 |
| A4 | 4.282289570E−05 | 6.001461731E−05 | −2.195350061E−06 | −4.128260181E−06 |
| A5 | −6.792376495E−07 | −1.454359137E−06 | 9.136445570E−07 | −3.248172170E−06 |
| A6 | −4.142620734E−08 | −1.413718764E−07 | −1.904350507E−07 | 8.986860005E−07 |
| A7 | −3.902796764E−08 | −6.355727301E−09 | 1.432171790E−08 | −1.300022430E−08 |
| A8 | 6.082965396E−09 | 2.065108881E−09 | 5.811773258E−10 | −7.796476393E−09 |
| A9 | −3.052407336E−10 | −1.115815987E−10 | −1.501240294E−10 | 5.316193436E−10 |
| A10 | −4.198565896E−12 | 1.105299530E−12 | 6.445433355E−12 | −1.792590112E−11 |
| A11 | 1.110886456E−12 | 5.509657300E−14 | 4.616876345E−14 | 9.667177243E−13 |
| A12 | −3.643756983E−14 | −7.380146456E−16 | −1.690435823E−15 | 6.430316141E−16 |
| A13 | −8.414796309E−16 | 8.743985904E−17 | 3.176073480E−17 | −8.109880999E−15 |
| A14 | 9.176855568E−17 | −8.347639291E−18 | −7.176393797E−17 | 6.887047249E−16 |
| A15 | −2.506179350E−18 | 2.111942046E−19 | 4.893553623E−18 | −2.435331432E−17 |
| A16 | 2.455136318E−20 | −1.434534763E−21 | −9.268950534E−20 | 3.241787192E−19 |

| Sn | 20 | 23 | 24 |
|---|---|---|---|
| KA | 2.989503245E−01 | 4.924960121E+00 | 8.373113865E−01 |
| A3 | 0.000000000E+00 | 0.000000000E+00 | 0.000000000E+00 |
| A4 | 2.812345754E−05 | 1.207561883E−05 | 1.335653592E−05 |
| A5 | −2.284340130E−07 | 7.852964352E−07 | 5.299641391E−07 |
| A6 | 2.339136267E−07 | −4.581008017E−08 | −7.749870510E−08 |
| A7 | 8.237286853E−08 | −5.383344404E−09 | 2.636153908E−09 |
| A8 | −1.701178099E−08 | 7.693047899E−10 | 3.802345136E−11 |
| A9 | 1.328529650E−09 | −2.279871142E−11 | −2.659532883E−12 |
| A10 | −6.174269495E−11 | −1.363206430E−12 | 7.443732429E−14 |
| A11 | 3.247514650E−14 | 1.199167915E−13 | −1.811933215E−14 |
| A12 | 3.070780945E−13 | −3.378181879E−15 | 1.447553591E−15 |
| A13 | −2.425154193E−14 | −7.393156090E−17 | −9.400030610E−18 |
| A14 | 8.416177612E−16 | 1.175234979E−17 | −2.626802777E−18 |
| A15 | −1.306444362E−17 | −4.380084846E−19 | 9.902497597E−20 |
| A16 | 5.984852679E−20 | 5.589644702E−21 | −1.141257871E−21 |

The corresponding values of Conditional Expressions (1) to (32) of the optical systems of Examples 1 to 10 are shown in Tables 31 and 32. Preferable ranges of the conditional expressions may be set using the corresponding values of the examples shown in Tables 31 and 32 as the upper limits and the lower limits of the conditional expressions.

TABLE 31

| Expression | | | | | | |
|---|---|---|---|---|---|---|
| Number | | Example 1 | Example 2 | Example 3 | Example 4 | Example 5 |
| (1) | α1 | −59.5300 | −59.5459 | −53.1588 | −56.5228 | −49.4674 |
| (2) | FNo | 1.75 | 1.75 | 1.75 | 1.75 | 1.75 |
| (3) | Bf/Y | 0.7633 | 0.7573 | 0.7727 | 0.7574 | 0.7579 |
| (4) | dStP/dStI | 0.0670 | 0.0479 | 0.0514 | 0.0498 | 0.0868 |
| (5) | Y/fEd | −0.1613 | −0.1239 | −0.0915 | −0.1100 | −0.0273 |
| (6) | α2 | −23.5553 | −22.4823 | −23.0139 | −24.9248 | −22.2846 |
| (7) | Y/fP | 0.3303 | 0.3470 | 0.3787 | 0.2158 | 0.4083 |
| (8) | ωm | 39.49 | 38.79 | 44.11 | 41.66 | 42.30 |
| (9) | f/Denp | 1.4473 | 1.5030 | 1.1963 | 1.2965 | 1.4446 |
| (10) | Dexp/Y | 0.3454 | 0.3441 | 0.3613 | 0.3660 | 0.3514 |
| (11) | \|B\| | 0.1200 | 0.1500 | 0.1200 | 0.1200 | 0.1200 |
| (12) | f/\|ffm\| | 0.4616 | 0.5952 | 0.5366 | 0.5816 | 0.4362 |
| (13) | f/ffmF | 0.0950 | 0.0404 | 0.0139 | 0.0453 | 0.1895 |
| (14) | \|γfm\| | 0.8431 | 1.1510 | 1.0945 | 1.2458 | 0.9703 |
| (15) | \|Mfm\|/TL | 0.0359 | 0.0446 | 0.0295 | 0.0290 | 0.0290 |
| (16) | f/ffmR | 0.1203 | −0.0493 | −0.0253 | −0.1010 | 0.0075 |
| (17) | f/Rc1 | −0.4313 | −0.4697 | −0.6032 | −0.5791 | −0.8635 |
| (18) | f/Rc2 | 0.9293 | 0.9959 | 0.7180 | 0.7315 | 0.7529 |
| (19) | Nmax | 2.00330 | 1.98613 | 2.00171 | 1.98613 | 2.00272 |
| (20) | Np | 1.98613 | 1.98613 | 1.98613 | 1.98613 | 1.98613 |
| (21) | νp | 16.48 | 16.48 | 16.48 | 16.48 | 16.48 |
| (22) | NEd | 1.80610 | 1.80610 | 1.80610 | 1.80610 | 1.80610 |
| (23) | νEd | 40.73 | 40.73 | 40.73 | 40.73 | 40.73 |
| (24) | f/f1 | 0.0950 | 0.0404 | 0.0139 | 0.0453 | 0.1895 |
| (25) | f/f2 | 0.4616 | 0.5952 | 0.5366 | 0.5816 | 0.4362 |
| (26) | f/f3 | 0.1203 | −0.1542 | −0.0943 | −0.1236 | 0.0075 |
| (27) | f/f4 | — | 0.1004 | 0.0673 | 0.0210 | — |
| (28) | f/f5 | — | — | — | — | — |
| (29) | f/fAsp1 | −0.5815 | −0.5615 | −0.5157 | −0.4255 | −0.5623 |
| (30) | f/RAsp2 | — | — | — | — | — |
| (31) | f/RAsp3 | — | — | — | — | — |
| (32) | νAsp1 | 31.02 | 31.02 | 31.02 | 31.02 | 31.02 |

TABLE 32

| Expression | | | | | | |
|---|---|---|---|---|---|---|
| Number | | Example 6 | Example 7 | Example 8 | Example 9 | Example 10 |
| (1) | α1 | −41.1373 | −59.6527 | −59.7040 | −59.6630 | −59.6511 |
| (2) | FNo | 1.75 | 1.75 | 1.75 | 1.75 | 1.75 |
| (3) | Bf/Y | 0.7742 | 1.1253 | 0.7815 | 1.1153 | 0.7772 |
| (4) | dStP/dStI | 0.0940 | 0.0308 | 0.0269 | 0.0306 | 0.0243 |
| (5) | Y/fEd | −0.4864 | −0.1810 | −0.0186 | 0.0232 | −0.1639 |
| (6) | α2 | −34.2840 | −18.3431 | −11.4009 | −15.1858 | −23.1933 |
| (7) | Y/fP | 0.6652 | 0.4752 | 0.4521 | 0.4852 | 0.4345 |
| (8) | ωm | 47.24 | 45.70 | 43.27 | 46.11 | 47.36 |
| (9) | f/Denp | 1.1.120 | 1.0675 | 1.0593 | 1.0489 | 1.0365 |
| (10) | Dexp/Y | 0.3857 | 0.3449 | 0.4043 | 0.3193 | 0.3291 |
| (11) | \|B\| | 0.1200 | 0.1200 | 0.1200 | 0.1200 | 0.1200 |
| (12) | f/\|ffm\| | 0.4498 | 0.5423 | 0.5850 | 0.4439 | 0.5083 |
| (13) | f/ffmF | 1.4414 | −0.3840 | −0.3947 | −0.4452 | −0.3117 |
| (14) | \|γfm\| | 1.4003 | 1.7500 | 1.8095 | 1.3392 | 1.4538 |
| (15) | \|Mfm\|/TL | 0.0169 | 0.0136 | 0.0143 | 0.0177 | 0.0149 |
| (16) | f/ffmR | 0.1630 | 0.8908 | 1.0542 | 0.8278 | 0.8803 |
| (17) | f/Rc1 | −0.9661 | −0.9871 | −1.0045 | −0.9449 | −0.3000 |
| (18) | f/Rc2 | 0.0335 | 0.7163 | 0.7400 | 0.6170 | 0.7452 |
| (19) | Nmax | 2.01960 | 2.00330 | 1.98613 | 2.00100 | 2.05090 |
| (20) | Np | 1.98613 | 1.55032 | 1.72916 | 1.55032 | 1.49700 |
| (21) | νp | 16.48 | 75.50 | 54.68 | 75.50 | 81.61 |
| (22) | NEd | 1.85135 | 1.85135 | 1.85135 | 1.85135 | 1.85400 |
| (23) | νEd | 40.10 | 40.10 | 40.10 | 40.10 | 40.38 |
| (24) | f/f1 | 1.4414 | −0.3840 | −0.3947 | −0.6300 | −0.3117 |
| (25) | f/f2 | −0.4498 | −0.5423 | −0.5850 | 0.1029 | −0.5083 |
| (26) | f/f3 | 0.1630 | 0.8908 | 1.0542 | −0.4439 | 0.9566 |
| (27) | f/f4 | — | — | — | 0.8278 | 0.7711 |
| (28) | f/f5 | — | — | — | — | −0.5437 |
| (29) | f/fAsp1 | — | — | — | — | — |
| (30) | f/RAsp2 | 0.7396 | −0.8076 | −1.1879 | −0.8843 | −0.3670 |
| (31) | f/RAsp3 | — | 0.6777 | 1.0107 | 0.9448 | — |
| (32) | νAsp1 | — | — | — | — | — |

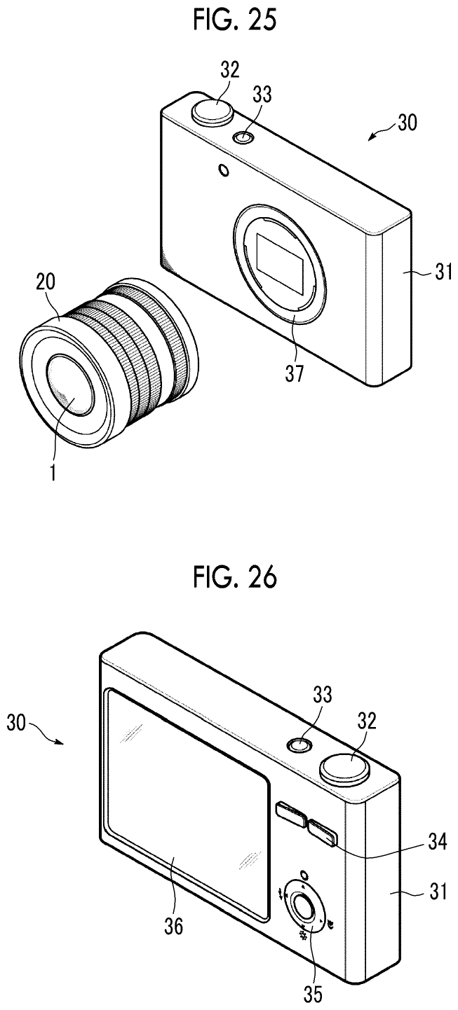

Next, an imaging apparatus according to the embodiment of the present disclosure will be described. FIGS. 25 and 26 illustrate external views of a camera 30 that is the imaging apparatus according to one embodiment of the present disclosure. FIG. 25 illustrates a perspective view of the camera 30 seen from a front surface side, and FIG. 26 illustrates a perspective view of the camera 30 seen from a rear surface side. The camera 30 is a so-called mirrorless type digital camera on which an interchangeable lens 20 can be attachably and detachably mounted. The interchangeable lens 20 may be configured to be accommodated in a lens barrel and include an optical system 1 according to one embodiment of the present disclosure.

The camera 30 comprises a camera body 31, and a shutter button 32 and a power button 33 are provided on an upper surface of the camera body 31. In addition, an operating part 34, an operating part 35, and a display unit 36 are provided on a rear surface of the camera body 31. The display unit 36 can display a captured image and an image within an angle of view before being captured.

An imaging opening on which light from an imaging target is incident is provided in a center portion of a front surface of the camera body 31, and a mount 37 is provided at a position corresponding to the imaging opening. The interchangeable lens 20 is mounted on the camera body 31 through the mount 37.

An imaging element such as a charge coupled device (CCD) or a complementary metal oxide semiconductor (CMOS) that outputs an imaging signal corresponding to a subject image formed by the interchangeable lens 20, a signal processing circuit that processes the imaging signal output from the imaging element to generate an image, a recording medium for recording the generated image, and the like are provided in the camera body 31. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples, and various modifications can be made. For example, the curvature radius, the surface spacing, the refractive index, the Abbe number, the partial dispersion ratio, and the aspherical coefficient of each lens are not limited to the values shown in each example and may have other values.

In addition, the optical apparatus according to the present disclosure is also not limited to the above. The optical apparatus according to the present disclosure is not limited to a digital camera and can have various aspects of a film camera, a video camera, a security camera, a video capturing camera, a broadcasting camera, a projector, and the like.

The following appendixes are further disclosed with respect to the embodiment and the examples described above.

### APPENDIX 1

An optical system including a plurality of lens components in a case where one lens component is one single lens or one cemented lens, in which an aperture stop that has a variable opening diameter and that determines an F-number of the optical system and at least one focusing group that moves during focusing are disposed in the optical system, and in a case where a lens component that is positioned closer to an object side than the aperture stop, that has a negative refractive power, and of which a surface closest to an image side has a concave shape is referred to as a negative concave lens component, the negative concave lens component having a maximum absolute value of an angle between an optical axis and a normal line to a surface of the negative concave lens component closest to the image side at a position of a maximum effective diameter of the surface in a cross section including the optical axis among the negative concave lens components of the optical system is referred to as a first negative concave lens component, the angle of the first negative concave lens component is denoted by α1, α1 is in degree units, and a sign of α1 is negative, an open F-number in a state where an infinite distance object is focused on is denoted by FNo, a back focus of the optical system as an air conversion distance in the state where the infinite distance object is focused on is denoted by βf, a focal length of the optical system in the state where the infinite distance object is focused on is denoted by f, a maximum half angle of view in the state where the infinite distance object is focused on is denoted by ωm, and Y=f×tan om is established, Conditional Expressions (1), (2), and (3) are satisfied, which are represented by

$$- 80 < α1 < - 30 \qquad ( 1 )$$

$$0.5 < FNo < 2.3 \qquad ( 2 )$$

$$0.5 < Bf / Y < 1.7 . \qquad ( 3 )$$

### APPENDIX 2

The optical system according to Appendix 1, in which in a case where a lens component closest to the object side among lens components that are positioned closer to the image side than the aperture stop and that have a positive refractive power is referred to as a P lens component, a distance on the optical axis from the aperture stop to a surface of the P lens component closest to the object side in the state where the infinite distance object is focused on is denoted by dStP, and a sum of Bf and a distance on the optical axis from the aperture stop to a lens surface of the optical system closest to the image side in the state where the infinite distance object is focused on is denoted by dStI, Conditional Expression (4) is satisfied, which is represented by

$$0 < d StP / dStI < 0.38 . \qquad ( 4 )$$

### APPENDIX 3

The optical system according to Appendix 2, in which in a case where a larger one of a maximum effective diameter of a surface closest to the object side and a maximum effective diameter of a surface closest to the image side for each lens component of the optical system is referred to as a wide effective diameter, a lens component having the minimum wide effective diameter among lens components included from a surface of the P lens component closest to the object side to a surface, closest to the object side, of a lens component of the optical system closest to the image side is referred to as an Ed lens component, and a focal length of the Ed lens component is denoted by fEd, Conditional Expression (5) is satisfied, which is represented by

$$- 0.27 < Y / fEd < 0.1 . \qquad ( 5 )$$

### APPENDIX 4

The optical system according to Appendix 2 or 3, in which in a case where a larger one of a maximum effective diameter of a surface closest to the object side and a maximum effective diameter of a surface closest to the image side for each lens component of the optical system is referred to as a wide effective diameter, a lens component having the minimum wide effective diameter among lens components included from a surface of the P lens component closest to the object side to a surface, closest to the object side, of a lens component of the optical system closest to the image side is referred to as an Ed lens component, an angle having a larger absolute value out of an angle between the optical axis and a normal line to a surface of the Ed lens component closest to the object side at the position of the maximum effective diameter of the surface and an angle between the optical axis and a normal line to a surface of the Ed lens component closest to the image side at the position of the maximum effective diameter of the surface in a cross section including the optical axis is denoted by α2, α2 is in degree units, and a sign of α2 is negative in a case where the surface from which the normal line is obtained is a concave surface, and a sign of α2 is positive in a case where the surface from which the normal line is obtained is a convex surface, Conditional Expression (6) is satisfied, which is represented by

$$- 45 < α 2 < 0. \qquad ( 6 )$$

### APPENDIX 5

The optical system according to any one of Appendixes 2 to 4, in which in a case where a focal length of the P lens component is denoted by fP, Conditional Expression (7) is satisfied, which is represented by

$$0.1 < Y / fP < 0.9 . \qquad ( 7 )$$

### APPENDIX 6

The optical system according to any one of Appendixes 1 to 5, in which in a case where om is in degree units, Conditional Expression (8) is satisfied, which is represented by

$$32 < ω m < 55. \qquad ( 8 )$$

### APPENDIX 7

The optical system according to any one of Appendixes 1 to 6, in which in a case where a distance on the optical axis from a lens surface of the optical system closest to the object side to a paraxial entrance pupil position in the state where the infinite distance object is focused on is denoted by Denp, Conditional Expression (9) is satisfied, which is represented by

$$0.83 < f / Denp < 2.5 . \qquad ( 9 )$$

### APPENDIX 8

The optical system according to any one of Appendixes 1 to 7, in which in a case where a distance on the optical axis from a paraxial exit pupil position to an image plane in the state where the infinite distance object is focused on is denoted by Dexp, and in a case where an optical member not having a refractive power is disposed between the image plane and the paraxial exit pupil position, Dexp is calculated using an air conversion distance for the optical member, Conditional Expression (10) is satisfied, which is represented by

$$0.25 < Dexp / Y < 0.5 . \qquad ( 10 )$$

### APPENDIX 9

The optical system according to any one of Appendixes 1 to 8, in which in a case where a lateral magnification of the optical system in a state where a nearest object is focused on is denoted by B, Conditional Expression (11) is satisfied, which is represented by

$$0.07 < \vert B \vert < 0.3 . \qquad ( 11 )$$

### APPENDIX 10

The optical system according to any one of Appendixes 1 to 9, in which in a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, and a focal length of the maximum focusing group is denoted by ffm, Conditional Expression (12) is satisfied, which is represented by

$$0.05 < f / \vert ffm \vert < 0.95 . \qquad ( 12 )$$

### APPENDIX 11

The optical system according to any one of Appendixes 1 to 10, in which in a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, and a combined focal length of all lenses closer to the object side than the maximum focusing group is denoted by ffmF, Conditional Expression (13) is satisfied, which is represented by

$$- 0.9 < f / ffmF < 2. \qquad ( 13 )$$

### APPENDIX 12

The optical system according to any one of Appendixes 1 to 11, in which in a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, and γ of the maximum focusing group is denoted by γfm, Conditional Expression (14) is satisfied, which is represented by

$$0.38 < \vert γ fm \vert < 2.5 . \qquad ( 14 )$$

### APPENDIX 13

The optical system according to any one of Appendixes 1 to 12, in which in a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, Mf of the maximum focusing group is denoted by Mfm, and a sum of Bf and a distance on the optical axis from a lens surface of the optical system closest to the object side to a lens surface of the optical system closest to the image side in the state where the infinite distance object is focused on is denoted by TL, Conditional Expression (15) is satisfied, which is represented by

$$0.0 \; 06 < \vert Mfm \vert / TL < 0.15 . \qquad ( 15 )$$

### APPENDIX 14

The optical system according to any one of Appendixes 1 to 13, in which in a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, and a combined focal length of all lenses closer to the image side than the maximum focusing group is denoted by ffmR, Conditional Expression (16) is satisfied, which is represented by

$$- 0.5 < f / ffmR < 1.5 . \qquad ( 16 )$$

### APPENDIX 15

The optical system according to any one of Appendixes 1 to 14, in which a first cemented lens that is obtained by bonding a negative lens and a positive lens to each other in this order from the object side and of which a surface closest to the object side has a concave shape is disposed between a surface of the first negative concave lens component closest to the image side and the aperture stop.

### APPENDIX 16

The optical system according to Appendix 15, in which in a case where a paraxial curvature radius of a surface of the first cemented lens closest to the object side is denoted by Rc1, Conditional Expression (17) is satisfied, which is represented by

$$- 2 < f / Rc 1 < - 0.025 . \qquad ( 17 )$$

### APPENDIX 17

The optical system according to any one of Appendixes 2 to 5, in which in a case where a larger one of a maximum effective diameter of a surface closest to the object side and a maximum effective diameter of a surface closest to the image side for each lens component of the optical system is referred to as a wide effective diameter, and a lens component having the minimum wide effective diameter among lens components included from a surface of the P lens component closest to the object side to a surface, closest to the object side, of a lens component of the optical system closest to the image side is referred to as an Ed lens component, a second cemented lens obtained by bonding a positive lens and a negative lens to each other in this order from the object side is disposed between a surface of the P lens component closest to the image side and a surface of the Ed lens component closest to the object side.

### APPENDIX 18

The optical system according to Appendix 17, in which in a case where a paraxial curvature radius of a surface of the second cemented lens closest to the object side is denoted by Rc2, Conditional Expression (18) is satisfied, which is represented by

$$0.02 < f / Rc 2 < 1.5 . \qquad ( 18 )$$

### APPENDIX 19

The optical system according to any one of Appendixes 1 to 18, in which in a case where a lens component closest to the object side among lens components that are positioned closer to the image side than the aperture stop and that have a positive refractive power is referred to as a P lens component, a distance on the optical axis from the aperture stop to a surface of the P lens component closest to the object side in the state where the infinite distance object is focused on is denoted by dStP, a sum of Bf and a distance on the optical axis from the aperture stop to a lens surface of the optical system closest to the image side in the state where the infinite distance object is focused on is denoted by dStI, a larger one of a maximum effective diameter of a surface closest to the object side and a maximum effective diameter of a surface closest to the image side for each lens component of the optical system is referred to as a wide effective diameter, a lens component having the minimum wide effective diameter among lens components included from a surface of the P lens component closest to the object side to a surface, closest to the object side, of a lens component of the optical system closest to the image side is referred to as an Ed lens component, a focal length of the Ed lens component is denoted by fEd, an angle having a larger absolute value out of an angle between the optical axis and a normal line to a surface of the Ed lens component closest to the object side at the position of the maximum effective diameter of the surface and an angle between the optical axis and a normal line to a surface of the Ed lens component closest to the image side at the position of the maximum effective diameter of the surface in a cross section including the optical axis is denoted by α2, α2 is in degree units, and a sign of α2 is negative in a case where the surface from which the normal line is obtained is a concave surface, and a sign of α2 is positive in a case where the surface from which the normal line is obtained is a convex surface, Conditional Expressions (4), (5), and (6) are satisfied, which are represented by

$$0 < dStP / dStI < 0.38 \qquad ( 4 )$$

$$- 0.2 \; 7 < Y / fEd < 0.1 \qquad ( 5 )$$

$$- 45 < α2 < 0. \qquad ( 6 )$$

### APPENDIX 20

An optical apparatus comprising the optical system according to any one of Appendixes 1 to 19.

What is claimed is:

1. An optical system comprising:
a plurality of lens components in a case where one lens component is one single lens or one cemented lens,
wherein an aperture stop that has a variable opening diameter and that determines an F-number of the optical system and at least one focusing group that moves during focusing are disposed in the optical system, and
in a case where a lens component that is positioned closer to an object side than the aperture stop, that has a negative refractive power, and of which a surface closest to an image side has a concave shape is referred to as a negative concave lens component, the negative concave lens component having a maximum absolute value of an angle between an optical axis and a normal line to a surface of the negative concave lens component closest to the image side at a position of a maximum effective diameter of the surface in a cross section including the optical axis among the negative concave lens components of the optical system is referred to as a first negative concave lens component, the angle of the first negative concave lens component is denoted by α1, α1 is in degree units, and a sign of α1 is negative, an open F-number in a state where an infinite distance object is focused on is denoted by FNo, a back focus of the optical system as an air conversion distance in the state where the infinite distance object is focused on is denoted by βf, a focal length of the optical system in the state where the infinite distance object is focused on is denoted by f, a maximum half angle of view in the state where the infinite distance object is focused on is denoted by ωm, and Y=f×tan ωm is established, Conditional Expressions (1), (2), and (3) are satisfied, which are represented by
$$- 80 < α1 < - 30 \qquad ( 1 )$$
$$0.5 < FNo < 2.3 \qquad ( 2 )$$
$$0.5 < Bf / Y < 1.7 . \qquad ( 3 )$$

2. The optical system according to claim 1,
wherein in a case where a lens component closest to the object side among lens components that are positioned closer to the image side than the aperture stop and that have a positive refractive power is referred to as a P lens component, a distance on the optical axis from the aperture stop to a surface of the P lens component closest to the object side in the state where the infinite distance object is focused on is denoted by dStP, and a sum of Bf and a distance on the optical axis from the aperture stop to a lens surface of the optical system closest to the image side in the state where the infinite distance object is focused on is denoted by dStI, Conditional Expression (4) is satisfied, which is represented by
$$0 < dStP / dStI < 0.38 . \qquad ( 4 )$$

3. The optical system according to claim 2,
wherein in a case where a larger one of a maximum effective diameter of a surface closest to the object side and a maximum effective diameter of a surface closest to the image side for each lens component of the optical system is referred to as a wide effective diameter, a lens component having the minimum wide effective diameter among lens components included from a surface of the P lens component closest to the object side to a surface, closest to the object side, of a lens component of the optical system closest to the image side is referred to as an Ed lens component, and a focal length of the Ed lens component is denoted by fEd, Conditional Expression (5) is satisfied, which is represented by
$$- 0.27 < Y / fEd < 0.1 . \qquad ( 5 )$$

4. The optical system according to claim 2,
wherein in a case where a larger one of a maximum effective diameter of a surface closest to the object side and a maximum effective diameter of a surface closest to the image side for each lens component of the optical system is referred to as a wide effective diameter, a lens component having the minimum wide effective diameter among lens components included from a surface of the P lens component closest to the object side to a surface, closest to the object side, of a lens component of the optical system closest to the image side is referred to as an Ed lens component, an angle having a larger absolute value out of an angle between the optical axis and a normal line to a surface of the Ed lens component closest to the object side at the position of the maximum effective diameter of the surface and an angle between the optical axis and a normal line to a surface of the Ed lens component closest to the image side at the position of the maximum effective diameter of the surface in a cross section including the optical axis is denoted by α2, α2 is in degree units, and a sign of α2 is negative in a case where the surface from which the normal line is obtained is a concave surface, and a sign of α2 is positive in a case where the surface from which the normal line is obtained is a convex surface, Conditional Expression (6) is satisfied, which is represented by
$$- 45 < α 2 < 0. \qquad ( 6 )$$

5. The optical system according to claim 2,
wherein in a case where a focal length of the P lens component is denoted by fP, Conditional Expression (7) is satisfied, which is represented by
$$0.1 < Y / fP < 0.9 . \qquad ( 7 )$$

6. The optical system according to claim 1,
wherein in a case where om is in degree units, Conditional Expression (8) is satisfied, which is represented by
$$32 < ω m < 55. \qquad ( 8 )$$

7. The optical system according to claim 1,
wherein in a case where a distance on the optical axis from a lens surface of the optical system closest to the object side to a paraxial entrance pupil position in the state where the infinite distance object is focused on is denoted by Denp, Conditional Expression (9) is satisfied, which is represented by
$$0.83 < f / Denp < 2.5 . \qquad ( 9 )$$

8. The optical system according to claim 1,
wherein in a case where a distance on the optical axis from a paraxial exit pupil position to an image plane in the state where the infinite distance object is focused on is denoted by Dexp, and in a case where an optical member not having a refractive power is disposed between the image plane and the paraxial exit pupil position, Dexp is calculated using an air conversion distance for the optical member, Conditional Expression (10) is satisfied, which is represented by
$$0.25 < D exp / Y < 0.5 . \qquad ( 10 )$$

9. The optical system according to claim 1,
wherein in a case where a lateral magnification of the optical system in a state where a nearest object is focused on is denoted by B, Conditional Expression (11) is satisfied, which is represented by
$$0.07 < \vert B \vert < 0.3 . \qquad ( 11 )$$

10. The optical system according to claim 1,
wherein in a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, and a focal length of the maximum focusing group is denoted by ffm, Conditional Expression (12) is satisfied, which is represented by
$$0.05 < f / \vert ffm \vert < 0.95 . \qquad ( 12 )$$

11. The optical system according to claim 1,
wherein in a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, and a combined focal length of all lenses closer to the object side than the maximum focusing group is denoted by ffmF, Conditional Expression (13) is satisfied, which is represented by
$$- 0.9 < f / ffmF < 2. \qquad ( 13 )$$

12. The optical system according to claim 1,
wherein in a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, and γ of the maximum focusing group is denoted by γfm, Conditional Expression (14) is satisfied, which is represented by
$$0.38 < \vert γ fm \vert < 2.5 . \qquad ( 14 )$$

13. The optical system according to claim 1,
wherein in a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, Mf of the maximum focusing group is denoted by Mfm, and a sum of Bf and a distance on the optical axis from a lens surface of the optical system closest to the object side to a lens surface of the optical system closest to the image side in the state where the infinite distance object is focused on is denoted by TL, Conditional Expression (15) is satisfied, which is represented by
$$0.0 \; 06 < \vert Mfm \vert / TL < 0.15 . \qquad ( 15 )$$

14. The optical system according to claim 1,
wherein in a case where for each focusing group of the optical system, a moving amount of the focusing group during focusing on a nearest object from the infinite distance object is denoted by Mf, a lateral magnification of the focusing group in the state where the infinite distance object is focused on is denoted by βf, a combined lateral magnification of all lenses closer to the image side than the focusing group in the state where the infinite distance object is focused on is denoted by βfR, and in a case where γ=(1−βf²)×βfR² is established, the focusing group having maximum |Mf×γ| among the focusing groups of the optical system is referred to as a maximum focusing group, and a combined focal length of all lenses closer to the image side than the maximum focusing group is denoted by ffmR, Conditional Expression (16) is satisfied, which is represented by
$$- 0.5 < f / ffmR < 1.5 . \qquad ( 16 )$$

15. The optical system according to claim 1,
wherein a first cemented lens that is obtained by bonding a negative lens and a positive lens to each other in this order from the object side and of which a surface closest to the object side has a concave shape is disposed between a surface of the first negative concave lens component closest to the image side and the aperture stop.

16. The optical system according to claim 15,
wherein in a case where a paraxial curvature radius of a surface of the first cemented lens closest to the object side is denoted by Rc1, Conditional Expression (17) is satisfied, which is represented by
$$- 2 < f / Rc 1 < - 0.025 . \qquad ( 17 )$$

17. The optical system according to claim 2,
wherein in a case where a larger one of a maximum effective diameter of a surface closest to the object side and a maximum effective diameter of a surface closest to the image side for each lens component of the optical system is referred to as a wide effective diameter, and a lens component having the minimum wide effective diameter among lens components included from a surface of the P lens component closest to the object side to a surface, closest to the object side, of a lens component of the optical system closest to the image side is referred to as an Ed lens component, a second cemented lens obtained by bonding a positive lens and a negative lens to each other in this order from the object side is disposed between a surface of the P lens component closest to the image side and a surface of the Ed lens component closest to the object side.

18. The optical system according to claim 17,
wherein in a case where a paraxial curvature radius of a surface of the second cemented lens closest to the object side is denoted by Rc2, Conditional Expression (18) is satisfied, which is represented by
$$0.02 < f / Rc 2 < 1.5 . \qquad ( 18 )$$

19. The optical system according to claim 1,
wherein in a case where a lens component closest to the object side among lens components that are positioned closer to the image side than the aperture stop and that have a positive refractive power is referred to as a P lens component, a distance on the optical axis from the aperture stop to a surface of the P lens component closest to the object side in the state where the infinite distance object is focused on is denoted by dStP, a sum of Bf and a distance on the optical axis from the aperture stop to a lens surface of the optical system closest to the image side in the state where the infinite distance object is focused on is denoted by dStI, a larger one of a maximum effective diameter of a surface closest to the object side and a maximum effective diameter of a surface closest to the image side for each lens component of the optical system is referred to as a wide effective diameter, a lens component having the minimum wide effective diameter among lens components included from a surface of the P lens component closest to the object side to a surface, closest to the object side, of a lens component of the optical system closest to the image side is referred to as an Ed lens component, a focal length of the Ed lens component is denoted by fEd, an angle having a larger absolute value out of an angle between the optical axis and a normal line to a surface of the Ed lens component closest to the object side at the position of the maximum effective diameter of the surface and an angle between the optical axis and a normal line to a surface of the Ed lens component closest to the image side at the position of the maximum effective diameter of the surface in a cross section including the optical axis is denoted by α2, α2 is in degree units, and a sign of α2 is negative in a case where the surface from which the normal line is obtained is a concave surface, and a sign of α2 is positive in a case where the surface from which the normal line is obtained is a convex surface, Conditional Expressions (4), (5), and (6) are satisfied, which are represented by
$$0 < dStP / dStI < 0.38 \qquad ( 4 )$$
$$- 0.27 < Y / fEd < 0.1 \qquad ( 5 )$$
$$- 45 < α 2 < 0. \qquad ( 6 )$$

20. An optical apparatus comprising:
the optical system according to claim 1.
